(19) United States
(12) Patent Application Publication
(10) Pub. No.: US 2026/0328916 A1
(43) Pub. Date: Oct. 22, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: HIROTAKA TANAKA, TOKYO (JP)

(21) Appl. No.: 19/122,768

(22) PCT Filed: Sep. 5, 2023
(86) PCT No.: PCT/JP2023/032318

§ 371 Date: Apr. 21, 2025

(30) Foreign Application Priority Data
Oct. 28, 2022 (JP) 2022-173018

(51) Int. Cl. G01S 7/4912; G01S 17/36; G01S 17/89; G01S 17/931

(52) U.S. Cl. CPC G01S 7/4918; G01S 17/36; G01S 17/89; G01S 17/931

(57) ABSTRACT

A light output sensor and a point cloud map generated on the basis of sensor detection information are controlled according to a speed of a mobile body, to enable optimal object detection according to the speed of the mobile body. There are provided: a sensor that is attached to a mobile body, outputs light with a predetermined frequency from a light transmission unit, and is input with reflected light from the object via a light reception unit; a point cloud map generation unit that is input with a sensor detection value to generate a point cloud map indicating an object position; and a control unit that controls at least one of the sensor or the point cloud map generation unit. The control unit performs control to change at least one of a frequency or intensity of output light of the sensor, an exposure time of input light of the sensor, or a point cloud cut region in a point cloud map, in accordance with a speed of the mobile body.

### TECHNICAL FIELD

The present disclosure relates to an information processing device, an information processing method, and a program. More specifically, for example, the present disclosure relates to an information processing device, an information processing method, and a program for executing obstacle detection processing for a mobile body such as a robot or an automated driving vehicle to travel safely.

### BACKGROUND ART

Recently, an automated moving mobile body such as a robot or an automated driving vehicle has been actively developed and used.

The automated moving mobile body includes the sensor that analyzes a position and a distance of an object such as a surrounding obstacle, analyzes the position and the distance of the obstacle on the basis of sensor detection information, and sets a traveling route avoiding collision or contact with the obstacle to travel safely.

Furthermore, there is a case where movement is performed using a map created on the basis of sensor detection information or map information input from the outside.

As a sensor that detects an object such as an obstacle, for example, there are known a time of flight (ToF) camera, light detection and ranging (LiDAR), and the like that output light such as visible light, infrared light, or laser light and analyze reflected light from the object.

While there are several types of ToF cameras, for example, there is known an indirect ToF (iToF) camera that calculates an object distance from a phase difference between transmission light (output light) and reception light (reflected light).

However, when the object distance is calculated using this iTOF camera, erroneous detection (aliasing) may occur in which an object that is actually at a far distance is determined as an object at a close distance different from the actual distance.

The iToF camera is configured to calculate a distance in accordance with a phase difference between transmission light (output light) and reception light (reflected light), but the phase difference between the transmission light (output light) and the reception light (reflected light) can be detected only in a range of 0 to 2π. As a result, a maximum detectable distance (for example, the phase difference=2π) is defined according to a frequency of the transmission light (output light).

For example, even if the actual phase difference between the transmission light (output light) and the reception light (reflected light) is not 2π but 4π or 6π of with a cycle delay, there is a possibility that a distance calculation error occurs in which the determination is made as an object of a close distance at a distance similar to the phase difference=2π.

Note that a principle of this erroneous detection will be described in detail later.

Patent Document 1 (Japanese Patent Application Laid-Open No. 2022-046162) and Patent Document 2 (Japanese Patent Application Laid-Open No. 2013-538342) are examples of conventional techniques that disclose a configuration for reducing deterioration in detection accuracy in a case of using a ToF sensor.

Patent Document 1 (Japanese Patent Application Laid-Open No. 2022-046162) discloses a configuration in which an exposure time and light emission intensity of a ToF sensor are changed according to a speed of a vehicle attached with the ToF sensor, to suppress deterioration in detection accuracy.

However, there is a problem that, for example, when the light emission intensity is increased in an environment where a person is walking or an oncoming vehicle is present, the person or the oncoming vehicle is disturbed.

Furthermore, Patent Document 2 (Japanese Patent Application Laid-Open No. 2013-538342) discloses a configuration in which phase difference detection is individually performed at each frequency by using a plurality of different modulation frequencies, and integration is performed on these phase differences to calculate an object distance with higher accuracy.

However, this configuration has a problem that a system configuration and arithmetic processing become complicated.

### CITATION LIST

### Patent Document

Patent Document 1: Japanese Patent Application Laid-Open No. 2022-046162

Patent Document 2: Japanese Patent Application Laid-Open No. 2013-538342

### SUMMARY OF THE INVENTION

### Problems to be Solved by the Invention

The present disclosure has been made in view of the problems described above, for example, and an object of the present disclosure is to provide an information processing device, an information processing method, and a program capable of calculating an object distance with high accuracy by optimal control according to various travel environments of a mobile body such as a robot and a vehicle.

Moreover, an embodiment of the present disclosure provides an information processing device, an information processing method, and a program, in which calculation accuracy of an object distance is further improved by using an iToF camera and LiDAR in combination.

### Solutions to Problems

A first aspect of the present disclosure is an information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit, in which
the control unit
performs control to change at least one of a frequency or intensity of output light of the sensor, an exposure time of input light of the sensor, or a point cloud cut region in a point cloud map generated by the point cloud map generation unit, in accordance with a speed of the mobile body.

Moreover, a second aspect of the present disclosure is an information processing method executed in an information processing device,
the information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit,
information processing method including:
by the control unit,
performing control to change at least one of a frequency or intensity of output light of the sensor, an exposure time of input light of the sensor, or a point cloud cut region in a point cloud map generated by the point cloud map generation unit, in accordance with a speed of the mobile body.

Moreover, a third aspect of the present disclosure is a program for causing an information processing device to execute information processing,
the information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit,
the program causing the control unit to execute
control to change at least one of a frequency or intensity of output light of the sensor, an exposure time of input light of the sensor, or a point cloud cut region in a point cloud map generated by the point cloud map generation unit, in accordance with a speed of the mobile body.

Note that the program of the present disclosure is, for example, a program that can be provided by a storage medium or a communication medium that provides a variety of program codes in a computer-readable format, to an information processing device or a computer system capable of executing the program codes. By providing such a program in a computer-readable format, processing corresponding to the program is implemented on the information processing device or the computer system.

Other objects, features, and advantages of the present disclosure will become apparent from the detailed description based on the embodiments of the present disclosure described later and the accompanying drawings. Note that, in the present specification, a system is a logical set configuration of a plurality of devices, and is not limited to one in which devices of respective configurations are in the same housing.

### Effects of the Invention

According to a configuration of an embodiment of the present disclosure, a configuration is achieved in which a light output sensor and a point cloud map generated on the basis of sensor detection information are controlled according to a speed of a mobile body, to enable optimal object detection according to the speed of the mobile body.

Specifically, for example, there are provided: a sensor that is attached to the mobile body, outputs light with a predetermined frequency from a light transmission unit, and is input with reflected light from an object via the light reception unit; a point cloud map generation unit that is input with a sensor detection value to generate a point cloud map indicating an object position; and a control unit that controls at least one of the sensor or the point cloud map generation unit. The control unit performs control to change at least one of a frequency or intensity of output light of the sensor, an exposure time of input light of the sensor, or a point cloud cut region in a point cloud map, in accordance with a speed of the mobile body.

With this configuration, a configuration is achieved in which the light output sensor and a point cloud map generated on the basis of sensor detection information are controlled according to a speed of the mobile body, to enable optimal object detection according to the speed of the mobile body.

Note that the effects described herein are merely examples and are not limited, and additional effects may also be provided.

### BRIEF DESCRIPTION OF DRAWINGS

FIG. 1 is a diagram for explaining an example of a configuration of a robot which is a mobile body to which an information processing device of the present disclosure is attached, and a travel environment in which the robot travels.

FIG. 2 is a diagram for explaining an example of object distance measurement performed by an iToF camera.

FIG. 3 is a diagram for explaining a specific example of a phase difference between a case where an object distance is small (close) and a case where the object distance is large (far).

FIG. 4 is a diagram for explaining a problem in object distance calculation processing using the iToF camera.

FIG. 5 is a diagram for explaining a problem in the object distance calculation processing using the iToF camera.

FIG. 6 is a diagram for explaining a problem in the object distance calculation processing using the iToF camera.

FIG. 7 is a diagram for explaining details of erroneous detection (aliasing) of an object distance by the iToF camera.

FIG. 8 is a diagram for explaining a relationship between a frequency of output light of the iToF camera and a measurable distance.

FIG. 9 is a diagram for explaining details of erroneous detection (aliasing) of an object distance by the iToF camera.

FIG. 10 is a diagram for explaining details of erroneous detection (aliasing) of an object distance by the iToF camera.

FIG. 11 is a diagram for explaining a configuration example of the information processing device of the present disclosure.

FIG. 12 is a diagram for explaining an example of a two-dimensional plane on which a 2D-LiDAR executes object distance detection processing.

FIG. 13 is a diagram for explaining an example of the object distance detection processing performed by the 2D-LiDAR.

FIG. 14 is a diagram for explaining an example of a point cloud map generated by a LiDAR point cloud map generation unit.

FIG. 15 is a diagram for explaining a point cloud cut region.

FIG. 16 is a diagram for explaining an example of a point cloud map (three-dimensional point cloud map) generated by an iToF point cloud map generation unit.

FIG. 17 is a diagram for explaining an example of a synthesized point cloud map generated by a point cloud map synthesizing unit.

FIG. 18 is a flowchart for explaining calculation processing of an iToF point cloud cut region control parameter executed by the information processing device, and processing based on the calculated parameter.

FIG. 19 is a diagram indicating a graph for explaining a correspondence relationship between a speed of the robot (mobile body) and enlargement and reduction processing on a point cloud cut region.

FIG. 20 is a diagram for explaining a specific example of the enlargement processing and the reduction processing on a point cloud cut region.

FIG. 21 is a diagram for explaining a specific example of synthesized point cloud map generation processing executed by the point cloud map synthesizing unit.

FIG. 22 is a diagram for explaining a specific example of the synthesized point cloud map generation processing executed by the point cloud map synthesizing unit.

FIG. 23 is a diagram for explaining a specific example of the synthesized point cloud map generation processing executed by the point cloud map synthesizing unit.

FIG. 24 is a diagram for explaining a graph indicating a calculation function of a point cloud cut region control parameter (Dmin).

FIG. 25 is a diagram for explaining a specific example of control in which hysteresis is set.

FIG. 26 is a diagram for explaining an example of a processing sequence in which point cloud cut processing is executed after generation of an iTOF point cloud map.

FIG. 27 is a flowchart for explaining calculation processing of an iToF camera output light frequency control parameter executed by the information processing device, and processing based on the calculated parameter.

FIG. 28 is a diagram for explaining a graph indicating a correspondence relationship between a speed of the robot (mobile body) and a frequency (Hz) of output light of the iToF camera.

FIG. 29 is a flowchart for explaining calculation processing of an iToF camera exposure time control parameter executed by the information processing device, and processing based on the calculated parameter.

FIG. 30 is a diagram for explaining a graph indicating a correspondence relationship between a speed of the robot (mobile body) and an exposure time (usec) of the iToF camera.

FIG. 31 is a flowchart for explaining calculation processing of an iToF camera output light intensity control parameter executed by the information processing device, and processing based on the calculated parameter.

FIG. 32 is a diagram for explaining a graph indicating a correspondence relationship between a speed of the robot (mobile body) and intensity (Watt) of output light of the iTOF camera.

FIG. 33 is a flowchart for explaining processing executed by the information processing device.

FIG. 34 is a flowchart for explaining processing executed by the information processing device.

FIG. 35 is a flowchart for explaining processing executed by the information processing device.

FIG. 36 is a flowchart for explaining processing executed by the information processing device.

FIG. 37 is a diagram for explaining a hardware configuration example of the information processing device according to the present disclosure.

### MODE FOR CARRYING OUT THE INVENTION

Hereinafter, an information processing device, an information processing method, and a program according to the present disclosure will be described in detail with reference to the drawings. Note that the description will be made in accordance with the following items.
1. Configuration of mobile body, and principle and problem of iToF camera
2. Configuration example of information processing device of present disclosure
3. Embodiments of processing executed by information processing device
3-1. (First embodiment) Calculation processing of iToF point cloud cut region control parameter and processing based on calculated parameter
3-1-1. (Modification 1 of first embodiment) Modification in which setting mode of point cloud cut region is changed
3-1-2. (Modification 2 of first embodiment) Modification in which point cloud cut processing is executed after generation of iToF point cloud map
3-2. (Second embodiment) Calculation processing of iToF camera output light frequency control parameter and processing based on calculated parameter
3-3. (Third embodiment) Calculation processing of iToF camera exposure time control parameter and processing based on calculated parameter
3-4. (Fourth embodiment) Calculation processing of iToF Camera output light intensity control parameter and processing based on calculated parameter
4. (Fifth embodiment) Embodiment in which processing of each of first to fourth embodiments described above is sequentially executed
5. Hardware configuration example of information processing device
6. Summary of configuration of present disclosure

### 1. Configuration of Mobile Body, and Principle and Problem of iToF Camera

First, a configuration of a mobile body, a principle and a problem of an iToF camera will be described.

An information processing device of the present disclosure is attached on a mobile body such as a robot or a vehicle, and calculates an object distance by using a ToF camera.

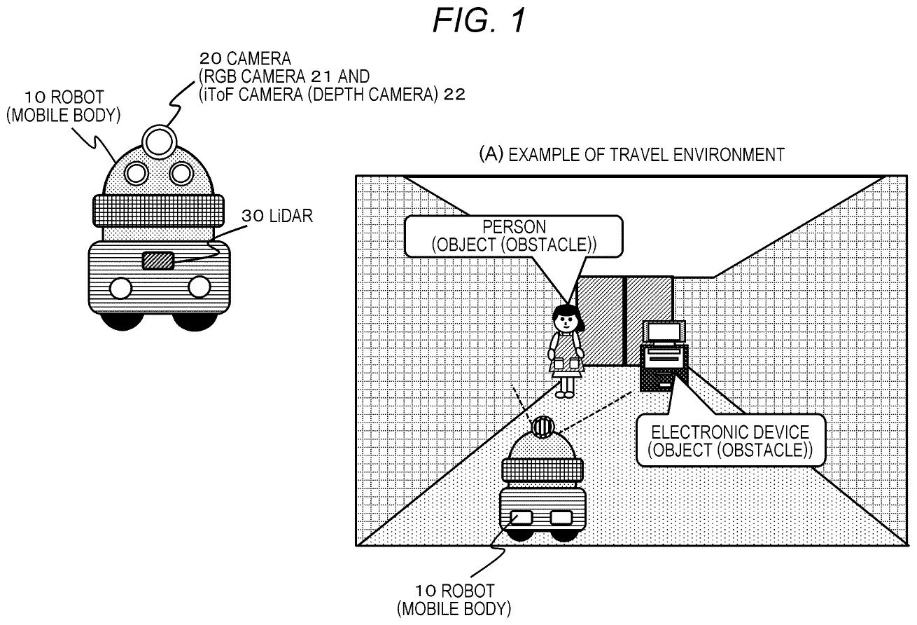

FIG. 1 illustrates an example of a configuration of a robot 10 which is a mobile body on which the information processing device of the present disclosure is attached, and a travel environment in which the robot 10 travels.

Note that the mobile body on which the information processing device of the present disclosure is attached is not limited to the robot illustrated in FIG. 1, and can be various mobile bodies such as, for example, a vehicle-type mobile body such as an automated driving vehicle and a flight-type mobile body such as a drone.

Hereinafter, an embodiment will be described in which the robot 10 of an automated traveling type is used as a mobile body to which the information processing device of the present disclosure is attached.

As illustrated in FIG. 1, the robot 10 includes a camera 20 and a LiDAR 30.

The camera 20 includes, for example, an RGB camera 21 and an iToF camera (depth camera) 22.

Note that the iToF camera 22 is an indirect time of flight (iToF) camera which analyzes a phase difference between transmission light (output light) and reception light (reflected light), and calculates an object distance on the basis of the phase difference.

Furthermore, the LiDAR 30 is a light detection and ranging (LiDAR) as a sensor that outputs laser light and analyzes reflected light of the laser light from an object, to measure a distance to an obstacle.

FIG. 1 illustrates (A) an example of a travel environment. The robot is traveling on a passage in a building. In front of the robot 10, which is an advancing direction, a person is walking and an electronic device is placed.

For the robot 10, the person and the electronic device are objects corresponding to obstacles, and it is necessary to correctly grasp a distance and a position of these objects (obstacles) in order for the robot 10 to travel without causing collision or contact with these objects (obstacles).

As a sensor for correctly grasping the distance and the position of the object (obstacle), the iToF camera 22 and the LiDAR 30 are used.

The iToF camera 22 and the LiDAR 30 output light such as visible light, infrared light, or laser light, for example, and receive and analyze reflected light from an object such as an obstacle.

The iToF camera 22 analyzes a phase difference between transmission light (output light) and reception light (reflected light), and calculates an object distance on the basis of the phase difference.

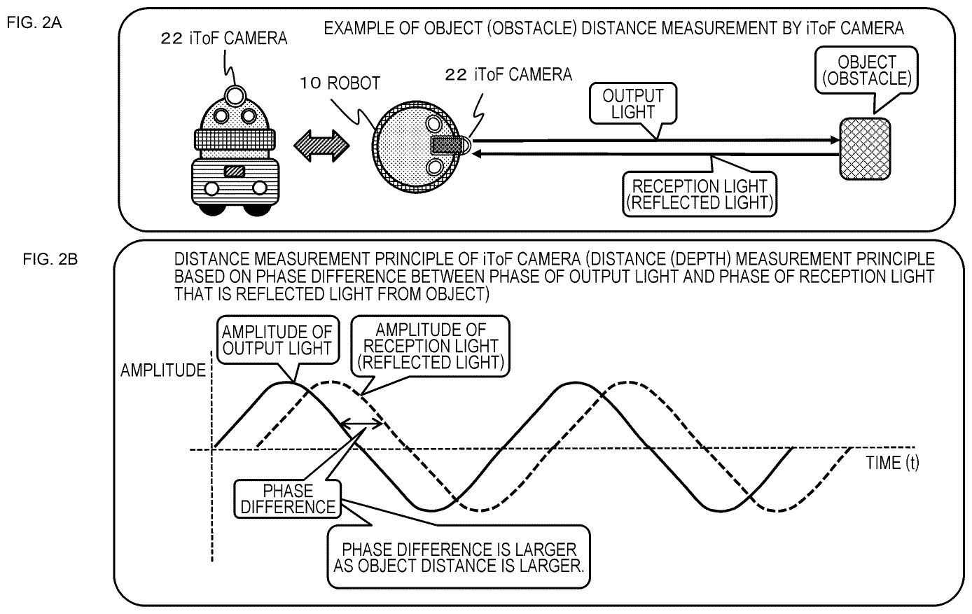

With reference to FIG. 2, a specific example of object distance calculation processing performed by the iToF camera 22 will be described.

FIG. 2(a) is a diagram illustrating an example of object distance measurement performed by the iToF camera 22.

When an object (obstacle) is irradiated with transmission light (output light) from the iToF camera 22 that is present on a front surface of the robot 10, light reflected from the object (obstacle) is input to the iToF camera 22 as reception light (reflected light).

FIG. 2(b) is a graph for explaining a distance (depth) measurement principle based on a phase difference between a phase of transmission light (output light) of the iTOF camera 22 illustrated in FIG. 2(a) and a phase of reception light that is reflected light from an object.

A horizontal axis of the graph in the figure represents a time (t), and a vertical axis represents an amplitude. A solid line indicates an amplitude change of transmission light (output light), and a dotted line indicates an amplitude change of reception light (reflected wave).

The amplitude change of the transmission light (output light) indicated by the solid line is an amplitude change detected by an optical output unit (light transmission unit) of the iToF camera 22. The amplitude change of the reception light (reflected wave) indicated by the dotted line is an amplitude change detected by an optical input unit (light reception unit) of the iToF camera 22.

As an object distance at which light is reflected is larger (farther), a deviation between the transmission light (output light) and the reception light (reflected light) becomes larger.

As illustrated in the graph of FIG. 2(b), the deviation between the transmission light (output light) and the reception light (reflected light) can be detected as a phase difference between the transmission light (output light) and the reception light (reflected light).

The phase difference is larger as the object distance is larger (farther).

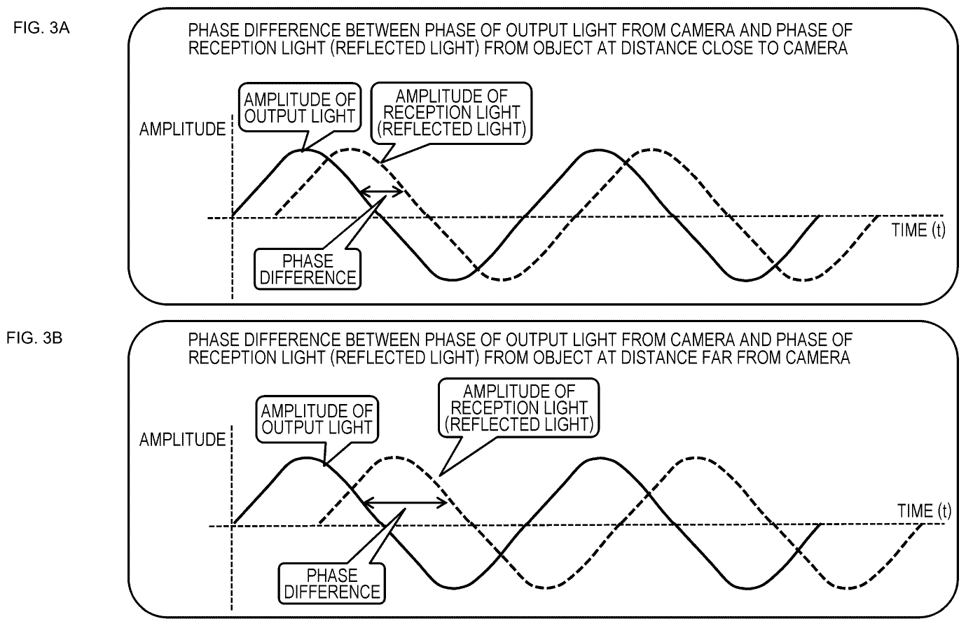

FIG. 3 shows a graph illustrating a specific example of a phase difference between a case where the object distance is small (close) and a case where the object distance is large (far).

The graph illustrated in FIG. 3(a) illustrates an amplitude change (solid line) of transmission light (output light) and an amplitude change (dotted line) of reception light (reflected light), in a case where the object distance is small (close).

FIG. 3(b) illustrates an amplitude change (solid line) of transmission light (output light) and an amplitude change (dotted line) of reception light (reflected light), in a case where the object distance is large (far).

Comparing phase differences corresponding to amounts of deviation between the transmission light and the reception light illustrated in FIG. 3(a) and 3(b), the phase difference in the case of the distant object illustrated in FIG. 3(b) is larger than the phase difference in the case of the close object illustrated in FIG. 3(a).

This is because a reception time of the reception light is delayed as the object is farther. That is, the phase difference is larger as the object distance is larger (farther).

The iToF camera is a distance sensor capable of calculating an object distance based on a phase difference between transmission light (output light) and reception light (reflected light) by using this principle.

However, when the object distance is calculated using the iTOF camera, erroneous detection (aliasing) may occur in which an object that is actually at a far distance is determined as an object at a close distance different from the actual distance.

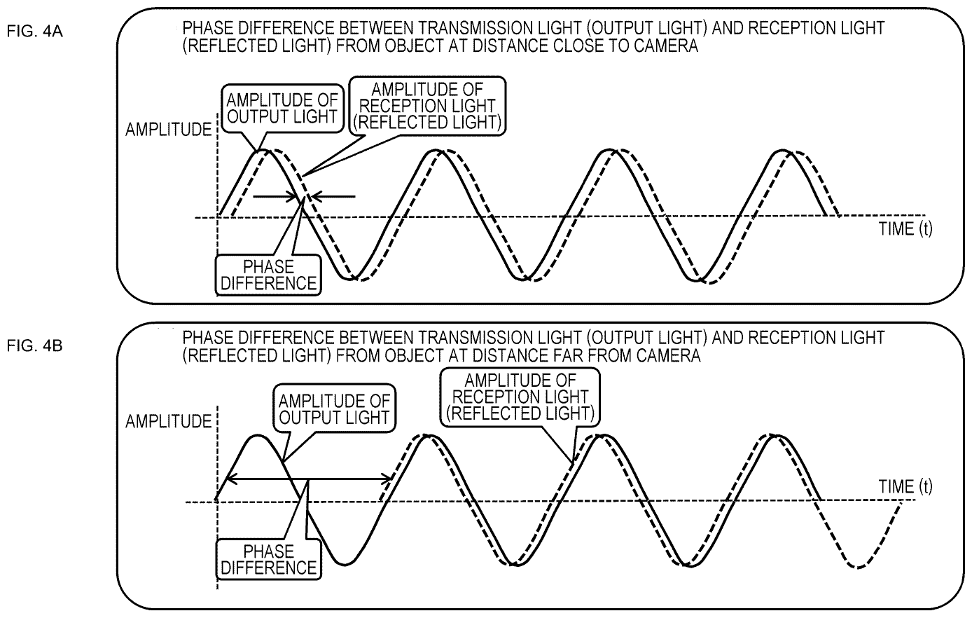

This problem will be described with reference to FIG. 4 and subsequent figures.

As described above, the iToF camera is configured to calculate a distance in accordance with a phase difference between transmission light (output light) and reception light (reflected light).

The phase difference between the transmission light (output light) and the reception light (reflected light) can be detected only in a range of 0 to 2π. That is, a maximum detectable distance (for example, the phase difference=2π) is to be defined according to a frequency of the transmission light (output light).

FIG. 4 illustrates the following two figures.
(a) An example of a phase difference between transmission light (output light) and reception light (reflected light) in a case where the object distance is small (close)
(b) An example of a phase difference between transmission light (output light) and reception light (reflected light) in a case where the object distance is large (far)

The example of FIG. 4(a) is an example of a phase difference between transmission light (output light) and reception light (reflected light) in a case where the object distance is small (close), and the phase difference has a value close to zero.

Whereas, the example of FIG. 4(b) is an example of a phase difference between transmission light (output light) and reception light (reflected light) in a case where the object distance is large (far), and the phase difference has a value close to 2π.

As described above, the phase difference between the transmission light (output light) and the reception light (reflected light) can be detected only in the range of 0 to 2π, and the maximum detectable distance (for example, the phase difference=2π) is defined according to a frequency of the transmission light (output light).

For example, even if the actual phase difference between the transmission light (output light) and the reception light (reflected light) is not 2π but 4π or 6π with a cycle delay, there is a possibility that the object is determined to be at a distance similar to the case of the phase difference=2π, and an object at a long distance for which a reflected wave having a phase difference of 4π or 6π is generated is erroneously determined as an object at a short distance corresponding to the phase difference=2π.

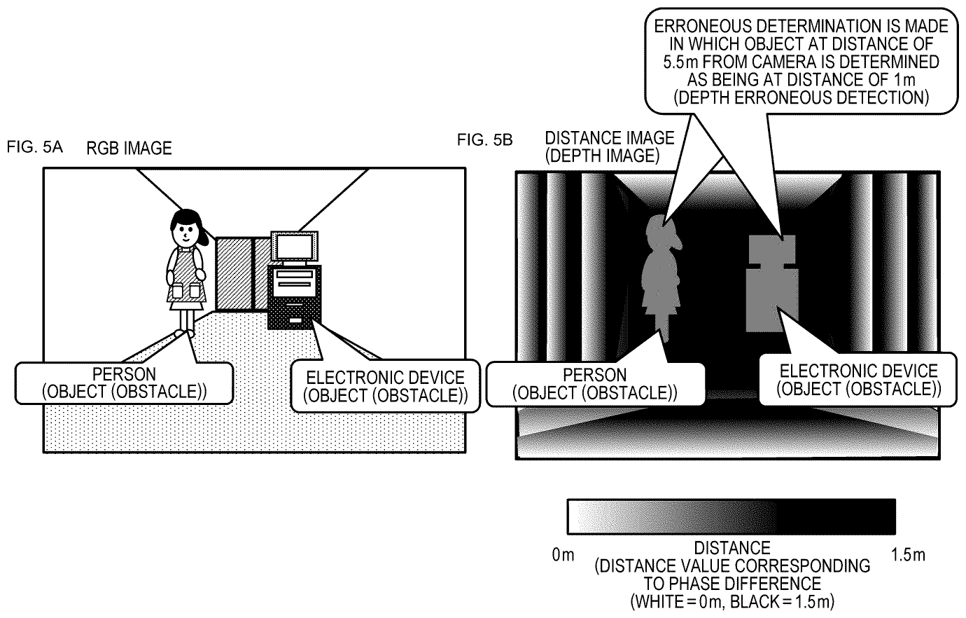

A specific example will be described with reference to FIG. 5 and subsequent figures.

FIG. 5 illustrates an example of “(a) an RGB image” captured by the RGB camera 21 of the robot 10 and “(b) a distance image (depth image)” based on a phase difference between transmission light (output light) and reception light (reflected light) analyzed using the iToF camera 22, in a case where the robot 10 travels in a travel environment similar to the travel environment example described above with reference to FIG. 1(A).

Note that the distance image illustrated in FIG. 5(b) is a schematic image example of an incorrect distance image generated on the basis of erroneous detection of an object distance.

The iToF camera used here is assumed to be a camera with a measurable object distance of 0 to 1.5 m. That is, an example is shown in which an iToF camera is used with setting in which the object distance is 1.5 m in a case where a maximum phase difference between transmission light (output light) and reception light (reflected light) of the iToF camera is 2π.

When such an iToF camera is used, correct distance detection cannot be performed for an object farther than the maximum measurable distance=1.5 m.

In the example illustrated in FIG. 5, objects such as the person (object) and the electronic device (object) are at a distance of 5.5 m from the iToF camera 22 attached to the robot 10.

In the iToF camera with the maximum measurable distance=1.5 m, distance calculation is erroneously executed for these objects at the distance of 5.5 m, for example, the calculated distance is to be 1.0 m or the like.

“(b) Distance image (depth image)” illustrated in FIG. 5(b) is an image in which a pixel value (luminance value) is set according to a phase difference between transmission light (output light) and reception light (reflected light) analyzed using the iToF camera with the maximum measurable distance=1.5 m.

In a luminance image, the luminance is lower (close to black) as the phase difference between the transmission light (output light) and the reception light (reflected light) is larger, and the luminance is higher (close to white) as the phase difference is smaller.

For example, a pixel with the phase difference=2π is set to black and indicates the object distance=1.5 m. Furthermore, a pixel with the phase difference=0 is set to white, and indicates the object distance=0 m.

Note that, as described above, “(b) Distance image (depth image)” illustrated in FIG. 5(b) is an example of a distance image (depth image), and is an image in which a luminance value according to a phase difference is set to each pixel. However, for example, a color image may also be used in which color according to the phase difference is set to each pixel. For example, a distance image (depth image) or the like is possible in which color is closer to red as the phase difference is larger (=the distance is longer) and color is closer to blue as the phase difference is smaller (=the distance is shorter).

The distance image illustrated in FIG. 5(b) is a distance image generated using an iToF camera with a measurable object distance=0 to 1.5 m, and an incorrect pixel value (luminance value) is set for an object at the object distance of 1.5 m or more.

As described above, the person (object) and the electronic device (object) are at the distance of 5.5 m from the iToF camera 22 attached on the robot 10, and the measurable object distance 0 to 1.5 m of the iToF camera is exceeded. Therefore, it is not possible to perform correct calculation of the distance for the objects such as the person and the electronic device in the distance image illustrated in FIG. 5(b). As a result, the pixel value (luminance value) of the distance image is set to a pixel value indicating an incorrect distance.

That is, for the person and the electronic device object, an incorrect distance value based on a phase difference between transmission light (output light) and reception light (reflected light) of the iToF camera 22 is calculated. Therefore, the pixel value (luminance value) corresponding to the incorrect distance value is set.

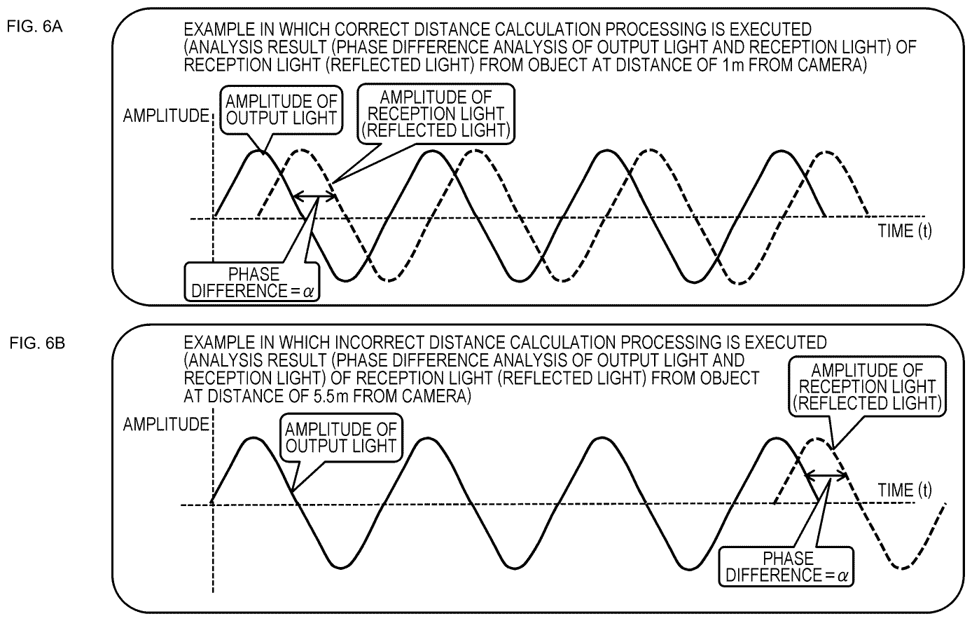

The reason why such erroneous detection occurs will be described with reference to FIG. 6.

FIG. 6 illustrates specific examples of an amplitude waveform and a phase difference of transmission light (output light) and reception light (reflected light) of the following two examples, as an example of object distance calculation processing using an iToF camera with the measurable object distance=0 to 1.5 m.
(a) Example in which correct distance calculation is executed (object distance=1.0 m)
(b) Example in which incorrect distance calculation is executed (object distance=5.5 m)

The example illustrated in FIG. 6(a) is a phase difference analysis result based on reception light (reflected light) from an object at the object distance=1.0 m, and a phase difference=α is measured between transmission light (output light) and reception light (reflected light) of the iTOF camera 22. α is a value within a range of 0 to 2π.

The measurable object distance of the iToF camera is 0 to 1.5 m. The object distance is 0 when the phase difference is 0, and the object distance is 1.5 m when the phase difference is 2π. In the example of FIG. 6(a), the phase difference is α (0≤α≤2π), and a correct object distance=1 m is calculated as a calculated distance in accordance with the phase difference=α (0≤α≤2π).

Whereas, the example illustrated in FIG. 6(b) is a phase difference analysis result based on reception light (reflected light) from an object at the object distance=5.5 m.

As understood from waveforms of the transmission light (output light) and the reception light (reflected light) in FIG. 6(b), in this case, the phase difference=α exactly the same as the example illustrated in FIG. 6(a) is measured as the phase difference between the transmission light (output light) and the reception light (reflected light) of the iTOF camera 22. α is a value within a range of 0 to 2π.

As a result, even for the object with the object distance=5.5 m, distance calculation based on exactly the same phase difference=α as in the example of FIG. 6(a) is performed, and an incorrect object distance of 1 m is calculated instead of the original object distance of 5.5 m.

As described above, an incorrect distance is calculated for an object at a distance exceeding the measurable object distance of the iToF camera to be used.

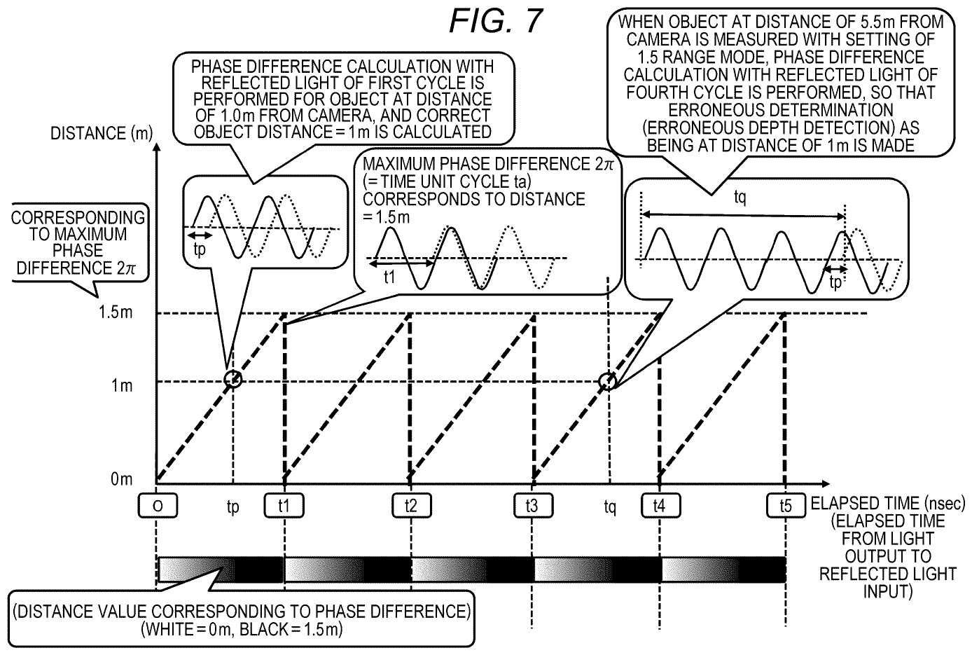

Moreover, details of erroneous detection (aliasing) of an object distance by the iToF camera will be described with reference to FIG. 7.

The graph illustrated in FIG. 7 is a graph in which a horizontal axis represents an elapsed time (nsec) from an output time of transmission light (output light) to a reception time of reception light (reflected light) of the iToF camera, and a vertical axis represents an object distance (m) calculated on the basis of a phase difference between the transmission light (output light) and the reception light (reflected light).

Note that, the measurable object distance of the iToF camera is 0 to 1.5 m. The object distance is 0 when the phase difference is 0, and the object distance is 1.5 m when the phase difference is 2π.

For example, in the elapsed time on the horizontal axis, a range of the elapsed time=0 to t1 is a range in which a correct distance can be calculated in this iToF camera.

The object distance is 0 m when the elapsed time is 0, and the object distance is 1.5 m when the elapsed time is t1.

An example of the elapsed time=tp is an example similar to the example described above with reference to FIG. 6(a), and corresponds to a case of the object distance=1.0 m.

Whereas, in the elapsed time on the horizontal axis, a region exceeding the elapsed time=t1 is a region where a correct distance cannot be calculated in this iToF camera (measurable object distance=0 to 1.5 m).

In the elapsed time=to to t1, the phase difference between the transmission light (output light) and the reception light (reflected light) sequentially increases in a range of 0 to 2π, and a correct object distance=0 to 1.5 m according to the phase difference=0 to 2π is calculated.

Thereafter, even in the elapsed time=t1 to t2, the phase difference between the transmission light (output light) and the reception light (reflected light) sequentially increases in the range of 0 to 2m. That is, a phase difference change=0 to 2π in the second cycle occurs.

Therefore, also in the elapsed time=t1 to t2, similarly to the elapsed time=t0 to t1, the object distance=0 to 1.5 m according to the phase difference=0 to 2π is calculated. This calculated distance is an incorrect distance.

Thereafter, even in a case of the elapsed time=t2 to t3, the elapsed time=t3 to t4, and the elapsed time=t4 to t5, the phase difference change=0 to 2π of the third to fifth cycles occurs.

Therefore, in each of these cycles, similarly to the elapsed time=t0 to t1, the object distance=0 to 1.5 m according to the phase difference=0 to 2π is calculated. This calculated distance is an incorrect distance.

Note that, for example, the elapsed time=tq within the elapsed time=t3 to t4 corresponds to an elapsed time until reception of the reflected light from the object at the object distance=5.5 m described above with reference to FIG. 6(b).

The phase difference between the transmission light (output light) and the reception light (reflected light) with respect to the object at the object distance=5.5 m is the same as the phase difference similar to the elapsed time=tp within the elapsed time=t0 to t1. As a result, the incorrect object distance=1.0 m is calculated.

As described above, the iToF camera to be used has a problem that erroneous detection (aliasing) of a calculated distance occurs for an object at a distance exceeding a measurable object distance.

Note that the measurable distance of the iToF camera is defined by a frequency of output light of the iToF camera. In order to increase the measurable distance of the iToF camera, the frequency of output light of the iToF camera may simply be set low, that is, a cycle may simply be increased.

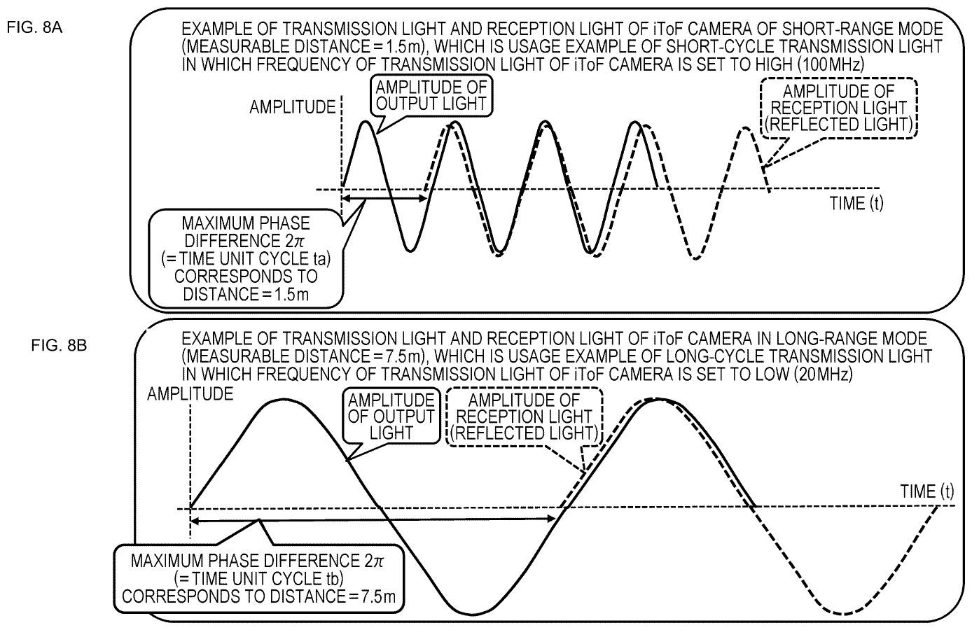

With reference to FIG. 8, a relationship between a frequency of output light of the iToF camera and a measurable distance will be described.

FIG. 8 illustrates the following two examples.
(a) An example of transmission light and reception light of the iToF camera in a short-range mode (measurable distance=1.5 m), which is a usage example of short-cycle transmission light in which a frequency of transmission light of the iToF camera is set to high (100 MHz)
(b) An example of transmission light and reception light of the iToF camera in a long-range mode (measurable distance=7.5 m), which is a usage example of long-cycle transmission light in which a frequency of transmission light of the iToF camera is set to low (20 MHz)

As understood from a graph of FIG. 8(a), in the short-range mode which is a usage example of short-cycle transmission light in which a frequency of transmission light of the iToF camera is set to high (100 MHz), an object distance measured with the maximum value=2πof a phase difference between transmission light (output light) and reception light (reflected light) is 1.5 m.

Whereas, as understood from a graph of FIG. 8(b), in the long-range mode which is a usage example long-cycle transmission light in which a frequency of transmission light of the iToF camera set to low (20 MHz), an object distance measured with the maximum value=2π of a phase difference between transmission light (output light) and reception light (reflected light) is 7.5 m.

In this manner, the measurable distance of the iToF camera can be changed by changing the frequency, that is, the cycle of output light of the iToF camera.

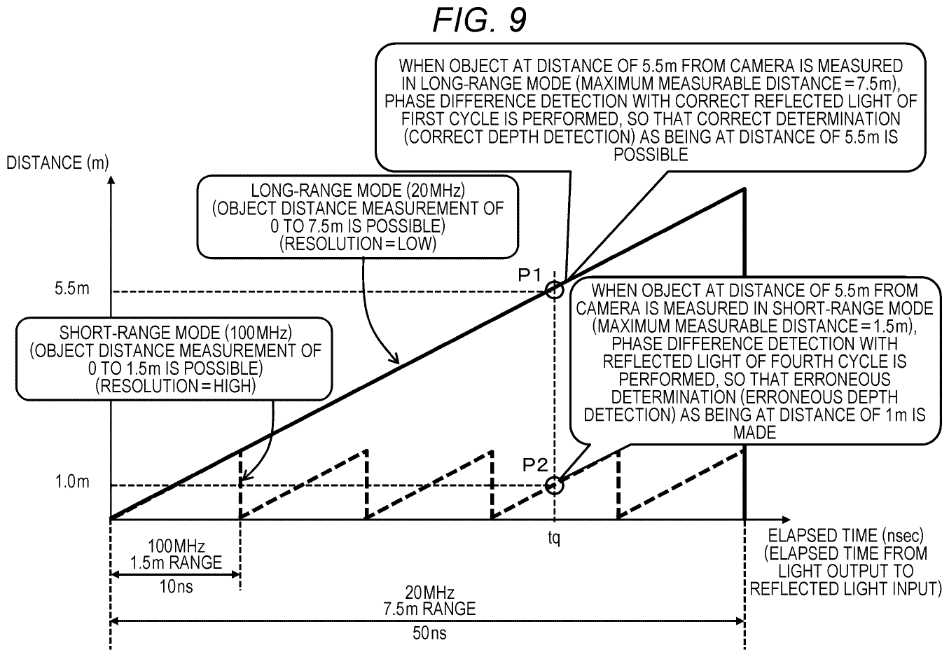

FIG. 9 is a diagram in which data of the long-range mode (correspondence data between an elapsed time and a distance) described with reference to FIG. 8(b) is added to the graph of FIG. 7 described above.

Similarly to FIG. 7 described above, the graph illustrated in FIG. 9 is a graph in which a horizontal axis represents an elapsed time (nsec) from an output time of transmission light (output light) to a reception time of reception light (reflected light) of the iToF camera, and a vertical axis represents an object distance (m) calculated on the basis of a phase difference between the transmission light (output light) and the reception light (reflected light).

A graph indicated by a dotted line is data in the short-range mode (correspondence data between an elapsed time and a distance) described with reference to FIG. 8(a). This is a graph similar to the graph described above with reference to FIG. 7, and is a graph of the iToF camera in the short-range mode with the measurable distance=0 to 1.5 m. In the iToF camera in the short-range mode, the phase difference=0 corresponds to the object distance=0, and the phase difference=2π corresponds to the object distance=1.5 m.

In this regard, a graph indicated by a solid line is data of the long-range mode (correspondence data between an elapsed time and a distance) described with reference to FIG. 8(b). That is, the graph is of the iToF camera in the long-range mode with the measurable distance=0 to 7.5 m. In the iToF camera in the long-range mode, the phase difference=0 corresponds to the object distance=0, and the phase difference=2π corresponds to the object distance=7.5m.

For example, the elapsed time tq corresponds to the elapsed time tq until reception of reflected light from the object at the object distance=5.5 m described above with reference to FIG. 7.

In a case where the iToF camera in the short-range mode with the measurable distance=0 to 1.5 m is used, as described above with reference to FIG. 7, the incorrect object distance=1.0 m is calculated as indicated by a point P2 on the dotted-line graph.

Whereas, in a case where the iToF camera in the long-range mode with the measurable distance=0 to 7.5 m is used, the correct object distance=5.5 m is calculated as indicated by a point P1 on the solid-line graph.

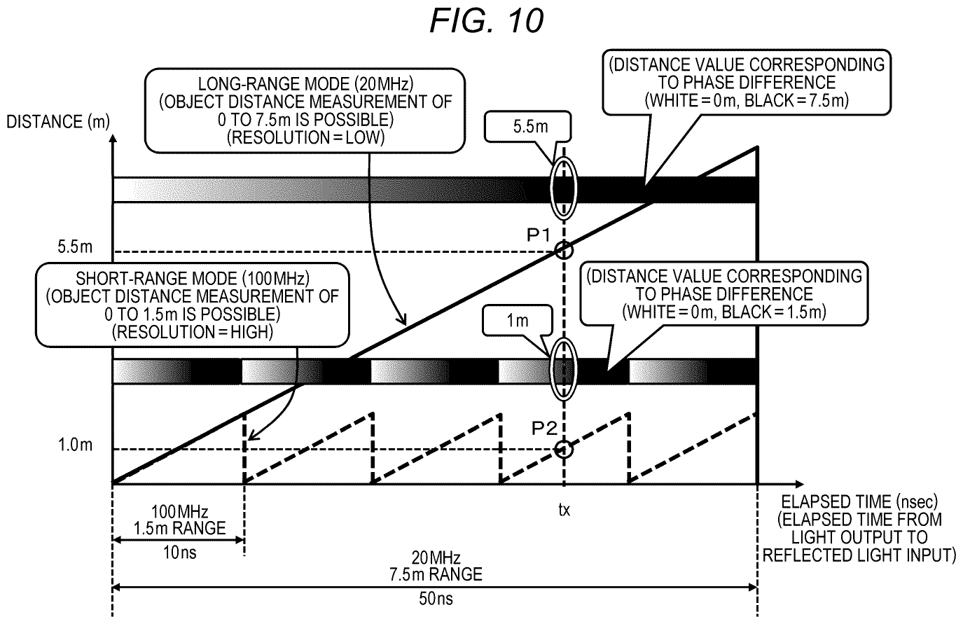

FIG. 10 is a diagram illustrating pixel values (luminance values) of a distance image (depth image) based on distance data calculated on the basis of the phase difference on the graph described with reference to FIG. 9.

In a case where the iToF camera in the short-range mode with the measurable distance=0 to 1.5 m is used, pixel values=white to black indicating the distance=0 to 1.5 m are repeated similarly to the cycle of the dotted-line graph.

That is, the pixel value of the distance image (depth image) indicates a correct distance for an object at the object distance of 1.5 m or less, but the pixel value of the distance image (depth image) indicates an incorrect distance for an object at the object distance exceeding 1.5 m.

Whereas, in a case where the iToF camera in the long-range mode with the measurable distance=0 to 7.5 m is used, there is one piece of change data with the pixel values=white to black indicating the distance=0 to 7.5 m corresponding to the solid-line graph.

That is, for an object at the object distance of 7.5 m or less, all the pixel values of the distance image (depth image) indicate correct distances.

In this manner, the measurable distance of the iToF camera can be changed by changing the frequency, that is, the cycle of output light of the iToF camera.

However, when the measurable distance is increased, there is a problem that accuracy of a calculated distance decreases.

Therefore, in a case where it is necessary to perform highly accurate distance calculation, it is preferable to use a camera with a measurable distance set to small.

### 2. Configuration Example of Information Processing Device of Present Disclosure

Next, a configuration example of the information processing device of the present disclosure will be described.

As described above, the information processing device of the present disclosure is a device that is attached on a mobile body such as a robot or a vehicle and calculates an object distance by using an iToF camera.

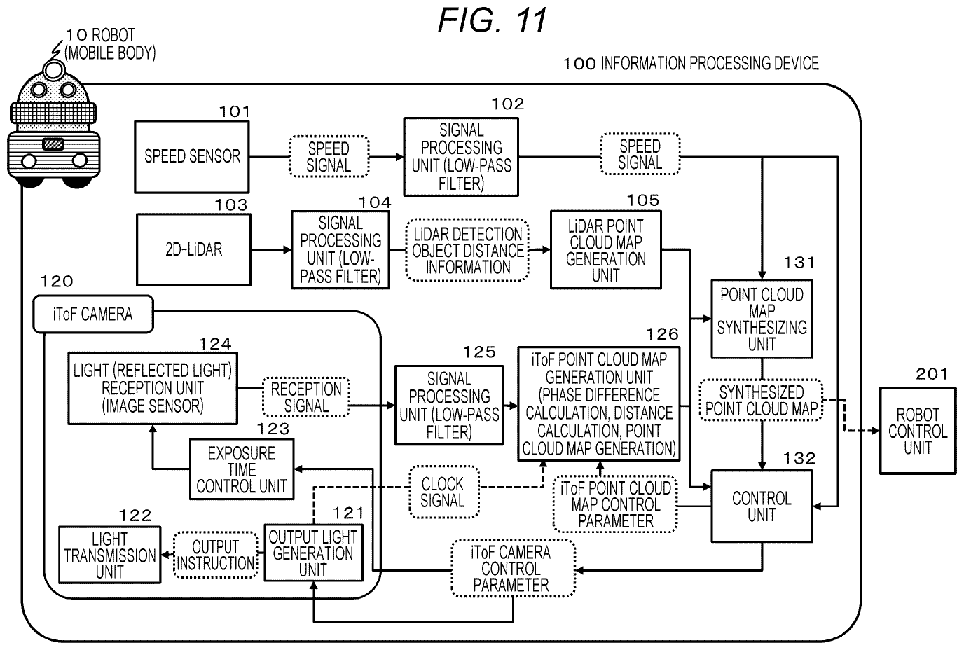

With reference to FIG. 11, a configuration example of the information processing device of the present disclosure will be described.

As illustrated in FIG. 11, an information processing device 100 of the present disclosure includes a speed sensor 101, a signal processing unit (low-pass filter) 102, a 2D-LiDAR 203, a signal processing unit (low-pass filter) 104, a LiDAR point cloud map generation unit 105, an iTOF camera 120, a signal processing unit (low-pass filter) 125, an iToF map generation unit 126, a point cloud map synthesizing unit 131, and a control unit 132.

Note that the iToF camera 120 includes an output light generation unit 121, a light transmission unit 122, an exposure time control unit 123, and a light reception unit (image sensor) 124.

Hereinafter, components of the information processing device 100 will be sequentially described.

The speed sensor 101 is a sensor that detects a moving speed of the robot 10, which is a mobile body to which the information processing device 100 is attached. A speed signal detected by the speed sensor 101 is input to the point cloud map synthesizing unit 131 via the signal processing unit (low-pass filter) 102.

Note that the signal processing unit (low-pass filter) 102 performs processing of removing a noise signal from the speed signal detected by the speed sensor 101.

The 2D-LiDAR 103 is a light detection and ranging (LiDAR) as a sensor that outputs laser light and analyzes reflected light of the laser light from an object, to measure a position and a distance of an obstacle.

The information processing device 100 of this embodiment uses the 2D-LiDAR 103 which is a 2D LiDAR.

The 2D-LiDAR 103 scans a two-dimensional plane with laser light, analyzes reflected light from an object in each direction on the two-dimensional plane, and calculates a distance of the object in each direction on the two-dimensional plane.

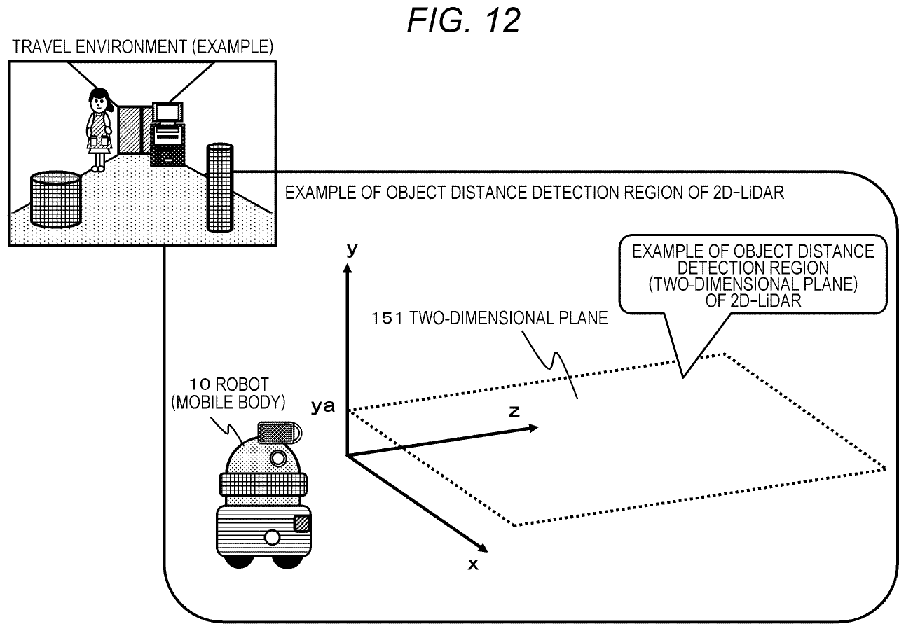

A specific example of the two-dimensional plane in which the 2D-LiDAR 103 detects the object distance is illustrated in FIG. 12.

FIG. 12 illustrates an example of a two-dimensional plane 151 on which the 2D-LiDAR 103 executes object distance detection processing.

As illustrated in FIG. 12, when a traveling direction of the robot 10 is a z-axis direction, a right direction of the robot is an x-axis, and a vertical upward direction is a y-axis, the two-dimensional plane 151 is one xz plane with y=ya parallel to a robot traveling plane (xz plane with y=0).

The two-dimensional plane 151 is a two-dimensional plane on which the 2D-LiDAR 103 executes the object distance detection processing.

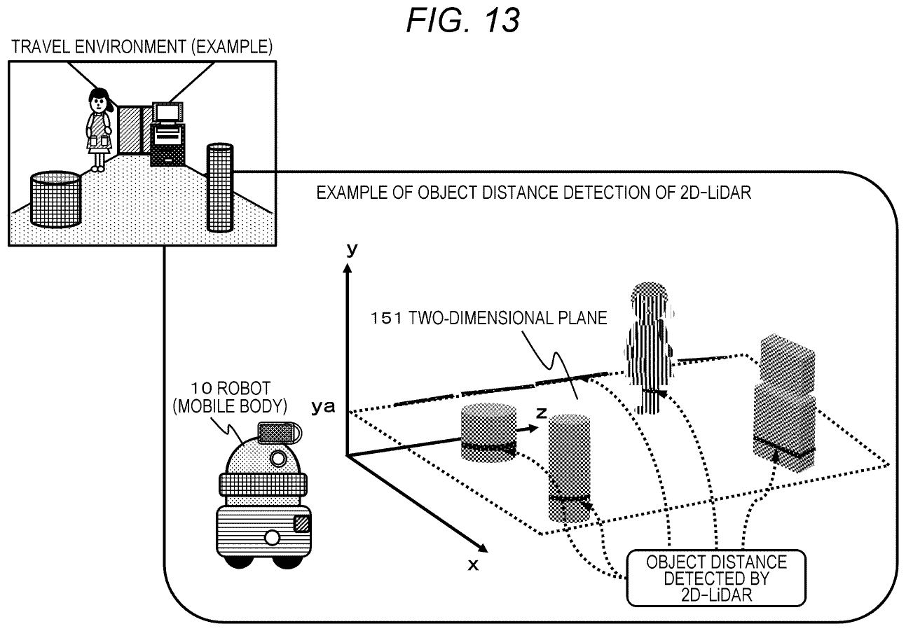

For example, in a case where the robot 10 travels in a travel environment as illustrated in the upper left of FIG. 12, when the 2D-LiDAR 103 executes the object distance detection processing, as illustrated in FIG. 13, a part of an object intersecting the two-dimensional plane 151 at a certain height (y=ya) of each object is detected, and a position and a distance is analyzed.

Information including the object position and distance on the two-dimensional plane analyzed by the 2D-LiDAR 103 is input to the LiDAR point cloud map generation unit 105 via the signal processing unit (low-pass filter) 104.

Note that the signal processing unit (low-pass filter) 104 performs processing of removing a noise signal from the information including the object position and distance on the two-dimensional plane analyzed by the 2D-LiDAR 103.

The LiDAR point cloud map generation unit 105 generates a point cloud map by using the information including the object position and distance on the two-dimensional plane analyzed by the 2D-LiDAR 103.

The point cloud map is a map indicating a point cloud at a position of an object such as an obstacle. For example, a three-dimensional point cloud map is a map showing a point cloud at an object position on xyz three-dimensional coordinates. A two-dimensional point cloud map is a map showing a point cloud at an object position on a two-dimensional plane.

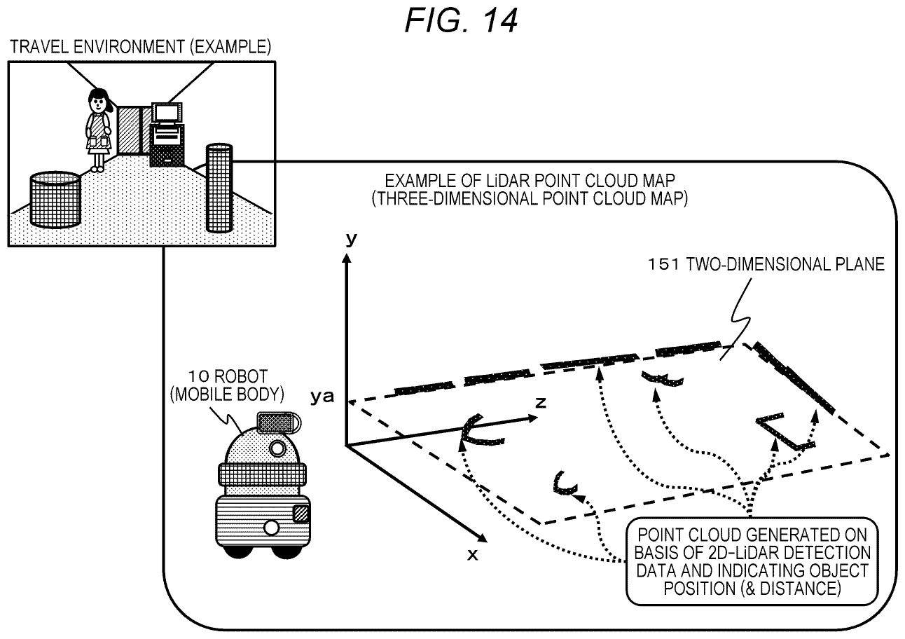

FIG. 14 illustrates an example of a point cloud map generated by the LiDAR point cloud map generation unit 105.

The point cloud map illustrated in FIG. 14 is a point cloud map generated when the robot 10 travels in a travel environment illustrated in the upper left of FIG. 14.

That is, the 2D-LiDAR 103 analyzes an object position and distance on the two-dimensional plane 151 described above with reference to FIG. 13, and the LiDAR point cloud map generation unit 105 generates this point cloud map (two-dimensional point cloud map) by using the analysis result.

As described above with reference to FIGS. 12 and 13, the 2D-LiDAR 103 detects only an object intersecting the two-dimensional plane 151 at a certain height (y=ya), and the point cloud map generated by the LiDAR point cloud map generation unit 105 is a map in which a point cloud corresponding to the object is set only on the two-dimensional plane 151 at the height (y=ya).

The point cloud map (LiDAR point cloud map) based on the LiDAR detection data and generated by the LiDAR point cloud map generation unit 105 is input to the point cloud map synthesizing unit 131.

The point cloud map synthesizing unit 131 executes synthesizing processing on a point cloud map (LiDAR point cloud map) based on LiDAR detection data and generated by the LiDAR point cloud map generation unit 105 and a point cloud map (iToF point cloud map) generated by an iToF point cloud map generation unit 125 on the basis of detection data of the iToF camera 120.

Processing executed by the point cloud map synthesizing unit 131 will be described later.

Next, a configuration and processing of the iToF camera 120 will be described.

As illustrated in FIG. 11, the iToF camera 120 includes the output light generation unit 121, the light transmission unit 122, the exposure time control unit 123, and the light reception unit (image sensor) 124.

The output light generation unit 121 sets parameters of output light such as laser light output from the light transmission unit 122, generates light according to the setting parameters, and outputs the light from the light transmission unit 122.

Note that the output light generation unit 121 generates output light having a frequency and intensity calculated by the control unit 132, and outputs the output light from the light transmission unit 122.

Note that the control unit 132 executes processing of calculating control parameters of the iToF camera 120 and control parameters of the iToF point cloud map generated by the iToF point cloud map generation unit 126, by using a movement speed of the robot 10, an analysis result of a point cloud map generated by the point cloud map synthesizing unit 131, and the like.

iToF camera control parameters calculated by the control unit 132 are, for example, output light control parameters such as a frequency and intensity of output light output from the light output unit 122 of the iToF camera 120, parameters such as an exposure time of the light (reflected light) reception unit (image sensor) 124, and the like.

Furthermore, the point cloud map control parameter calculated by the control unit 132 is a parameter or the like that defines a point cloud cut region of the iTOF point cloud map generated by the iToF point cloud map generation unit 126.

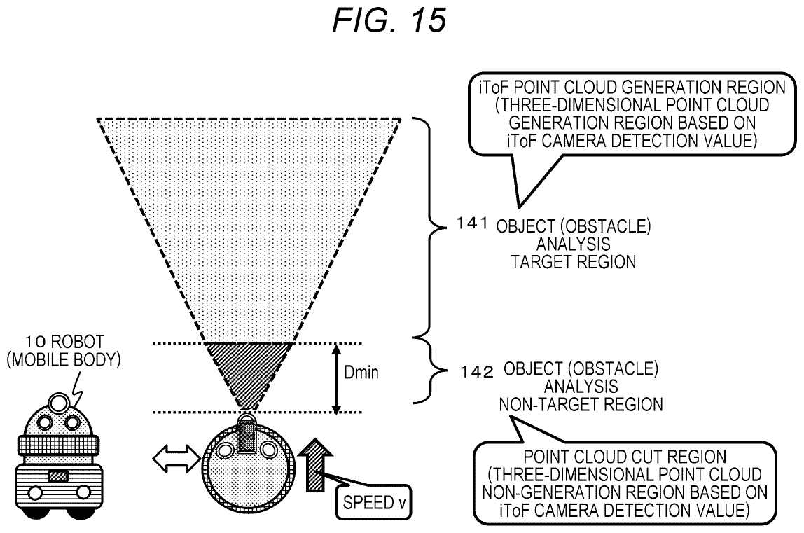

The point cloud cut region will be described with reference to FIG. 15.

It is assumed that the robot 10 illustrated in FIG. 15 is traveling forward (upward in the figure) at a speed (v) at a predetermined speed (v).

The robot 10 travels while generating a traveling route that does not cause collision or contact with an object (obstacle), while detecting an obstacle in the traveling direction.

However, a certain period of time is required for traveling direction change processing, speed change processing, or stop processing by the robot 10, and the robot 10 also travels forward during that period.

Therefore, the robot 10 needs to perform processing of determining the traveling route on the basis of an object (obstacle) that is present in front at a certain distance, not immediately in front of the robot 10.

Specifically, for example, the traveling route is determined on the basis of the object (obstacle) that is present in an object (obstacle) analysis target region 141 illustrated in FIG. 15. Whereas, an object (obstacle) analysis non-target region 142 illustrated in FIG. 15 is a region where an object (obstacle) has been analyzed in advance, and traveling is executed according to a route generated according to a result of the preliminary analysis.

The object (obstacle) analysis target region 141 illustrated in FIG. 15 is a region that requires object analysis for determining the traveling route of the robot 10, and is a region that requires analysis of an object position and distance by using an iToF point cloud map generated by the iToF point cloud map generation unit 126. That is, a point cloud corresponding to the object needs to be generated in the iToF point cloud map generated by the iToF point cloud map generation unit 126.

Whereas, the object (obstacle) analysis non-target region 142 illustrated in FIG. 15 is a region where an object analysis has already been completed and the traveling route of the robot 10 has already been determined, and the object analysis at the present moment is unnecessary. That is, at the current position of the robot 10, new object analysis by the iToF point cloud map is unnecessary for the object (obstacle) analysis non-target region 142.

Therefore, this region is to be a region where it is not necessary to generate a point cloud corresponding to the object in the iToF point cloud map generated by the iToF point cloud map generation unit 126. This region is referred to as a “point cloud cut region”.

Note that Dmin illustrated in FIG. 15 is a maximum distance of the point cloud cut region from the robot 10, and corresponds to a point cloud cut region control parameter calculated by the control unit 132.

Details of the point cloud cut region control parameter (Dmin) and a specific example of calculation processing will be described later.

A size of the “point cloud cut region” varies depending on a traveling speed of the robot 10. In a case where a traveling speed of the robot 10 is fast, the processing of determining the traveling route is performed on the basis of an object (obstacle) farther in front. Whereas, in a case where the traveling speed of the robot 10 is slow, the traveling route determination processing is performed on the basis of an object (obstacle) at a position close to the robot 10 in some degree.

Therefore, as the traveling speed of the robot 10 is higher, the “point cloud cut region” can be set to be large up to a distance farther from the robot 10.

Details of the processing of setting the point cloud cut region according to a robot speed will be described later.

Note that, by setting the point cloud cut region, the iToF point cloud map generation unit 126 does not need to perform processing of generating a three-dimensional point cloud of the point cloud cut region close to the robot 10, and a processing load is reduced.

As a result, processing loads on the information processing device 100 and the robot 10 can be reduced, and battery consumption can be reduced.

Returning to FIG. 11, the description of the configuration of the information processing device 100 of the present disclosure will be continued.

As described above, the control unit 132 generates output light control parameters such as a frequency and intensity of output light output from the light output unit 122 of the iToF camera 120, parameters such as an exposure time of the light (reflected light) reception unit (image sensor) 124, a parameter that defines a point cloud cut region of the iTOF point cloud map generated by the iToF point cloud map generation unit 126, and the like.

Note that details of parameter calculation processing executed by the control unit 132 will be described later.

The output light generation unit 121 of the iToF camera 120 adjusts a frequency and intensity of output light such as laser light in accordance with control parameters (frequency, intensity, and the like) calculated by the control unit 132, generates light according to the control parameters, and outputs the light from the light transmission unit 122.

The light output from the light transmission unit 122 is, for example, light having an amplitude of a predetermined frequency as described above with reference to FIG. 2(b).

When the light output from the light transmission unit 122 is reflected by an object such as an obstacle, the reflected light is input to the light (reflected light) reception unit (image sensor) 124.

Note that the light (reflected light) reception unit (image sensor) 124 includes an image sensor including a large number of pixels similarly to a normal camera, and a reception signal of each pixel is output to the signal processing unit (low-pass filter) 125.

The signal processing unit (low-pass filter) 125 performs processing of removing a noise signal from a speed signal detected by the speed sensor 101, and a reception signal of the light (reflected light) reception unit (image sensor) 124 from which the noise has been removed is input to the iToF point cloud map generation unit 126.

The iToF point cloud map generation unit 126 generates an iTOF point cloud map on the basis of a reception signal of the light (reflected light) reception unit (image sensor) 124.

The iToF point cloud map generation unit 126 first calculates a phase difference between reception light (reflected light) input by each pixel of the image sensor and transmission light (output light) output by the light transmission unit 122 on the basis of a reception signal of the light (reflected light) reception unit (image sensor) 124, and calculates a distance of an object reflecting the reception light (reflected light) input to each pixel on the basis of the calculated phase difference.

The phase difference calculation processing and the object distance calculation processing are executed according to, for example, the processing described above with reference to FIG. 2(b) and the like and the processing described with reference to FIGS. 9 and 10.

The iToF point cloud map generation unit 126 further generates an iToF point cloud map (three-dimensional point cloud map) indicating an object position and distance corresponding to each pixel of the light (reflected light) reception unit (image sensor) 124.

The point cloud map is a map showing a point cloud at a position of an object such as an obstacle as described above. For example, a three-dimensional point cloud map is a map showing a point cloud at an object position on xyz three-dimensional coordinates.

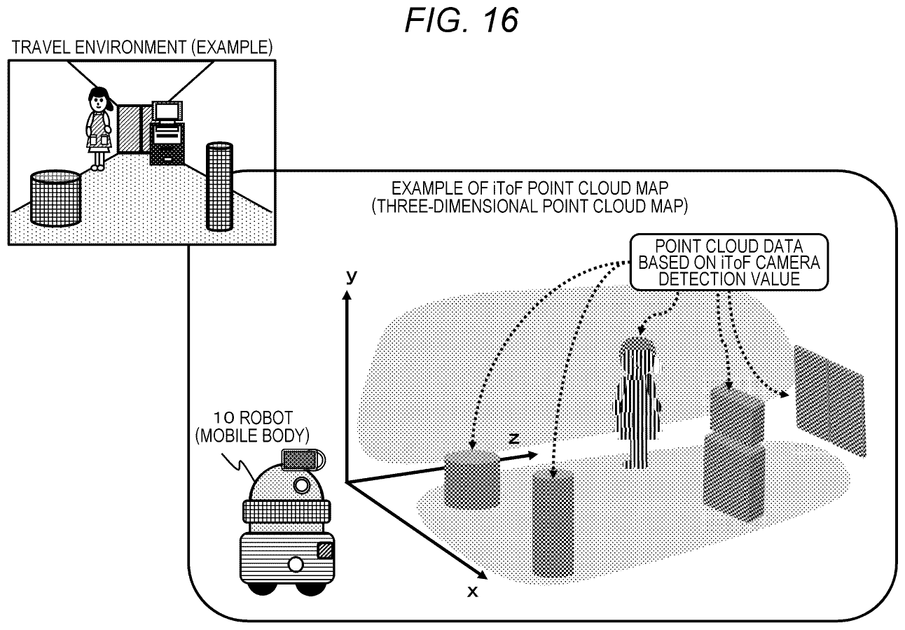

FIG. 16 illustrates an example of a point cloud map (three-dimensional point cloud map) generated by the iToF point cloud map generation unit 126.

The point cloud map illustrated in FIG. 16 is a point cloud map generated when the robot 10 travels in a travel environment illustrated in the upper left of FIG. 16.

The iToF point cloud map generation unit 126 calculates a phase difference between reception light (reflected light) input by each pixel of the image sensor and transmission light (output light) output by the light transmission unit 122 on the basis of a reception signal of the light (reflected light) reception unit (image sensor) 124, calculates an object distance corresponding to each pixel on the basis of the calculated phase difference, and generates the iToF point cloud map (three-dimensional point cloud map) as illustrated in FIG. 16 on the basis of the calculated distance information.

The iToF point cloud map (three-dimensional point cloud map) illustrated in FIG. 16 is a three-dimensional point cloud map indicating, as a point cloud, a position of each object (obstacle) on xyz three-dimensional space coordinates.

The point cloud map (iToF point cloud map) based on output data of the iToF camera 120 and generated by the iToF point cloud map generation unit 126 is input to the point cloud map synthesizing unit 131.

The point cloud map synthesizing unit 131 executes synthesizing processing of a point cloud map (LiDAR point cloud map) based on the LiDAR detection data and generated by the LiDAR point cloud map generation unit 105 and a point cloud map (iTOF point cloud map) generated by the iToF point cloud map generation unit 125 on the basis of detection data of the iToF camera 120.

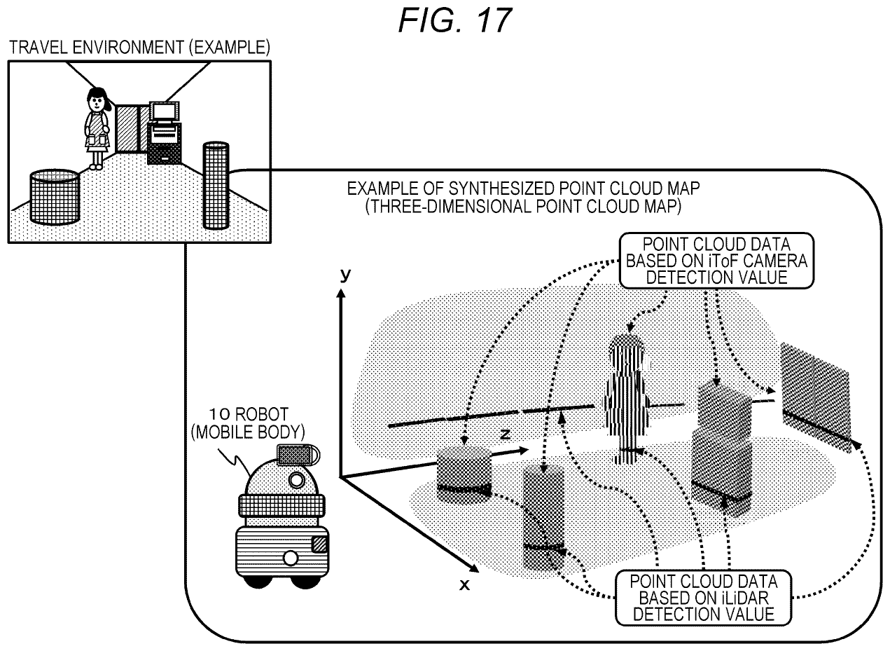

FIG. 17 illustrates an example of a synthesized point cloud map generated by the point cloud map synthesizing unit 131.

The synthesized point cloud map illustrated in FIG. 17 is a point cloud map generated in a case where traveling is performed in the travel environment illustrated in the upper left of FIG. 17.

The synthesized point cloud map illustrated in FIG. 17 is a point cloud map obtained by synthesizing the following two types of point cloud maps. That is, by synthesizing the following two types of point cloud maps:
(a) a point cloud map (LiDAR point cloud map (two-dimensional point cloud map)) on the two-dimensional plane 151 based on LiDAR detection data and generated by the LiDAR point cloud map generation unit 105 described with reference to FIG. 14; and
(b) a point cloud map (iToF point cloud map (three-dimensional point cloud map)) generated by the iToF point cloud map generation unit 125 on the basis of detection data of the iToF camera 120 described with reference to FIG. 16, the point cloud map synthesizing unit 131 generates a synthesized point cloud map as illustrated in FIG. 17.

The synthesized point cloud map generated by the point cloud map synthesizing unit 131 includes a point cloud map (LiDAR point cloud map) based on detection data of the 2D-LiDAR 103, a point cloud map (iToF point cloud map) based on detection data of the iToF camera 120, and a point cloud map generated on the basis of the detection data of these two different sensors, and is to be a point cloud map reflecting object distance data with higher accuracy.

Note that the synthesized point cloud map generated by the point cloud map synthesizing unit 131 is input to a robot control unit 201 and the control unit 132 as illustrated in FIG. 11.

The robot control unit 201 refers to the synthesized point cloud map generated by the point cloud map synthesizing unit 131 to check a position and a distance of an object that is an obstacle in traveling of the robot 10, determines a safe traveling route and traveling speed that do not cause collision or contact with the obstacle, and causes the robot 10 to travel according to the determined traveling route and traveling speed.

The control unit 132 is input with the synthesized point cloud map generated by the point cloud map synthesizing unit 131 and the traveling speed information of the robot 10 detected by the speed sensor 101, and executes, on the basis of the input information, processing of calculating a control parameter of the iToF camera 120 and a control parameter of the iToF point cloud map generated by the iToF point cloud map generation unit 126.

As described above, the iToF camera control parameters calculated by the control unit 132 are, for example, output light control parameters such as a frequency and intensity of output light output from the light output unit 122 of the iToF camera 120, a parameter such as an exposure time of the light (reflected light) reception unit (image sensor) 124, and the like.

The parameters calculated by the control unit 132 are input to the iToF camera 120.

The iToF camera 120 executes output light control, exposure control, and the like in accordance with the parameters input from the control unit 132.

Furthermore, the point cloud map control parameter calculated by the control unit 132 is a parameter or the like that defines a point cloud cut region of the iToF point cloud map generated by the iToF point cloud map generation unit 126.

The iToF point cloud map generation unit 126 executes cut processing of the point cloud of the iToF point cloud map, that is, deletion processing in accordance with the parameter input from the control unit 132.

The parameter calculation processing executed by the control unit 132 and the processing based on the calculated parameter will be described in detail in the following items.

### 3. Embodiment of Processing Executed by Information Processing Device

Next, an embodiment of processing executed by the information processing device 100 of the present disclosure will be described.

An embodiment described below is control parameter calculation processing executed by the control unit 132 in the information processing device 100 illustrated in FIG. 11, and processing based on the calculated parameter.

As illustrated in FIG. 11, the control unit 132 is input with a synthesized point cloud map generated by the point cloud map synthesizing unit 131 and traveling speed information of the robot 10 detected by the speed sensor 101.

On the basis of the input information, the control unit 132 calculates a control parameter of the iTOF camera 120 and a control parameter of the iToF point cloud map generated by the iToF point cloud map generation unit 126.

The control parameter calculated by the control unit 132 is at least one of the following control parameters.
(a) iToF point cloud cut region control parameter
(b) iToF camera output light frequency control parameter
(c) iToF camera exposure time control parameter
(d) iTOF camera output light intensity control parameter

The control unit 132 calculates at least one or more control parameters of the control parameters (a) to (d) described above.

The “(a) iToF point cloud cut region control parameter” calculated by the control unit 132 is input to the iToF point cloud map generation unit 126 illustrated in FIG. 11, and the iTOF point cloud map generation unit 126 generates an iToF point cloud map not including a point cloud of the cut region, in accordance with the input parameter.

Furthermore, the following control parameters (b) to (d) calculated by the control unit 132 are input to the iToF camera 120.
(b) iToF camera output light frequency control parameter
(c) iToF camera exposure time control parameter
(d) iToF camera output light intensity control parameter

In accordance with the parameters input from the control unit 132, the iToF camera 120 executes at least one of frequency control of output light, intensity control of output light, or exposure control.

Hereinafter, a plurality of embodiments relating to control parameter calculation processing executed by the control unit 132 and control processing executed on the basis of the calculated parameter will be sequentially described.

A plurality of embodiments described below will be sequentially described.
(First embodiment) Calculation processing of iToF point cloud cut region control parameter and processing based on calculated parameter
(Second embodiment) Calculation processing of iToF camera output light frequency control parameter and processing based on calculated parameter
(Third embodiment) Calculation processing of iToF camera exposure time control parameter and processing based on calculated parameter
(Fourth embodiment) Calculation processing of iToF camera output light intensity control parameter and processing based on calculated parameter
   [3-1. (First embodiment) Calculation processing of iToF Point Cloud Cut Region Control Parameter and Processing Based on Calculated Parameter]

First, calculation processing of an iToF point cloud cut region control parameter and processing based on the calculated parameter will be described, as a first embodiment of processing executed by the information processing device 100 of the present disclosure.

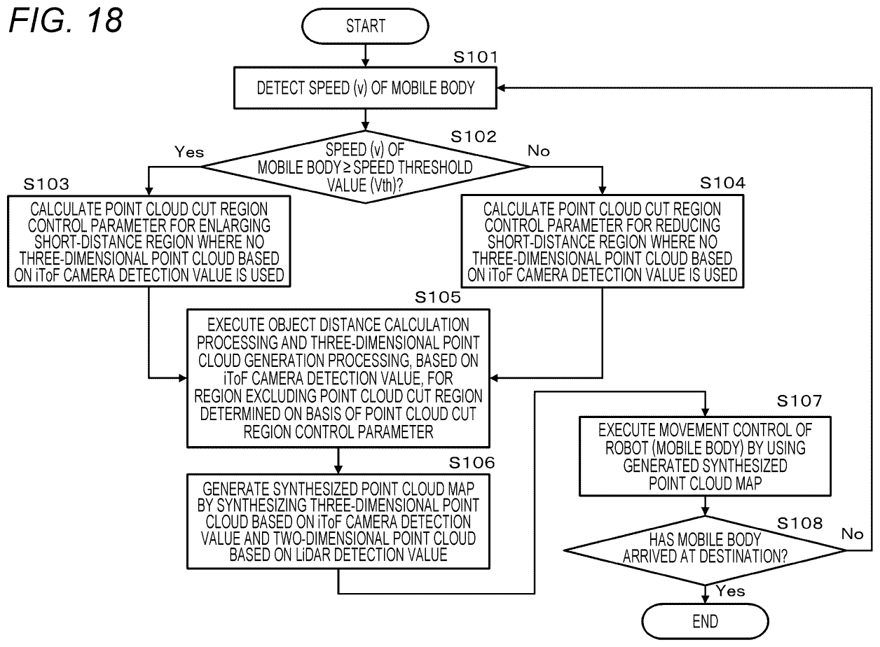

A flowchart illustrated in FIG. 18 is a flowchart for explaining calculation processing of an iToF point cloud cut region control parameter executed by the information processing device 100 of the present disclosure, and processing based on the calculated parameter.

Note that processing according to the flow described below can be executed under control of a control unit (data processing unit) including a CPU and the like having a program execution function, in accordance with a program stored in a memory inside the information processing device 100 of the present disclosure.

Hereinafter, processing of each step of the flow illustrated in FIG. 18 will be sequentially described.

### (Step S101)

First, in step S101, the information processing device 100 of the present disclosure detects a speed (v) of the robot (mobile body) 10.

The speed detection processing on the robot (mobile body) 10 is executed by the speed sensor 101 of the information processing device 100 illustrated in FIG. 11, and the detected speed (v) is input to the control unit 132 and the point cloud map synthesizing unit 131.

### (Step S102)

Next, in step S102, the information processing device 100 compares the detected speed (v) of the robot 10 with a predefined speed threshold value (Vth), and determines whether or not the speed (v) of the robot 10 is equal to or higher than the speed threshold value (Vth). That is, it is determined whether the following (Determination Formula a) is satisfied.

v≥Vth (Determination Formula a)

This processing is executed by the control unit 132 of the information processing device 100 illustrated in FIG. 11.

When it is determined that (Determination Formula a) described above is satisfied and the speed (v) of the robot 10 is equal to or higher than the speed threshold value (Vth), the process proceeds to step S103.

Whereas, when it is determined that (Determination Formula a) described above is not satisfied and the speed (v) of the robot 10 is not equal to or higher than the speed threshold value (Vth), the process proceeds to step S104.

### (Sup S103)

When it is determined in step S102 that (Determination Formula a) described above is satisfied and the speed (v) of the robot 10 is equal to or higher than the speed threshold value (Vth), the process proceeds to step S103.

In this case, in step S103, the information processing device 100 calculates a point cloud cut region control parameter for enlarging a short-distance region where no three-dimensional point cloud based on the iToF camera detection value is used.

This processing is also executed by the control unit 132 of the information processing device 100 illustrated in FIG. 11.

As described above with reference to FIG. 15, the “point cloud cut region” corresponds to the object (obstacle) analysis non-target region 142 illustrated in FIG. 15, and is a region where a point cloud corresponding to an object is unnecessary in the iToF point cloud map generated by the iToF point cloud map generation unit 126.

As described above, the traveling robot 10 performs processing of determining the traveling route on the basis of an object (obstacle) that is present in front at a certain distance, not immediately in front of the robot 10. That is, for example, the traveling route is determined on the basis of the object (obstacle) that is present in the object (obstacle) analysis target region 141 illustrated in FIG. 15. Whereas, the object (obstacle) analysis non-target region 142 illustrated in FIG. 15 is a region where an object (obstacle) has been analyzed in advance, and traveling is to be executed according to a route generated according to a result of the preliminary analysis.

The object (obstacle) analysis non-target region 142 illustrated in FIG. 15 is a region where a traveling route has already been determined by object analysis, and is a region where a new object analysis is unnecessary. That is, it is a region where object analysis using the iToF point cloud map is unnecessary. Therefore, this region is a region where it is not necessary to generate a point cloud corresponding to an object in the iToF point cloud map generated by the iToF point cloud map generation unit 126. This region is a “point cloud cut region”.

Note that, the traveling route determination processing is performed on the basis of an object (obstacle) farther in front in a case where the traveling speed of the robot 10 is fast, and the traveling route determination processing is performed on the basis of an object (obstacle) at a position close to the robot 10 in some degree in a case where the traveling speed of the robot 10 is slow.

Therefore, the “point cloud cut region” is set up to a farther distance as the traveling speed of the robot 10 is higher.

The processing of step S103 is processing when it is determined that the speed (v) of the robot 10 is equal to or higher than the speed threshold value (Vth). In this case, the control unit 132 calculates, in step S103, a point cloud cut region control parameter for enlarging a point cloud cut short-distance region that does not require point cloud generation based on the iToF camera detection value.

### (Step S104)

Whereas, step S104 is processing when it is determined in step S102 that (Determination Formula a) described above is satisfied and the speed (v) of the robot 10 is not equal to or higher than the speed threshold value (Vth).

In this case, in step S104, the information processing device 100 calculates a point cloud cut region control parameter for reducing the point cloud cut short-distance region where no three-dimensional point cloud based on the iToF camera detection value is used.

### (Step S105)

When the processing of calculating the point cloud cut region control parameter for enlarging or reducing the short-distance region where no three-dimensional point cloud based on the iToF camera detection value is used ends in step S103 or step S104, the process proceeds to step S105.

In step S105, the information processing device 100 executes object distance calculation processing and three-dimensional point cloud generation processing based on the iToF camera detection value, for a region excluding the point cloud cut region determined on the basis of the point cloud cut region control parameter.

This processing is processing executed by the iToF point cloud map generation unit 126 of the information processing device 100 illustrated in FIG. 11.

The iToF point cloud map generation unit 126 is input with the point cloud cut region control parameter from the control unit 132, determines the point cloud cut region where no three-dimensional point cloud based on the iTOF camera detection value is generated in accordance with the input point cloud cut region control parameter, and generates the iToF point cloud map in which a point cloud is set only in a region excluding the determined point cloud cut region.

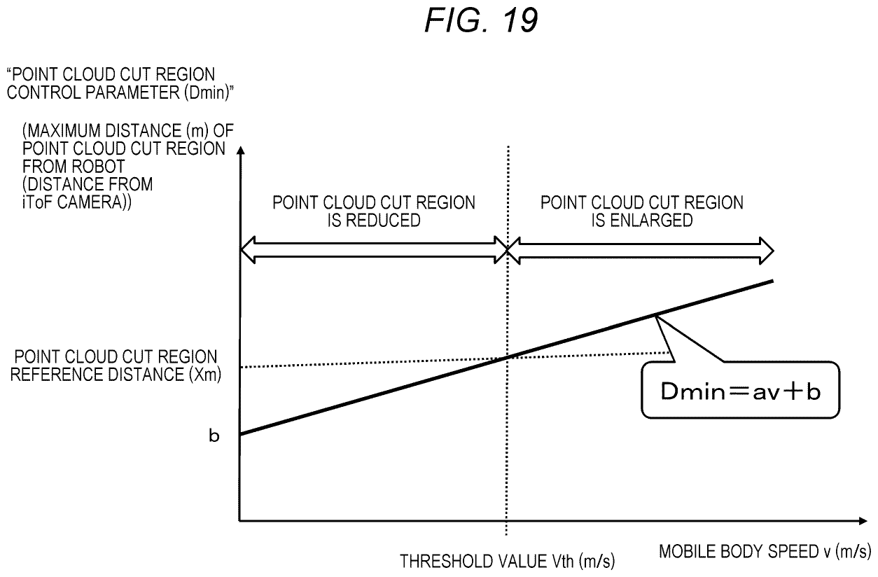

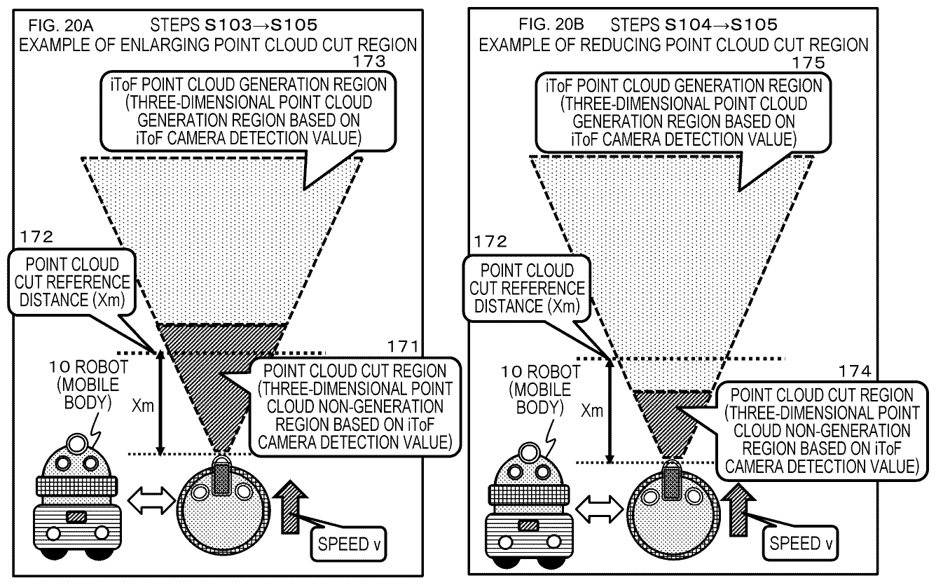

A specific example of a series of processing in steps S103 to S105 will be described with reference to FIGS. 19 and 20.

FIG. 19 is a graph for explaining a correspondence relationship between a speed of the robot (mobile body) 10 and enlargement and reduction processing on a point cloud cut region.

A horizontal axis of the graph represents a speed v (m/s) of the robot (mobile body) 10. A vertical axis represents a “point cloud cut region control parameter (Dmin)”, and specifically represents a maximum distance (m) of the point cloud cut region from the robot 10.

A straight line in the graph illustrated in the figure corresponds to a function for calculating the “point cloud cut region control parameter (Dmin)” on the basis of the speed (v) of the robot (mobile body) 10, and is expressed by the following Formula (Formula 1).

Dmin=a×v+b (Formula 1)
Where,
Dmin: a point cloud cut region control parameter, which is a maximum distance (m) of the point cloud cut region from the robot 10,
v: a speed (m/s) of the robot,
a: a correction coefficient (sensitivity corresponding to a speed), and
b: an offset (a point cloud cut region specified value at a minimum speed value (v=0)).

Furthermore, a “point cloud cut region reference distance (Xm)” indicated on the vertical axis of the graph of FIG. 19 is a point cloud cut region control parameter serving as a reference in a case where the robot is traveling at a predefined “threshold speed (Vth)”, and is a maximum distance from the robot 10 (=distance from the iToF camera) in the “point cloud cut region” set in a case where the robot is traveling at the predefined “threshold speed (Vth)”. This reference distance is defined as Xm.

The processing in step S103 of the flow of FIG. 18, that is, the processing when it is determined that the speed (v) of the robot 10 is equal to or higher than the speed threshold value (Vth) is processing on the right side of the threshold value Vth in the graph illustrated in FIG. 19.

That is, in this case, in step S103, the information processing device 100 enlarges the short-distance region where no three-dimensional point cloud based on the iToF camera detection value is used.

Whereas, the processing in step S104 of the flow of FIG. 18, that is, the processing when it is determined that the speed (v) of the robot 10 is not equal to or higher than the speed threshold value (Vth) is processing on the left side of the threshold value Vth in the graph illustrated in FIG. 19.

That is, in this case, in step S104, the information processing device 100 reduces the short-distance region where no three-dimensional point cloud based on the iToF camera detection value is used.

FIG. 20 is a diagram illustrating a specific example of the enlargement processing and the reduction processing on a point cloud cut region.

Specific examples of the following two different types of processing are shown.

(a1) Exemplary setting of the point cloud generation region and the point cloud cut region when it is determined that the speed (v) of the robot 10 is equal to or higher than the speed threshold value (Vth) and the processing of step S103 and the processing of step S105 are executed

(a2) Exemplary setting of the point cloud generation region and the point cloud cut region when it is determined that the speed (v) of the robot 10 is lower than the speed threshold value (Vth) and the processing of step S104 and the processing of step S105 are executed

FIG. 20(a1) illustrates an example of a point cloud cut region 171, the point cloud cut reference distance (Xm), and an iTOF point cloud generation region 173 when it is determined that the speed (v) of the robot 10 is equal to or higher than the speed threshold value (Vth).

When it is determined that the speed (v) of the robot 10 is equal to or higher than the speed threshold value (Vth), the point cloud cut region 171 is set to a region enlarged to a position farther than a point cloud cut reference distance (Xm) 172.

In this case, the iToF point cloud generation region 173 is a region excluding the point cloud cut region 171, and is set in a region farther from the robot 10.

Whereas, FIG. 20(a2) illustrates an example of a point cloud cut region 174, the point cloud cut reference distance (Xm) 172, and an iToF point cloud generation region 175 when it is determined that the speed (v) of the robot 10 is lower than the speed threshold value (Vth).

When it is determined that the speed (v) of the robot 10 is lower than the speed threshold value (Vth), the point cloud cut region 174 is set as a reduced region up to a position closer than the point cloud cut reference distance (Xm).

In this case, the iToF point cloud generation region 173 is a wide region excluding the point cloud cut region 174, and a point cloud is generated in the wide region from a medium distance to a far distance from the robot 10.

As described above, in steps S102 to S105, it is determined whether or not the traveling speed (v) of the robot 10 is equal to or higher than the predefined speed threshold value (Vth), the point cloud cut region is set enlarged when the robot 10 is traveling at a high speed equal to or higher than the threshold value (Vth), and the point cloud cut region is set reduced when the robot 10 is traveling at a low speed lower than the threshold value (Vth).

By performing such processing, it is not necessary to perform unnecessary point cloud generation processing for an uncontrollable short-distance region that changes according to the traveling speed of the robot 10, and reduction in processing load and reduction in battery consumption are achieved.

Returning to the flow illustrated in FIG. 18, processing of step S106 and subsequent steps will be described.

Note that, while generation processing for the iToF point cloud map which is a point cloud based on the iToF camera is being executed in step S105, the LiDAR point cloud map generation unit 105 of the information processing device 100 illustrated in FIG. 11 is generating a LiDAR point cloud map based on a detection value of the 2D-LiDAR 103 in parallel.

As described above with reference to FIG. 13, the LiDAR point cloud map based on the detection value of the 2D-LiDAR 103 and generated by the LiDAR point cloud map generation unit 105 includes point cloud data indicating an object intersecting a two-dimensional plane at a certain height (y=ya) of each object.

### (Step S106)

In step S106, the information processing device 100 generates a synthesized point cloud map by synthesizing the three-dimensional point cloud based on the iToF camera detection value and the two-dimensional point cloud based on the LiDAR detection value.

This processing is processing executed by the point cloud map synthesizing unit 131 of the information processing device 100 illustrated in FIG. 11.

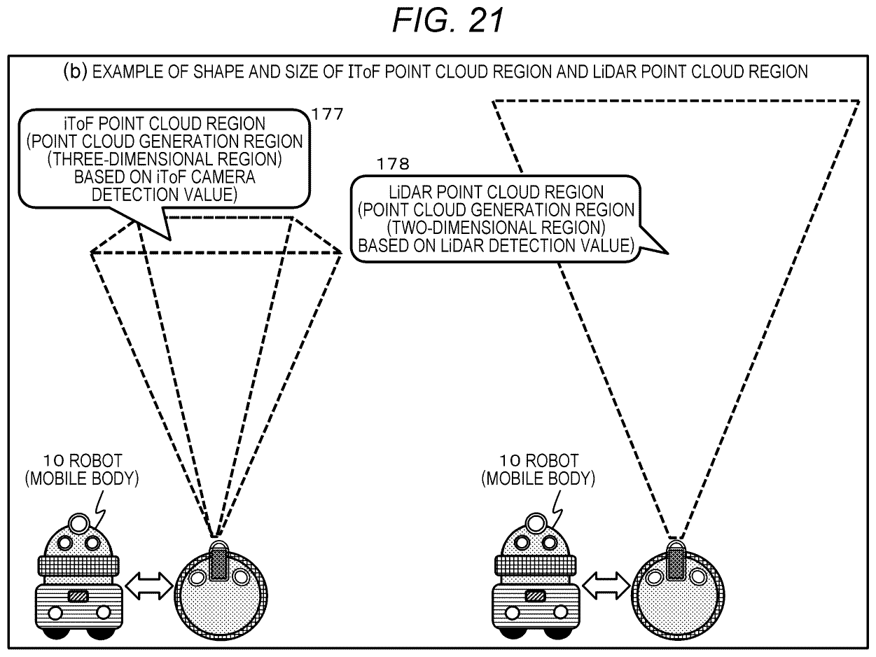

A specific example of the processing in step S106 will be described with reference to FIGS. 21 to 23.

FIG. 21 illustrates
(b) an example of a shape and a size of an IToF point cloud region and a LiDAR point cloud region.

The left side of FIG. 21 illustrates an iToF point cloud region 177. The iToF point cloud region 177 is a point cloud generation region based on an iToF camera detection value. This region is a three-dimensional region.

Whereas, the right side illustrates a LiDAR point cloud region, which is a point cloud generation region based on a LiDAR detection value. This region is a two-dimensional region.

In general, a size and a maximum distance of the iToF point cloud region are smaller than a size and a maximum distance of the LiDAR point cloud region. This is because, as described above, in the iToF camera, the maximum measurable object distance is a distance corresponding to the maximum phase difference (2π), and correct distance calculation cannot be performed for an object at a distance equal to or longer than the distance corresponding to the maximum phase difference (2π).

Whereas, in the LiDAR point cloud region, measurement with relatively high accuracy can be performed even for a farther object.

Therefore, the point cloud map synthesizing unit 131 of the information processing device 100 synthesizes two point cloud maps having different sizes to generate one point cloud map.

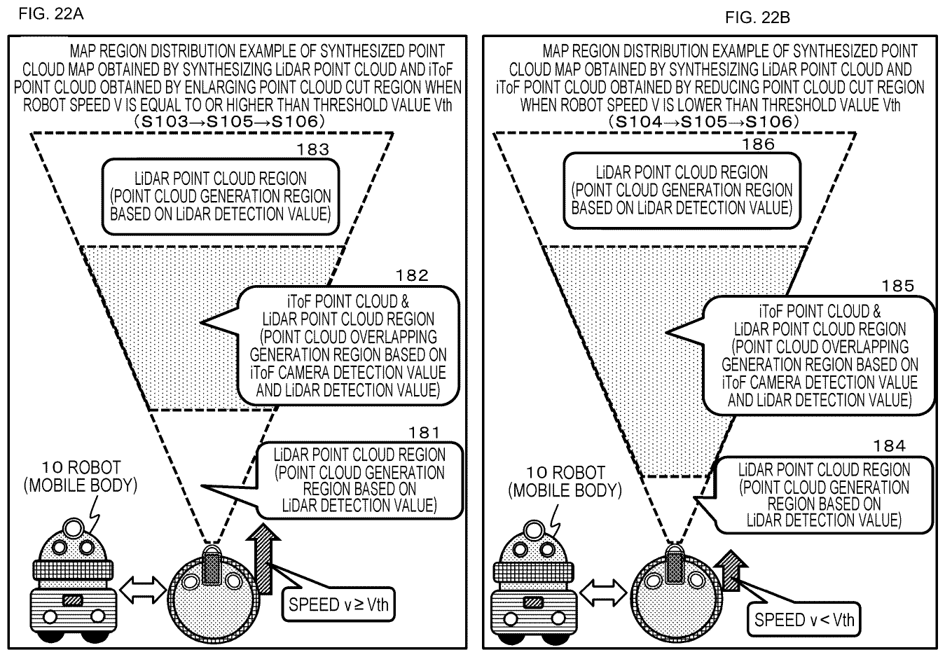

With reference to FIG. 22, an example of the synthesized point cloud map generated by the point cloud map synthesizing unit 131 will be described.

FIG. 22 illustrates a map region distribution example of the following two synthesized point cloud maps.
(c1) A map region distribution example of a synthesized point cloud map obtained by synthesizing a LiDAR point cloud and an iToF point cloud obtained by enlarging the point cloud cut region when the robot speed (v) is equal to or higher than the threshold value Vth (an example of a case where each of processing of S103→S105→S106 of the flow of FIG. 18 is executed)
(c2) A map region distribution example of a synthesized point cloud map obtained by synthesizing a LiDAR point cloud and an iToF point cloud obtained by reducing the point cloud cut region when the robot speed (v) is lower than the threshold value Vth (an example of a case where each of processing of S104→S105→S106 of the flow of FIG. 18 is executed)

FIG. 22(c1) illustrates the map region distribution example of a synthesized point cloud map generated in a case where the traveling speed (v) of the robot 10 is equal to or higher than the threshold value Vth, and the enlargement processing is executed on the cut region at a short distance in the iTOF point cloud in S103 of the flow of FIG. 18.

Note that the figure is illustrated as a plan view observed from above.

A region closest to the robot 10 is a LiDAR point cloud region 181. This region corresponds to the point cloud cut region of the iTOF point cloud enlarged in the processing of S103 of the flow of FIG. 18. This region has no iToF point cloud and only includes the LiDAR point cloud (two-dimensional plane point cloud).

A region at a distance farther from the LiDAR point cloud region 181 is an iTOF point cloud & LiDAR point cloud region 182. This region is a region where the iToF point cloud (three-dimensional point cloud) based on the iToF camera detection value and the LiDAR point cloud (two-dimensional plane point cloud) based on the LiDAR detection value are generated in an overlapping manner.

A region farther from the iToF point cloud & LiDAR point cloud region 182 is a LiDAR point cloud region 183. This region is a region where no iToF point cloud based on the iToF camera detection value is generated, and this region also has no iToF point cloud generated and only includes the LiDAR point cloud (two-dimensional plane point cloud), similarly to the LiDAR point cloud region 181 on a side close to the robot 10.

(c2) illustrated on the right side of FIG. 22 illustrates a map region distribution example of a synthesized point cloud map generated by executing the reduction processing on the point cloud cut region at a short distance in the iToF point cloud in S104 of the flow of FIG. 18, when the traveling speed (v) of the robot 10 is lower than the threshold value Vth.

In this example, in a region closest to the robot 10, a LiDAR point cloud region 184 is smaller than that in (c1) on the left side. This is because the reduction processing is performed on the cut region at a short distance in the iTOF point cloud in S104 of the flow of FIG. 18. This region has no iToF point cloud and only includes the LiDAR point cloud (two-dimensional plane point cloud).

A region at a distance farther from the LiDAR point cloud region 184 is an iTOF point cloud & LiDAR point cloud region 185, and a region at a distance even farther is a LiDAR point cloud region 186.

As described above, the synthesized point cloud map generated by the point cloud map synthesizing unit 131 has a configuration in which the following individual point cloud regions are set from a side closer to the robot 10.
(a) LiDAR point cloud region
(b) iToF point cloud & LiDAR point cloud region
(c) LiDAR point cloud region

Among the individual regions described above, “(a) LiDAR point cloud region”, which is a region closest to the robot 10, is resized according to the traveling speed of the robot. As the traveling speed of the robot is faster, the size is made larger, that is, the size is enlarged up to a position where a distance from the robot 10 is farther.

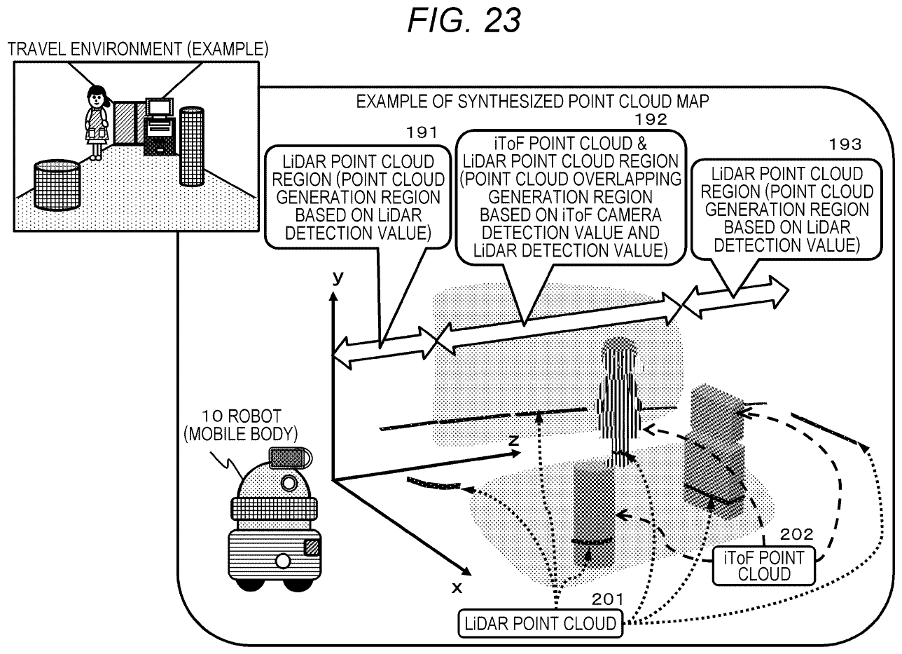

FIG. 23 illustrates a specific example of a synthesized point cloud map generated by the point cloud map synthesizing unit 131.

The example of the synthesized point cloud map illustrated in FIG. 23 is an example of a synthesized point cloud map generated in a case where the robot 10 is traveling in a traveling environment illustrated in the upper left of FIG. 23.

As illustrated in FIG. 23, the synthesized point cloud map generated by the point cloud map synthesizing unit 131 has a configuration in which the following individual point cloud regions are set from a side closer to the robot 10.
(a) LiDAR point cloud region 191
(b) iTOF point cloud & LiDAR point cloud region 192
(c) LiDAR point cloud region 193

In each of these regions, “(a) LiDAR point cloud region 191” and “(c) LiDAR point cloud region 193” have no iTOF point cloud, and include only a LiDAR point cloud (point cloud on a two-dimensional plane).

“(b) iTOF point cloud & LiDAR point cloud region 192” is a region where, in addition to the LiDAR point cloud (two-dimensional point cloud on a two-dimensional plane), an iToF point cloud (three-dimensional point cloud) generated on the basis of a detection value of the iToF camera is also set.

The robot 10 can acquire an object position and distance information with higher accuracy from “(b) iTOF point cloud & LiDAR point cloud region 192”.

Note that “(b) iToF point cloud & LiDAR point cloud region 192” is a highly important region to be used to determine the traveling route of the robot 10.

As described above, in step S106 of the flow illustrated in FIG. 18, the information processing device 100 generates the synthesized point cloud map by synthesizing the point cloud (three-dimensional point cloud) based on the iToF camera detection value and the point cloud (two-dimensional point cloud) based on the LiDAR detection value, for example, the synthesized point cloud map as illustrated in FIG. 23.

Returning to the flow illustrated in FIG. 18, processing of step S107 and subsequent steps will be described.

### (Step S107)

After generation of the synthesized point cloud map in step S106 by synthesizing the point cloud (three-dimensional point cloud) based on the iToF camera detection value and the point cloud (two-dimensional point cloud) based on the LiDAR detection value, for example, after generation of the synthesized point cloud map as illustrated in FIG. 23, next, the information processing device executes the processing of step S107.

That is, in step S107, movement control of the robot 10 is executed using the synthesized point cloud map generated in step S106.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

Note that the point cloud data to be used for the traveling route determination processing performed by the robot control unit 201 is mainly “(b) iTOF point cloud & LiDAR point cloud region 192” in the synthesized point cloud map illustrated in FIG. 23.

As described above, in “(b) iToF point cloud & LiDAR point cloud region 192”, in addition to the LiDAR point cloud (two-dimensional point cloud), the iToF point cloud (three-dimensional point cloud) generated on the basis of the detection value of the iToF camera is also set, and it is possible to analyze the object position and the distance information with higher accuracy, and to set a safe and reliable traveling route.

### (Step S108)

Finally, in step S108, the information processing device 100 determines whether or not the robot 10 has arrived at a destination, and completes the map generation processing and the traveling processing in a case where the robot has arrived at the destination.

In a case where the robot has not arrived at the destination, the process returns to step S101, and the processing of step S101 and subsequent steps is repeated.

“(First embodiment) Calculation processing of iToF point cloud cut region control parameter and processing based on calculated parameter” has been described above.

The processing of the first embodiment described above is an example, and various modifications with a changed processing mode and processing procedure are possible.

Hereinafter, the following modifications will be described.
(Modification 1 of first embodiment) Modification in which setting mode of point cloud cut region is changed
(Modification 2 of first embodiment) Modification in which point cloud cut processing is executed after generation of iToF point cloud map

### [3-1-1. (Modification 1 of First Embodiment) Modification in Which Setting Mode of Point Cloud Cut Region is Changed]

First, as Modification 1 of the first embodiment, a modification will be described in which a setting mode of a point cloud cut region is changed.

In the first embodiment described above, the calculation function of the point cloud cut region control parameter (Dmin) is expressed by the following Formula (Formula 1) as described above with reference to FIG. 19.

Dmin=a×v+b (Formula 1)
Where,
Dmin: a point cloud cut region control parameter, which is a maximum distance (m) of the point cloud cut region from the robot 10,
v: a speed (m/s) of the robot,
a: a correction coefficient (sensitivity corresponding to a speed), and
b: an offset (a point cloud cut region specified value at a minimum speed value (v=0)).

The calculation formula of the point cloud cut region control parameter (Dmin) described with reference to FIG. 19 is an example, and formulas other than this calculation formula can also be applied.

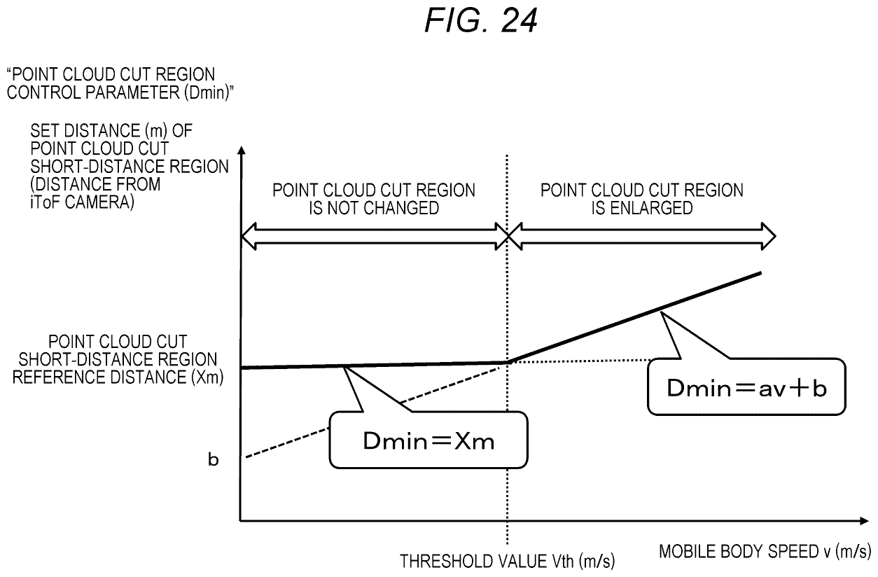

For example, a configuration may be adopted in which a calculation function of the point cloud cut region control parameter (Dmin) corresponding to a graph as illustrated in FIG. 24 is used.

In a case where the speed (v) of the robot 10 is equal to or higher than the speed threshold value (Vth), the graph illustrated in FIG. 24 has a function similar to that of the graph illustrated in FIG. 19. That is, the function is expressed by the following Formula (Formula 1).

Dmin=a×v+b (Formula 1)

However, in a case where the speed (v) of the robot 10 is lower than the speed threshold value (Vth), unlike the graph illustrated in FIG. 19, the point cloud cut region control parameter (Dmin) has a fixed value, that is,
Dmin=X
is set.

That is, the point cloud cut region control parameter (Dmin) calculation function illustrated in FIG. 24 can be expressed by the following Formula (Formula 2).

If the robot speed v≥Vth,

Dmin=a×v+b

If the robot speed v<Vth,

Dmin=X (Formula 2)

In a case where the point cloud cut region control parameter (Dmin) calculation function indicated by (Formula 2) described above is used, that is, the calculation function of the point cloud cut region control parameter (Dmin) illustrated in FIG. 24 is used, the processing in step S103 of the flow of FIG. 18, that is, the processing when it is determined that the speed (v) of the robot 10 is equal to or higher than the speed threshold value (Vth) is processing on the right side of the threshold value Vth in the graph illustrated in FIG. 24.

That is, in this case, in step S103, the information processing device 100 enlarges the short-distance region where no three-dimensional point cloud based on the iToF camera detection value is used.

Whereas, the processing in step S104 of the flow of FIG. 18, that is, the processing when it is determined that the speed (v) of the robot 10 is not equal to or higher than the speed threshold value (Vth) is processing on the left side of the threshold value Vth in the graph illustrated in FIG. 24.

That is, in this case, in step S104, the information processing device 100 fixes the short-distance region where no three-dimensional point cloud based on the iToF camera detection value is used, without enlarging or reducing the short-distance region, and sets
Dmin=X (m).

Specifically, the maximum distance (m) of the point cloud cut region from the robot 10 is maintained at the reference distance (Xm).

For example, a configuration may be adopted in which such processing is executed.

Note that, in a case where the point cloud cut region control parameter (Dmin) calculation function expressed by (Formula 2) described above is used, that is, the calculation function of the point cloud cut region control parameter (Dmin) illustrated in FIG. 24 is used, if the robot speed (v) fluctuates around the threshold value (Vth), the processing may become unstable.

Specifically, if the robot speed (v) repeatedly fluctuates around the threshold value (Vth), there is a possibility that a setting change of the point cloud cut region is not smoothly performed.

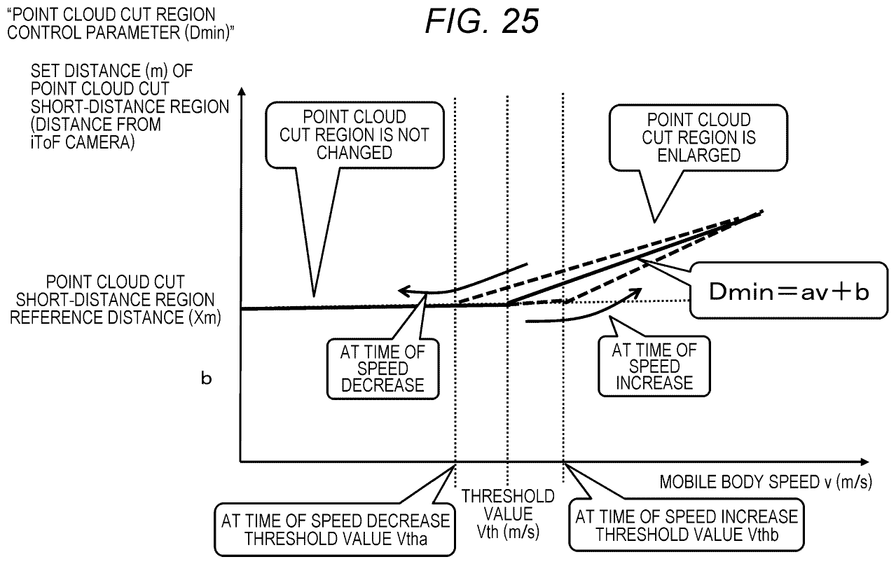

In order to solve such processing instability, for example, as illustrated in FIG. 25, it is preferable to adopt a configuration of performing control in which hysteresis is set.

That is, as illustrated in FIG. 25, at a time of speed increase when the robot speed (v) changes from lower than the threshold value (Vth) to equal to or higher than the threshold value, a transition timing of these two calculation formulas
Dmin=Xm
to
Dmin=a×v+b
is made delayed. That is, a threshold value at a time of speed increase is defined as Vthb (where Vth<Vthb).

Whereas, at a time of speed decrease when the robot speed (v) decreases from equal to or higher than the threshold value (Vth) to lower than the threshold value, a transition timing of these two calculation formulas
Dmin=a×v+b
to
Dmin=Xm
is made delayed. That is, a threshold value at a time of speed decrease is defined as Vtha (where Vtha<Vth).

In this way, by adopting a configuration of setting the hysteresis and executing the switching of the two different point cloud cut region control parameter (Dmin) calculation functions, the setting change processing of the point cloud cut region can be smoothly performed.

[3-1-2. (Modification 2 of First Embodiment) Modification in Which Point Cloud Cut Processing is Executed After Generation of iToF Point Cloud Map]

Next, as Modification 2 of the first embodiment described above, a modification will be described in which the point cloud cut processing is executed after generation of the iToF point cloud map.

In the first embodiment described above, as described with reference to the flow illustrated in FIG. 18, first, the control unit 132 calculates the iToF point cloud cut region control parameter, that is, the point cloud cut region control parameter (Dmin) defined by the robot speed (v) described with reference to the graph illustrated in FIG. 19.

Next, the iToF point cloud map generation unit 126 performs processing in a processing sequence of generating the iToF point cloud map in which the point cloud is set in the region excluding the point cloud cut region determined according to the point cloud cut region control parameter (Dmin).

That is, when generating the iToF point cloud map in step S105 of the flow illustrated in FIG. 11, the iToF point cloud map generation unit 126 of the information processing device 100 illustrated in FIG. 18 has generated the iToF point cloud map in which the point cloud is set only for the region excluding the point cloud cut region determined on the basis of the iToF point cloud map control parameter input from the control unit 132.

As a processing sequence different from such a processing sequence, for example, a processing sequence may be used in which the point cloud cut processing is executed after generation of the iToF point cloud map.

That is, the iToF point cloud map generation unit 126 of the information processing device 100 illustrated in FIG. 11 first generates the iToF point cloud map in which the point cloud is set for the entire region where the point cloud can be generated.

Thereafter, the iToF point cloud map generation unit 126 is input with the point cloud cut region control parameter (Dmin) from the control unit 132, deletes the point cloud in the point cloud cut region on the basis of the input parameter, and generates the iToF point cloud map by cutting the point cloud in the point cloud cut region.

The processing may be performed in such a processing sequence.

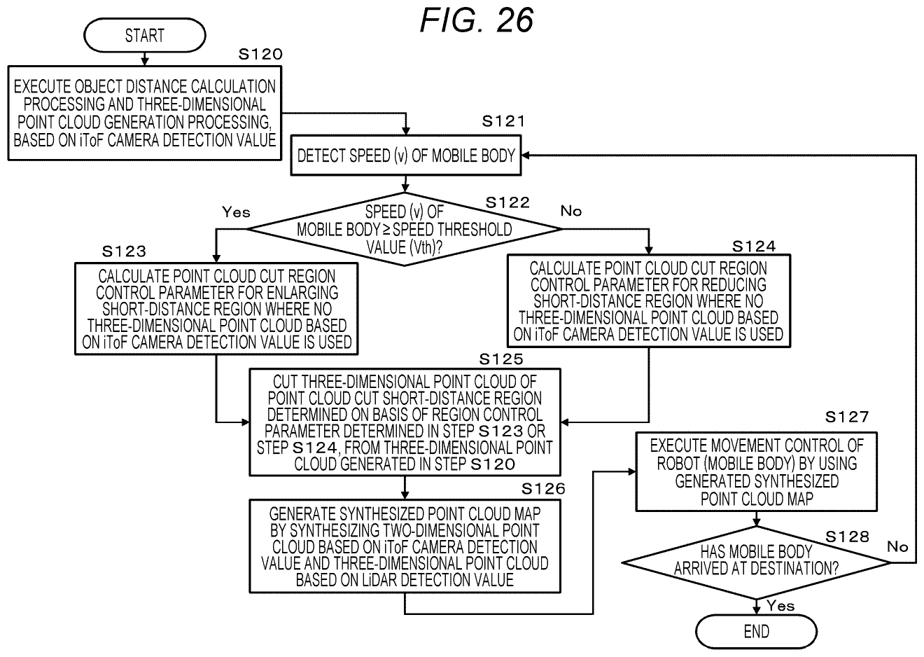

A flowchart illustrated in FIG. 26 is a flowchart for explaining a processing procedure according to this processing sequence.

Hereinafter, processing of each step of the flow illustrated in FIG. 26 will be sequentially described.

### (Step S120)

First, in step S120, the information processing device 100 of the present disclosure executes object distance calculation processing and three-dimensional point cloud generation processing, based on an iTOF camera detection value.

This processing is processing executed by the iToF point cloud map generation unit 126 of the information processing device 100 illustrated in FIG. 11.

In step S120, the iToF point cloud map generation unit 126 generates an iToF point cloud map in which a point cloud is set for the entire region where the point cloud can be generated.

### (Steps S121 to S124)

The processing of steps S121 to S124 is similar to the processing of steps S101 to S104 of the flow described above with reference to FIG. 18.

That is, first, in step S121, a speed (v) of the robot (mobile body) 10 is detected.

Next, in step S122, it is determined whether the speed (v) of the robot 10 is equal to or higher than the speed threshold value (Vth).

The process proceeds to step S123 in a case where the speed (v) of the robot 10 is equal to or higher than the speed threshold value (Vth), and the process proceeds to step S124 in a case where the speed (v) is not equal to or higher than the speed threshold value (Vth).

In step S123, a point cloud cut region control parameter for enlarging a short-distance region where no three-dimensional point cloud based on the iToF camera detection value is used is calculated.

Furthermore, in step S124, a point cloud cut region control parameter for reducing the short-distance region where no three-dimensional point cloud based on the iToF camera detection value is used is calculated.

### (Step S125)

When the calculation processing for the point cloud cut region control parameter for enlarging or reducing the short-distance region where no three-dimensional point cloud based on the iToF camera detection value is used ends in step S123 or step S124, the process proceeds to step S125.

In step S125, the information processing device 100 executes processing of deleting the point cloud of the point cloud cut region determined on the basis of the point cloud cut region control parameter calculated in step S123 or step S124, from the iToF point cloud map generated in step S120.

This processing is processing executed by the iToF point cloud map generation unit 126 of the information processing device 100 illustrated in FIG. 11.

The iToF point cloud map generation unit 126 generates the iTOF point cloud map not including the point cloud of the point cloud cut region by this processing.

### (Steps S126 to S128)

The processing of steps S126 to S128 is similar to the processing of steps S106 to S108 of the flow described above with reference to FIG. 18.

That is, in step S126, a synthesized point cloud map is generated by synthesizing the three-dimensional point cloud based on the iToF camera detection value and the two-dimensional point cloud based on the LiDAR detection value.

Next, in step S127, movement control of the robot 10 is executed using the synthesized point cloud map generated in step S126.

Finally, in step S128, it is determined whether or not the robot 10 has arrived at a destination, and completes the map generation processing and the traveling processing in a case where the robot has arrived at the destination.

In a case where the robot has not arrived at the destination, the process returns to step S121, and the processing of step S121 and subsequent steps is repeated.

In the processing illustrated in the flow illustrated in FIG. 26, the iToF point cloud map generation unit 126 of the information processing device 100 illustrated in FIG. 11 executes the processing in a procedure of first generating a conventional iToF point cloud map in which a point cloud is set in the entire region where the point cloud can be set, and thereafter, deleting the point cloud of the point cloud cut region.

Therefore, similarly to the related art, the iTOF point cloud map generation unit 126 can first generate the conventional iToF point cloud map in which a point cloud is set in the entire region in which the point cloud can be set. Thereafter, it is only necessary to add processing of deleting the point cloud of the point cloud cut region, and there is an advantage that it is not necessary to greatly change the configuration and processing of the conventional device.

[3-2. (Second Embodiment) Calculation Processing of iToF Camera Output Light Frequency Control Parameter and Processing Based on Calculated Parameter]

Next, as a second embodiment of processing executed by the information processing device 100 of the present disclosure, calculation processing of an iToF camera output light frequency control parameter and processing based on the calculated parameter will be described.

As described above, the iToF camera calculates a distance in accordance with a phase difference between transmission light (output light) and reception light (reflected light).

The phase difference between the transmission light (output light) and the reception light (reflected light) can be detected only in a range of 0 to 2π. That is, a maximum detectable distance (for example, the phase difference=2π) is defined according to a frequency of the transmission light (output light).

That is, as described above with reference to FIGS. 8 and 9, a measurable distance of the iToF camera can be changed by changing the frequency, that is, the cycle of output light of the iTOF camera. However, when the measurable distance is increased, there is a problem that accuracy of a calculated distance decreases.

Therefore, for example, it is possible to perform control such that the frequency of output light is lowered in order to enable distance calculation in a wider range up to a farther distance in a case where the traveling speed of the robot 10 is fast, while the frequency of output light is increased to give priority to highly accurate distance calculation in a case where the traveling speed of the robot 10 is slow.

An embodiment in which such frequency control of output light is performed will be described below.

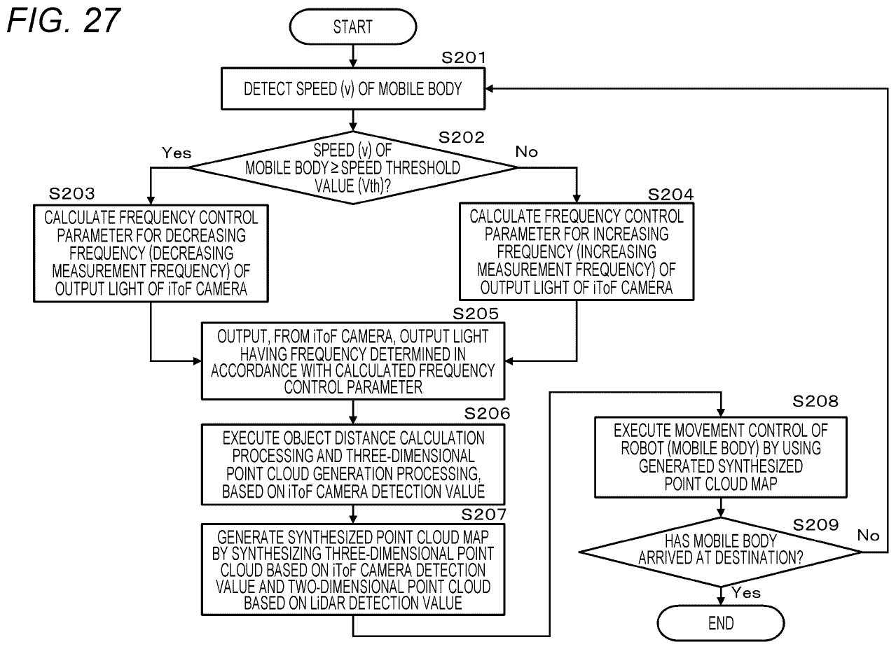

A flowchart illustrated in FIG. 27 is a flowchart for explaining calculation processing of an iToF camera output light frequency control parameter executed by the information processing device 100 of the present disclosure and processing based on the calculated parameter.

Hereinafter, processing of each step of the flow illustrated in FIG. 27 will be sequentially described.

### (Step S201)

First, in step S201, the information processing device 100 of the present disclosure detects a speed (v) of the robot (mobile body) 10.

The speed detection processing on the robot (mobile body) 10 is executed by the speed sensor 101 of the information processing device 100 illustrated in FIG. 11, and the detected speed (v) is input to the control unit 132 and the point cloud map synthesizing unit 131.

### (Step S202)

Next, in step S202, the information processing device 100 compares the detected speed (v) of the robot 10 with a predefined speed threshold value (Vth), and determines whether or not the speed (v) of the robot 10 is equal to or higher than the speed threshold value (Vth). That is, it is determined whether the following (Determination Formula a) is satisfied.

v≥Vth (Determination Formula a)

This processing is executed by the control unit 132 of the information processing device 100 illustrated in FIG. 11.

When it is determined that (Determination Formula a) described above is satisfied and the speed (v) of the robot 10 is equal to or higher than the speed threshold value (Vth), the process proceeds to step S203.

Whereas, when it is determined that (Determination Formula a) described above is not satisfied and the speed (v) of the robot 10 is not equal to or higher than the speed threshold value (Vth), the process proceeds to step S204.

### (Sup S203)

When it is determined in step S202 that (Determination Formula a) described above is satisfied and the speed (v) of the robot 10 is equal to or higher than the speed threshold value (Vth), the process proceeds to step S203.

In this case, in step S203, the information processing device 100 calculates a frequency control parameter for decreasing the frequency of output light of the iToF camera 120. That is, a frequency control parameter for decreasing the frequency of light output from the light transmission unit 122 of the iToF camera 120 is calculated.

This processing is also executed by the control unit 132 of the information processing device 100 illustrated in FIG. 11.

### (Step S204)

Whereas, step S204 is processing when it is determined in step S202 that (Determination Formula a) described above is satisfied and the speed (v) of the robot 10 is not equal to or higher than the speed threshold value (Vth).

In this case, in step S204, the information processing device 100 calculates a frequency control parameter for increasing the frequency of output light of the iToF camera 120. That is, a frequency control parameter for increasing the frequency of light output from the light transmission unit 122 of the iToF camera 120 is calculated.

This processing is also executed by the control unit 132 of the information processing device 100 illustrated in FIG. 11.

### (Step S205)

When the processing of calculating the frequency control parameter for decreasing or increasing the frequency of light output from the iToF camera 120 ends in step S203 or step S204, the process proceeds to step S205.

In step S205, the information processing device 100 outputs, from the iToF camera 120, output light having a frequency determined on the basis of the frequency control parameter calculated in step S203 or step S204.

This processing is executed in the output light generation unit 121 and the light transmission unit 122 of the iToF camera 120.

### (Step S206)

Next, in step S206, the information processing device 100 executes object distance calculation processing and three-dimensional point cloud generation processing, based on an iToF camera detection value.

This processing is processing executed by the iToF point cloud map generation unit 126 of the information processing device 100 illustrated in FIG. 11.

The iToF point cloud map generation unit 126 is input with a reception signal of the light reception unit 124 of the iToF camera 120 via the signal processing unit (low-pass filter) 125, and executes the object distance calculation processing and the three-dimensional point cloud generation processing on the basis of the input value, to generate the iToF point cloud map.

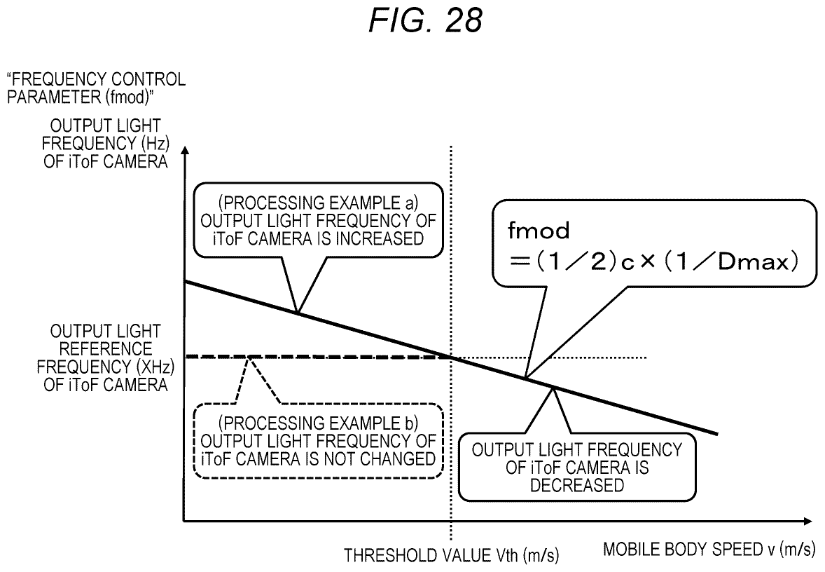

A specific example of a series of processing in steps S203 to S206 will be described with reference to FIG. 28.

FIG. 28 is a graph for explaining a correspondence relationship between a speed of the robot (mobile body) 10 and a frequency (Hz) of output light from the iToF camera.

A horizontal axis of the graph represents a speed v (m/s) of the robot (mobile body) 10. A vertical axis is a “frequency control parameter (fmod)”, and specifically indicates a frequency (Hz) of light output from the iToF camera 120.

Note that, two graphs of a solid line graph (Processing Example a) and a dotted-line graph (Processing Example b) are illustrated in a region where the speed v (m/s) of the robot (mobile body) 10 is equal to or lower than the threshold value Vth. These graphs correspond to the processing example illustrated in FIG. 19 and the processing example illustrated in FIG. 24 regarding the point cloud cut processing of the first embodiment described above, and indicate that two different types of processing can be performed.

First, the solid line graph including (Processing Example a) will be described.

A straight line (solid line) in the graph illustrated in the figure corresponds to a function for calculating the “frequency control parameter (fmod)” on the basis of the speed (v) of the robot (mobile body) 10, and is expressed by the following Formula (Formula 3).

fmod=(½)c×(1/Dmax) (Formula 3)
Where,
fmod: a frequency control parameter, which is a frequency (Hz) of light output from the iToF camera 120,
c: a speed of light (c=3×10⁸ (m/s)),
Dmax: a target maximum measurement distance,
Dmax=p×v+q,
v: a speed of the robot (m/s),
p: a correction coefficient (sensitivity corresponding to a speed), and
q: an offset (a target maximum measurement distance at a minimum speed value (v=0)).

Furthermore, an “output light reference frequency (X (Hz)) of the iToF camera” indicated on the vertical axis of the graph of FIG. 28 is a frequency control parameter serving as a reference in a case where the robot is traveling at a predefined “threshold speed (Vth)”, and is a “frequency of output light of the iToF camera 120” set in a case where the robot is traveling at the predefined “threshold speed (Vth)”. This reference frequency is defined as X (Hz).

The processing in step S203 of the flow of FIG. 27, that is, the processing when it is determined that the speed (v) of the robot 10 is equal to or higher than the speed threshold value (Vth) is processing on the right side of the threshold value Vth in the graph illustrated in FIG. 28.

That is, in this case, the information processing device 100 decreases the frequency of output light of the iToF camera 120 in step S203.

Whereas, the processing in step S204 of the flow of FIG. 27, that is, the processing when it is determined that the speed (v) of the robot 10 is not equal to or higher than the speed threshold value (Vth) is processing on the left side of the threshold value Vth in the graph illustrated in FIG. 28.

That is, in this case, the information processing device 100 increases the frequency of output light of the iToF camera 120 in step S204.

As described above, in steps S202 to S206, it is determined whether or not the traveling speed (v) of the robot 10 is equal to or higher than the predefined speed threshold value (Vth), the frequency of output light of the iToF camera 120 is decreased when the robot 10 is traveling at a high speed equal to or higher than the threshold value (Vth), and the frequency of output light of the iToF camera 120 is increased when the robot 10 is traveling at a low speed lower than the threshold value (Vth).

By performing such processing, the generation region of the iTOF point cloud map can be changed according to the traveling speed of the robot 10.

That is, when the robot 10 is traveling at a high speed, the iToF point cloud map generation unit 126 generates an iToF point cloud map of a wide region where a point cloud is set up to a farther region.

Whereas, when the robot 10 is traveling at a low speed, an iTOF point cloud map of a narrow region is generated in which a highly accurate point cloud of a close region is set.

Returning to the flow illustrated in FIG. 28, processing of step S207 and subsequent steps will be described.

Note that, while generation processing for the iToF point cloud map which is a point cloud based on the iToF camera is being executed in step S206, the LiDAR point cloud map generation unit 105 of the information processing device 100 illustrated in FIG. 11 is generating a LiDAR point cloud map based on a detection value of the 2D-LiDAR 103 in parallel.

As described above with reference to FIG. 13, the LiDAR point cloud map based on the detection value of the 2D-LiDAR 103 and generated by the LiDAR point cloud map generation unit 105 includes point cloud data indicating an object intersecting a two-dimensional plane at a certain height (y=ya) of each object.

### (Step S207)

In step S207, the information processing device 100 generates a synthesized point cloud map by synthesizing the three-dimensional point cloud based on the iToF camera detection value and the two-dimensional point cloud based on the LiDAR detection value.

This processing is processing executed by the point cloud map synthesizing unit 131 of the information processing device 100 illustrated in FIG. 11.

### (Step S208)

After generation of the synthesized point cloud map in step S207 by synthesizing the point cloud (three-dimensional point cloud) based on the iToF camera detection value and the point cloud (two-dimensional point cloud) based on the LiDAR detection value, for example, after generation of the synthesized point cloud map as described with reference to FIG. 23 in the above embodiment, next, the information processing device executes the processing in step S208.

That is, in step S208, movement control of the robot 10 is executed using the synthesized point cloud map generated in step S207.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

### (Step S209)

Finally, in step S209, the information processing device 100 determines whether or not the robot 10 has arrived at a destination, and completes the map generation processing and the traveling processing in a case where the robot has arrived at the destination.

In a case where the robot has not arrived at the destination, the process returns to step S201, and the processing of step S201 and subsequent steps is repeated.

In the present embodiment, the frequency of output light of the iToF camera 120 is decreased when the robot 10 is traveling at a high speed equal to or higher than the threshold value (Vth), and the frequency of output light of the iToF camera 120 is increased when the robot 10 is traveling at a low speed lower than the threshold value (Vth).

As a result, it is possible to generate an iToF point cloud map of a wide region where a point cloud is set up to a farther region when the robot 10 is traveling at a high speed, while it is possible to generate an iToF point cloud map of a narrow region where a highly accurate point cloud of a close region is set when the robot 10 is traveling at a low speed.

Note that, in the graph of FIG. 28, a dotted-line graph (Processing Example b) illustrated in the region where the speed v (m/s) of the robot (mobile body) 10 is equal to or lower than the threshold value Vth is a modification in which the frequency control parameter (fmod) is set to a fixed value, that is,
fmod=X (Hz)
in a case where the speed (v) of the robot 10 is lower than the speed threshold value (Vth), similarly to the processing example (Modification 1) illustrated in FIG. 24 of the point cloud cut processing described in the first embodiment above.

That is, the frequency control parameter (fmod) calculation function of (Processing Example b) can be expressed by the following Formula (Formula 4).

If the robot speed v≥Vth,

fmod=(½)c×(1/Dmax)

If the robot speed v<Vth,

fmod=X (Formula 4)

In a case where the frequency control parameter (fmod) calculation function indicated in (Formula 4) described above is used, the processing in step S203 of the flow of FIG. 27, that is, the processing when it is determined that the speed (v) of the robot 10 is equal to or higher than the speed threshold value (Vth) is processing on the right side of the threshold value Vth in the graph illustrated in FIG. 24.

That is, in this case, the information processing device 100 decreases the frequency of light output by the iToF camera 120 in step S203.

Whereas, the processing in step S204 of the flow of FIG. 27, that is, the processing when it is determined that the speed (v) of the robot 10 is not equal to or higher than the speed threshold value (Vth) is processing of the dotted line (Processing Example b) on the left side of the threshold value Vth in the graph illustrated in FIG. 28.

That is, in this case, in step S204, the information processing device 100 fixes the frequency of light output from the iTOF camera 120 to
fmod=X (Hz).

For example, a configuration may be adopted in which such processing is executed.

Note that, in a case where the frequency control parameter (fmod) calculation function indicated by (Formula 4) described above is used, that is, in a case where the following two different functions are used: the function indicated by the dotted line of (Processing Example b) on the left side of the graph illustrated in FIG. 28 when the speed (v) of the robot 10 is lower than the speed threshold value (Vth); and the function indicated by the solid line on the right side of the graph illustrated in FIG. 28 when the speed (v) of the robot 10 is equal to or higher than the speed threshold value (Vth), there is a possibility that the processing becomes unstable if the robot speed (v) fluctuates around the threshold value (Vth).

In order to solve such processing instability, for example, as described above with reference to FIG. 25, a configuration may be adopted in which control in which hysteresis is set is performed.

By setting hysteresis and executing switching of two different frequency control parameter (fmod) calculation functions, it is possible to smoothly perform frequency change processing.

As described above, in “(Second embodiment) Calculation processing of iToF camera output light frequency control parameter and processing based on calculated parameter”,
the generation region of the iToF point cloud map generated by the iToF point cloud map generation unit 126 can be changed by changing a frequency of light output from the iToF camera 120 in accordance with a traveling speed of the robot 10.

That is, the iToF point cloud map generation unit 126 can generate an iToF point cloud map of a wide region where a point cloud is set up to a farther region when the robot 10 is traveling at a high speed, and can generate an iToF point cloud map of a narrow region where a highly accurate point cloud of a close region is set when the robot 10 is traveling at a low speed.

[3-3. (Third Embodiment) Calculation Processing of iToF Camera Exposure Time Control Parameter and Processing Based On Calculated Parameter]

Next, calculation processing of an iToF camera exposure time control parameter and processing based on the calculated parameter will be described.

As described above, the iToF camera calculates a distance in accordance with a phase difference between transmission light (output light) and reception light (reflected light).

In the iToF camera, similarly to a normal camera, in a case where intensity of reception light (reflected light) is weak, it is possible to increase an amount of incident light on the image sensor by lengthening an exposure time, and thus, it is possible to enhance analysis accuracy.

The intensity of the reception light (reflected light) decreases as a distance of the object increases.

In a case where a traveling speed of the robot 10 is fast, it is necessary to calculate a distance of a farther object, and control for lengthening the exposure time is effective for distance analysis of far objects. Whereas, in a case where the traveling speed of the robot 10 is slow, calculation of a distance of a close object may be prioritized over calculation of a distance of a far object, and the exposure time may be short.

The embodiment described below is in response to this request. For example, in a case where the traveling speed of the robot 10 is fast, the exposure time of the iToF camera is lengthened in order to enable distance calculation of an object in a wider range up to a farther distance. Whereas, in a case where the traveling speed of the robot 10 is slow, an exposure time of the iTOF camera is shortened, and priority is given to highly accurate distance calculation of a short-distance region.

The embodiment described below is an embodiment in which the exposure time control of the iToF camera is performed according to the traveling speed of the robot 10 as described above.

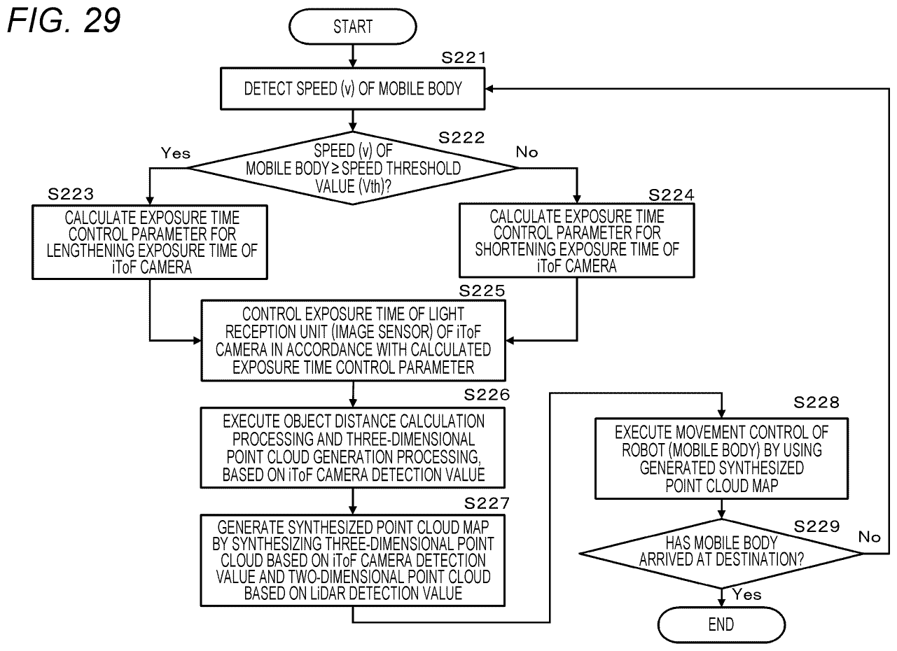

A flowchart illustrated in FIG. 29 is a flowchart for explaining calculation processing of an iToF camera exposure time control parameter executed by the information processing device 100 of the present disclosure and processing based on the calculated parameter.

Hereinafter, processing of each step of the flow illustrated in FIG. 29 will be sequentially described.

### (Step S221)

First, in step S221, the information processing device 100 of the present disclosure detects a speed (v) of the robot (mobile body) 10.

The speed detection processing on the robot (mobile body) 10 is executed by the speed sensor 101 of the information processing device 100 illustrated in FIG. 11, and the detected speed (v) is input to the control unit 132 and the point cloud map synthesizing unit 131.

### (Step S222)

Next, in step S222, the information processing device 100 compares the detected speed (v) of the robot 10 with a predefined speed threshold value (Vth), and determines whether or not the speed (v) of the robot 10 is equal to or higher than the speed threshold value (Vth). That is, it is determined whether the following (Determination Formula a) is satisfied.

v≥Vth (Determination Formula a)

This processing is executed by the control unit 132 of the information processing device 100 illustrated in FIG. 11.

When it is determined that (Determination Formula a) described above is satisfied and the speed (v) of the robot 10 is equal to or higher than the speed threshold value (Vth), the process proceeds to step S223.

Whereas, when it is determined that (Determination Formula a) described above is not satisfied and the speed (v) of the robot 10 is not equal to or higher than the speed threshold value (Vth), the process proceeds to step S224.

### (Sup S223)

When it is determined in step S222 that (Determination Formula a) described above is satisfied and the speed (v) of the robot 10 is equal to or higher than the speed threshold value (Vth), the process proceeds to step S223.

In this case, in step S223, the information processing device 100 calculates an exposure time control parameter for lengthening the exposure time of the iToF camera 120. That is, an exposure time control parameter for lengthening the exposure time of the light reception unit 124 of the iToF camera 120 is calculated.

This processing is also executed by the control unit 132 of the information processing device 100 illustrated in FIG. 11.

### (Step S224)

Whereas, step S224 is processing when it is determined in step S222 that (Determination Formula a) described above is satisfied and the speed (v) of the robot 10 is not equal to or higher than the speed threshold value (Vth).

In this case, in step S224, the information processing device 100 calculates an exposure time control parameter for shortening the exposure time of the iToF camera 120. That is, an exposure time control parameter for shortening the exposure time of the light reception unit 124 of the iToF camera 120 is calculated.

This processing is also executed by the control unit 132 of the information processing device 100 illustrated in FIG. 11.

### (Step S225)

When the processing of calculating the exposure time control parameter for decreasing or shortening the exposure time of light output from the iToF camera 120 ends in step S223 or step S224, the process proceeds to step S225.

In step S225, the information processing device 100 sets an exposure time determined on the basis of the exposure time control parameter calculated in step S223 or step S224, as the exposure time of the light reception unit 124 of the iToF camera 120.

This processing is executed by the exposure time control unit 123 and the light reception unit 124 of the iToF camera 120.

### (Step S226)

Next, in step S226, the information processing device 100 executes object distance calculation processing and three-dimensional point cloud generation processing, based on an iToF camera detection value.

This processing is processing executed by the iToF point cloud map generation unit 126 of the information processing device 100 illustrated in FIG. 11.

The iToF point cloud map generation unit 126 is input with a reception signal of the light reception unit 124 of the iToF camera 120 via the signal processing unit (low-pass filter) 125, and executes the object distance calculation processing and the three-dimensional point cloud generation processing on the basis of the input value, to generate the iToF point cloud map.

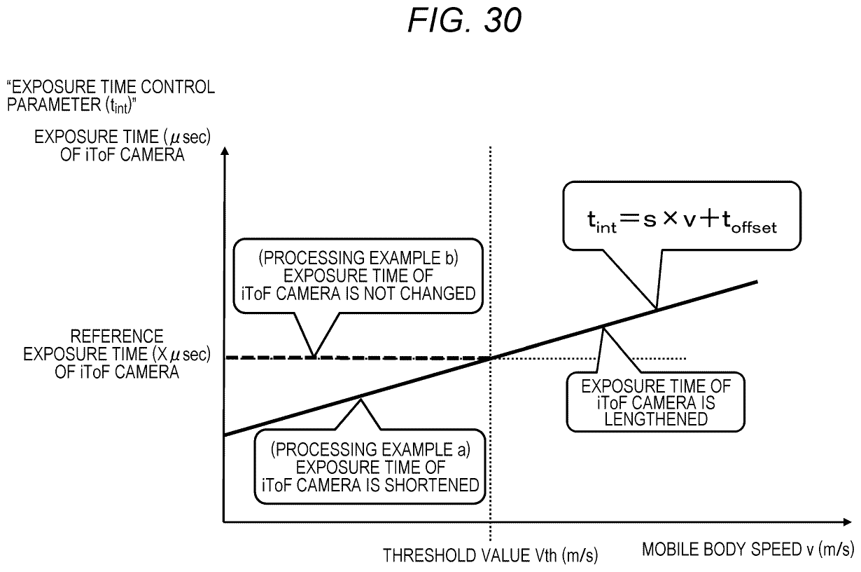

A specific example of a series of processing in steps S223 to S226 will be described with reference to FIG. 30.

FIG. 30 is a graph for explaining a correspondence relationship between a speed of the robot (mobile body) 10 and an exposure time (sec) of the iToF camera.

A horizontal axis of the graph represents a speed v (m/s) of the robot (mobile body) 10. A vertical axis represents an “exposure time control parameter (tᵢₙₜ)”, and specifically represents an exposure time (μsec) of the light reception unit 124 of the iToF camera 120.

Note that, two graphs of a solid line graph (Processing Example a) and a dotted-line graph (Processing Example b) are illustrated in a region where the speed v (m/s) of the robot (mobile body) 10 is equal to or lower than the threshold value Vth. These graphs correspond to the processing example illustrated in FIG. 19 and the processing example illustrated in FIG. 24 regarding the point cloud cut processing of the first embodiment described above, and indicate that two different types of processing can be performed.

First, the solid line graph including (Processing Example a) will be described.

A straight line (solid line) in the graph illustrated in the figure corresponds to a function for calculating the “exposure time control parameter (tᵢₙₜ)” on the basis of the speed (v) of the robot (mobile body) 10, and is expressed by the following Formula (Formula 5).

tᵢₙₜ=s×v+t_{offset} (Formula 5)
Where,
tᵢₙₜ: an exposure time control parameter, which is an exposure time (usec) of the light reception unit 124 of the iToF camera 120,
s: a correction coefficient (sensitivity corresponding to a speed),
v: a speed (m/s) of the robot, and
t_{offset}: an offset (an exposure time (usec) at a minimum speed value (v=0)).

Furthermore, an “output light reference exposure time (X (μsec)) of the iTOF camera” indicated on the vertical axis of the graph of FIG. 30 is an exposure time control parameter serving as a reference in a case where the robot is traveling at a predefined “threshold speed (Vth)”, and is an “exposure time of the iToF camera 120” set in a case where the robot is traveling at the predefined “threshold speed (Vth)”. This reference exposure time is defined as X (μsec).

The processing in step S223 of the flow of FIG. 29, that is, the processing when it is determined that the speed (v) of the robot 10 is equal to or higher than the speed threshold value (Vth) is processing on the right side of the threshold value Vth in the graph illustrated in FIG. 30.

That is, in this case, the information processing device 100 lengthens the exposure time of the iToF camera 120 in step S223.

Whereas, the processing in step S224 of the flow of FIG. 29, that is, the processing when it is determined that the speed (v) of the robot 10 is not equal to or higher than the speed threshold value (Vth) is processing on the left side of the threshold value Vth in the graph illustrated in FIG. 30.

That is, in this case, the information processing device 100 shortens the exposure time of the iToF camera 120 in step S224.

As described above, in steps S222 to S226, it is determined whether or not the traveling speed (v) of the robot 10 is equal to or higher than the predefined speed threshold value (Vth), the exposure time of the iTOF camera 120 is lengthened when the robot 10 is traveling at a high speed equal to or higher than the threshold value (Vth), and the exposure time of the iToF camera 120 is shortened when the robot 10 is traveling at a low speed lower than the threshold value (Vth).

By performing such processing, accuracy in a long-distance region of the iToF point cloud map can be changed according to the traveling speed of the robot 10.

That is, when the robot 10 is traveling at a high speed, the iToF point cloud map generation unit 126 generates an iToF point cloud map in which a highly accurate point cloud is set up to a farther region.

Whereas, when the robot 10 is traveling at a low speed, an iToF point cloud map in which a highly accurate point cloud is set only in a close region is generated.

Returning to the flow illustrated in FIG. 30, processing of step S227 and subsequent steps will be described.

Note that, while generation processing for the iToF point cloud map which is a point cloud based on the iToF camera is being executed in step S226, the LiDAR point cloud map generation unit 105 of the information processing device 100 illustrated in FIG. 11 is generating a LiDAR point cloud map based on a detection value of the 2D-LiDAR 103 in parallel.

As described above with reference to FIG. 13, the LiDAR point cloud map based on the detection value of the 2D-LiDAR 103 and generated by the LiDAR point cloud map generation unit 105 includes point cloud data indicating an object intersecting a two-dimensional plane at a certain height (y=ya) of each object.

### (Step S227)

In step S227, the information processing device 100 generates a synthesized point cloud map by synthesizing the three-dimensional point cloud based on the iToF camera detection value and the two-dimensional point cloud based on the LiDAR detection value.

This processing is processing executed by the point cloud map synthesizing unit 131 of the information processing device 100 illustrated in FIG. 11.

### (Step S228)

After generation of the synthesized point cloud map in step S227 by synthesizing the point cloud (three-dimensional point cloud) based on the iToF camera detection value and the point cloud (two-dimensional point cloud) based on the LiDAR detection value, for example, after generation of the synthesized point cloud map as described with reference to FIG. 23 in the above embodiment, next, the information processing device executes the processing in step S228.

That is, in step S228, movement control of the robot 10 is executed using the synthesized point cloud map generated in step S227.

This processing is processing executed by the robot control unit 201 illustrated in FIG. 11.

The robot control unit 201 refers to the synthesized point cloud map obtained by synthesizing the point cloud (three-dimensional point cloud) based on the iTOF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

### (Step S229)

Finally, in step S229, the information processing device 100 determines whether or not the robot 10 has arrived at a destination, and completes the map generation processing and the traveling processing in a case where the robot has arrived at the destination.

In a case where the robot has not arrived at the destination, the process returns to step S221, and the processing of step S221 and subsequent steps is repeated.

In the present embodiment, the exposure time of the iToF camera 120 is lengthened when the robot 10 is traveling at a high speed equal to or higher than the threshold value (Vth), and the exposure time of the iTOF camera 120 is shortened when the robot 10 is traveling at a low speed lower than the threshold value (Vth).

As a result, it is possible to generate an iToF point cloud map in which a highly accurate point cloud is set up to a farther region when the robot 10 is traveling at a high speed, while it is possible to generate an iToF point cloud map in which a highly accurate point cloud is set only in a close region when the robot 10 is traveling at a low speed.

Note that, in the graph of FIG. 30, a dotted-line graph (Processing Example b) illustrated in the region where the speed v (m/s) of the robot (mobile body) 10 is equal to or lower than the threshold value Vth is a modification in which the exposure time control parameter (tᵢₙₜ) is set to a fixed value, that is,
tᵢₙₜ=X (μsec)
in a case where the speed (v) of the robot 10 is lower than the speed threshold value (Vth), similarly to the processing example (Modification 1) illustrated in FIG. 24 of the point cloud cut processing described in the first embodiment above.

That is, the exposure time control parameter (tᵢₙₜ) calculation function of (Processing Example b) can be expressed by the following Formula (Formula 6).

If the robot speed v≥Vth,

tᵢₙₜ=s×v+t_{offset}

If the robot speed v<Vth,

tᵢₙₜ=X (Formula 6)

In a case where the exposure time control parameter (tᵢₙₜ) calculation function expressed by (Formula 6) described above is used, the processing in step S223 of the flow of FIG. 29, that is, the processing when it is determined that the speed (v) of the robot 10 is equal to or higher than the speed threshold value (Vth) is processing on the right side of the threshold value Vth in the graph illustrated in FIG. 24.

That is, in this case, the information processing device 100 lengthens the exposure time of the iToF camera 120 in step S223.

Whereas, the processing in step S224 of the flow of FIG. 29, that is, the processing when it is determined that the speed (v) of the robot 10 is not equal to or higher than the speed threshold value (Vth) is processing of the dotted line (Processing Example b) on the left side of the threshold value Vth in the graph illustrated in FIG. 30.

In other words, in this case, in step S224, the information processing device 100 fixes the exposure time of light output from the iToF camera 120 to
tᵢₙₜ=X (μsec).

For example, a configuration may be adopted in which such processing is executed.

Note that, in a case where the exposure time control parameter (tᵢₙₜ) calculation function expressed by (Formula 6) described above is used, that is, in a case where the following two different functions are used: the function indicated by the dotted line in (Processing Example b) on the left side of the graph illustrated in FIG. 30 when the speed (v) of the robot 10 is lower than the speed threshold value (Vth); and the function indicated by the solid line on the right side of the graph illustrated in FIG. 30 when the speed (v) of the robot 10 is equal to or higher than the speed threshold value (Vth), there is a possibility that the processing becomes unstable if the robot speed (v) fluctuates around the threshold value (Vth).

In order to solve such processing instability, for example, as described above with reference to FIG. 25, a configuration may be adopted in which control in which hysteresis is set is performed.

By setting hysteresis and executing switching of two different exposure time control parameter (tᵢₙₜ) calculation functions, it is possible to smoothly perform exposure time change processing.

As described above, in the “(Third embodiment) Calculation processing of iToF camera exposure time control parameter and processing based on calculated parameter”,
it is possible to change accuracy in the long-distance region of the iToF point cloud map generated by the iToF point cloud map generation unit 126, by changing an exposure time of light output from the iToF camera 120 in accordance with a traveling speed of the robot 10.

That is, the iToF point cloud map generation unit 126 can generate an iToF point cloud map in which a highly accurate point cloud is set up to a farther region when the robot 10 is traveling at a high speed, and generate an iToF point cloud map in which a highly accurate point cloud is set only in a close region when the robot 10 is traveling at a low speed.

[3-4. (Fourth Embodiment) Calculation Processing of iToF Camera Output Light Intensity Control Parameter and Processing Based on Calculated Parameter]

Next, as a fourth embodiment of processing executed by the information processing device 100 of the present disclosure, calculation processing of an iToF camera output light intensity control parameter and processing based on the calculated parameter will be described.

As described above, the iToF camera 120 calculates a distance in accordance with a phase difference between transmission light (output light) and reception light (reflected light).

The transmission light (output light) is output from the light transmission unit 122 of the iTOF camera 120 of the information processing device 100 illustrated in FIG. 11.

The output light from the light transmission unit 122 reaches farther as output intensity is higher, and the light reception unit 124 can receive reflected light from a farther distant object.

That is, as the intensity of light output from the light transmission unit 122 of the iToF camera 120 is increased, distance calculation accuracy of a distant object can be improved.

However, for example, in a case where a person or an oncoming vehicle is present in the vicinity in front, there is a case where outputting high intensity light may disturb the person or the oncoming vehicle.

The fourth embodiment described below is an embodiment in which the intensity control of output light of the iToF camera 120 is executed in view of these situations.

Specifically, in a case where the traveling speed of the robot 10 is fast, it is necessary to calculate a distance of a farther object, and in this case, intensity of output light is increased. Whereas, in a case where the traveling speed of the robot 10 is slow, intensity of output light is decreased. Such intensity control of output light is executed.

An embodiment in which such intensity control of output light is performed will be described below.

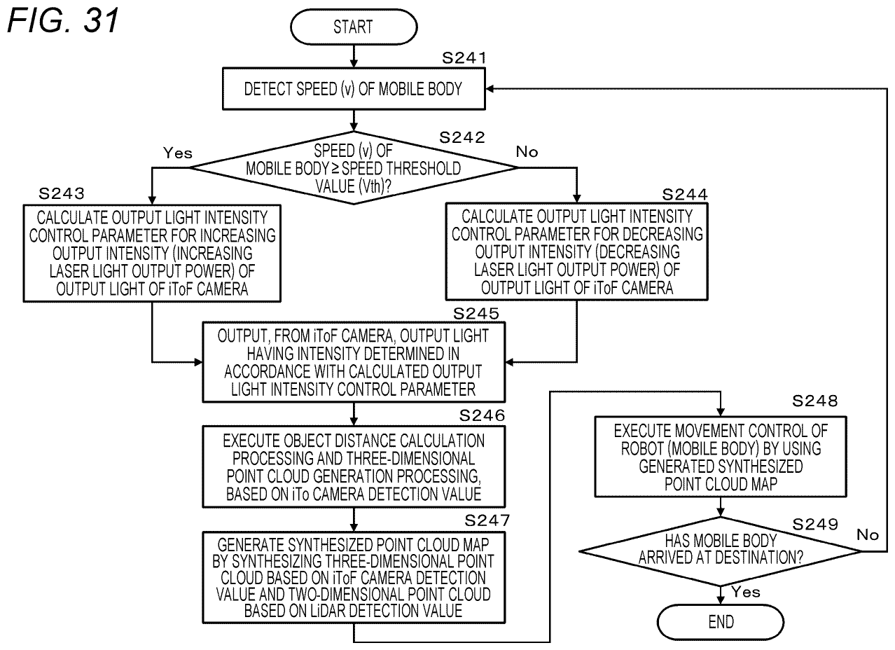

A flowchart illustrated in FIG. 31 is a flowchart for explaining calculation processing of an iToF camera output light intensity control parameter executed by the information processing device 100 of the present disclosure and processing based on the calculated parameter.

Hereinafter, processing of each step of the flow illustrated in FIG. 31 will be sequentially described.

### (Step S241)

First, in step S241, the information processing device 100 of the present disclosure detects a speed (v) of the robot The speed detection processing on the robot (mobile body) 10 is executed by the speed sensor 101 of the information processing device 100 illustrated in FIG. 11, and the detected speed (v) is input to the control unit 132 and the point cloud map synthesizing unit 131.

### (Step S242)

Next, in step S242, the information processing device 100 compares the detected speed (v) of the robot 10 with a predefined speed threshold value (Vth), and determines whether or not the speed (v) of the robot 10 is equal to or higher than the speed threshold value (Vth). That is, it is determined whether the following (Determination Formula a) is satisfied.

v≥Vth (Determination Formula a)

This processing is executed by the control unit 132 of the information processing device 100 illustrated in FIG. 11.

When it is determined that (Determination Formula a) described above is satisfied and the speed (v) of the robot 10 is equal to or higher than the speed threshold value (Vth), the process proceeds to step S243.

Whereas, when it is determined that (Determination Formula a) described above is not satisfied and the speed (v) of the robot 10 is not equal to or higher than the speed threshold value (Vth), the process proceeds to step S244.

### (Sup S243)

When it is determined in step S242 that (Determination Formula a) described above is satisfied and the speed (v) of the robot 10 is equal to or higher than the speed threshold value (Vth), the process proceeds to step S243.

In this case, in step S243, the information processing device 100 calculates an intensity control parameter for increasing the intensity of output light of the iToF camera 120. That is, an intensity control parameter for increasing the intensity of light output from the light transmission unit 122 of the iToF camera 120 is calculated.

This processing is also executed by the control unit 132 of the information processing device 100 illustrated in FIG. 11.

### (Step S244)

Whereas, step S244 is processing when it is determined in step S242 that (Determination Formula a) described above is satisfied and the speed (v) of the robot 10 is not equal to or higher than the speed threshold value (Vth).

In this case, in step S244, the information processing device 100 calculates an intensity control parameter for decreasing the intensity of output light of the iToF camera 120. That is, an intensity control parameter for decreasing the intensity of light output from the light transmission unit 122 of the iToF camera 120 is calculated.

This processing is also executed by the control unit 132 of the information processing device 100 illustrated in FIG. 11.

### (Step S245)

When the processing of calculating the intensity control parameter for increasing or decreasing the intensity of light output from the iToF camera 120 ends in step S243 or step S244, the process proceeds to step S245.

In step S245, the information processing device 100 outputs, from the iToF camera 120, output light having the intensity determined on the basis of the intensity control parameter calculated in step S243 or step S244.

This processing is executed in the output light generation unit 121 and the light transmission unit 122 of the iToF camera 120.

### (Step S246)

Next, in step S246, the information processing device 100 executes object distance calculation processing and three-dimensional point cloud generation processing, based on an iToF camera detection value.

This processing is processing executed by the iToF point cloud map generation unit 126 of the information processing device 100 illustrated in FIG. 11.

The iToF point cloud map generation unit 126 is input with a reception signal of the light reception unit 124 of the iToF camera 120 via the signal processing unit (low-pass filter) 125, and executes the object distance calculation processing and the three-dimensional point cloud generation processing on the basis of the input value, to generate the iToF point cloud map.

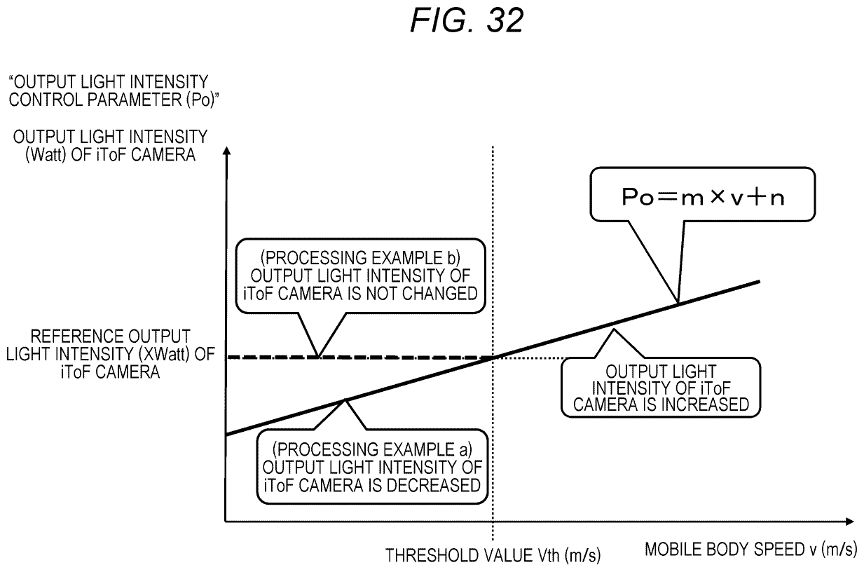

A specific example of a series of processing in steps S243 to S246 will be described with reference to FIG. 32.

FIG. 32 is a graph for explaining a correspondence relationship between a speed of the robot (mobile body) 10 and intensity (Watt) of output light of the iToF camera.

A horizontal axis of the graph represents a speed v (m/s) of the robot (mobile body) 10. A vertical axis is an “intensity control parameter (Po)”, and specifically indicates intensity (Watt) of light output from the iToF camera 120.

Note that, two graphs of a solid line graph (Processing Example a) and a dotted-line graph (Processing Example b) are illustrated in a region where the speed v (m/s) of the robot (mobile body) 10 is equal to or lower than the threshold value Vth. These graphs correspond to the processing example illustrated in FIG. 19 and the processing example illustrated in FIG. 24 regarding the point cloud cut processing of the first embodiment described above, and indicate that two different types of processing can be performed.

First, the solid line graph including (Processing Example a) will be described.

A straight line (solid line) in the graph illustrated in the figure corresponds to a function for calculating the “intensity control parameter (Po)” on the basis of the speed (v) of the robot (mobile body) 10, and is expressed by the following Formula (Formula 7).

Po=m×v+n (Formula 7)
Where,
Po: an intensity control parameter, which is light output intensity (watt) of light output from the iToF camera 120,
m: a correction coefficient (sensitivity corresponding to a speed), and
n: an offset (light output intensity (watt) at a minimum speed value (v=0)).

Furthermore, “output light reference intensity (X (Watt)) of the iToF camera” indicated on the vertical axis of the graph of FIG. 32 is a light output intensity control parameter serving as a reference in a case where the robot is traveling at a predefined “threshold speed (Vth)”, and is “intensity of output light of the iToF camera 120” set in a case where the robot is traveling at the predefined “threshold speed (Vth)”. This reference intensity is defined as X (Watt).

The processing in step S243 of the flow of FIG. 31, that is, the processing when it is determined that the speed (v) of the robot 10 is equal to or higher than the speed threshold value (Vth) is processing on the right side of the threshold value Vth in the graph illustrated in FIG. 32.

That is, in this case, the information processing device 100 increases the intensity of output light of the iToF camera 120 in step S243.

Whereas, the processing in step S244 of the flow of FIG. 31, that is, the processing when it is determined that the speed (v) of the robot 10 is not equal to or higher than the speed threshold value (Vth) is processing on the left side of the threshold value Vth in the graph illustrated in FIG. 32.

That is, in this case, the information processing device 100 decreases the intensity of output light of the iToF camera 120 in step S244.

As described above, in steps S242 to S246, it is determined whether or not the traveling speed (v) of the robot 10 is equal to or higher than the predefined speed threshold value (Vth), the intensity of output light of the iToF camera 120 is increased when the robot 10 is traveling at a high speed equal to or higher than the threshold value (Vth), and the intensity of output light of the iToF camera 120 is decreased when the robot 10 is traveling at a low speed lower than the threshold value (Vth).

By performing such processing, generation processing of the iToF point cloud map according to the traveling speed of the robot 10 can be achieved. That is, it is possible to generate an iTOF point cloud map expressing a distance of a long-distance object with high accuracy at the time of high-speed traveling, and generate an iToF point cloud map expressing a distance of a short-distance object with high accuracy at the time of low-speed traveling.

That is, when the robot 10 is traveling at a high speed, the iToF point cloud map generation unit 126 generates an iToF point cloud map in which a highly accurate point cloud is set up to a farther region.

Whereas, when the robot 10 is traveling at a low speed, an iToF point cloud map in which a highly accurate point cloud is set to an object in a close region is generated.

Returning to the flow illustrated in FIG. 32, processing of step S247 and subsequent steps will be described.

Note that, while generation processing for the iToF point cloud map which is a point cloud based on the iToF camera is being executed in step S246, the LiDAR point cloud map generation unit 105 of the information processing device 100 illustrated in FIG. 11 is generating a LiDAR point cloud map based on a detection value of the 2D-LiDAR 103 in parallel.

As described above with reference to FIG. 13, the LiDAR point cloud map based on the detection value of the 2D-LiDAR 103 and generated by the LiDAR point cloud map generation unit 105 includes point cloud data indicating an object intersecting a two-dimensional plane at a certain height (y=ya) of each object.

### (Step S247)

In step S247, the information processing device 100 generates a synthesized point cloud map by synthesizing the three-dimensional point cloud based on the iToF camera detection value and the two-dimensional point cloud based on the LiDAR detection value.

This processing is processing executed by the point cloud map synthesizing unit 131 of the information processing device 100 illustrated in FIG. 11.

### (Step S248)

After generation of the synthesized point cloud map in step S247 by synthesizing the point cloud (three-dimensional point cloud) based on the iToF camera detection value and the point cloud (two-dimensional point cloud) based on the LiDAR detection value, for example, after generation of the synthesized point cloud map as described with reference to FIG. 23 in the above embodiment, next, the information processing device executes the processing in step S248.

That is, in step S248, movement control of the robot 10 is executed using the synthesized point cloud map generated in step S247.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

### (Step S249)

Finally, in step S249, the information processing device 100 determines whether or not the robot 10 has arrived at a destination, and completes the map generation processing and the traveling processing in a case where the robot has arrived at the destination.

In a case where the robot has not arrived at the destination, the process returns to step S241, and the processing of step S241 and subsequent steps is repeated.

In the present embodiment, the intensity of output light of the iToF camera 120 is increased when the robot 10 is traveling at a high speed equal to or higher than the threshold value (Vth), and the intensity of output light of the iToF camera 120 is decreased when the robot 10 is traveling at a low speed lower than the threshold value (Vth).

As a result, it is possible to generate an iToF point cloud map in which a highly accurate point cloud is set for an object in a farther region when the robot 10 is traveling at a high speed, while it is possible to generate an iToF point cloud map in which a highly accurate point cloud is set for an object in a close region when the robot 10 is traveling at a low speed.

Note that, in the graph of FIG. 32, a dotted-line graph (Processing Example b) illustrated in the region where the speed v (m/s) of the robot (mobile body) 10 is equal to or lower than the threshold value Vth is a modification in which the intensity control parameter (Po) is set to a fixed value, that is,
Po=X (Watt)
in a case where the speed (v) of the robot 10 is lower than the speed threshold value (Vth), similarly to the processing example (Modification 1) illustrated in FIG. 24 of the point cloud cut processing described in the first embodiment above.

That is, the intensity control parameter (Po) calculation function of (Processing Example b) can be expressed by the following Formula (Formula 8).

If the robot speed v≥Vth,

Po=m×v+n,

If the robot speed v<Vth,

Po=X (Formula 8)

In a case where the intensity control parameter (Po) calculation function expressed by (Formula 8) described above is used, the processing in step S243 of the flow of FIG. 31, that is, the processing when it is determined that the speed (v) of the robot 10 is equal to or higher than the speed threshold value (Vth) is processing on the right side of the threshold value Vth in the graph illustrated in FIG. 24.

That is, in this case, the information processing device 100 increases the intensity of light output from the iToF camera 120 in step S243.

Whereas, the processing in step S244 of the flow of FIG. 31, that is, the processing when it is determined that the speed (v) of the robot 10 is not equal to or higher than the speed threshold value (Vth) is processing of the dotted line (Processing Example b) on the left side of the threshold value Vth in the graph illustrated in FIG. 32.

In other words, in this case, in step S244, the information processing device 100 fixes the intensity of light output from the iToF camera 120 to
Po=X (Watt).

For example, a configuration may be adopted in which such processing is executed.

Note that, in a case where the intensity control parameter (Po) calculation function indicated by (Formula 8) described above is used, that is, in a case where the following two different functions are used: the function indicated by the dotted line of (Processing Example b) on the left side of the graph illustrated in FIG. 32 when the speed (v) of the robot 10 is lower than the speed threshold value (Vth) ; and the function indicated by the solid line on the right side of the graph illustrated in FIG. 32 when the speed (v) of the robot 10 is equal to or higher than the speed threshold value (Vth), there is a possibility that the processing becomes unstable if the robot speed (v) fluctuates around the threshold value (Vth).

In order to solve such processing instability, for example, as described above with reference to FIG. 25, a configuration may be adopted in which control in which hysteresis is set is performed.

By setting hysteresis and executing switching of two different intensity control parameter (Po) calculation functions, it is possible to smoothly perform intensity change processing.

As described above, in “(Fourth embodiment) Calculation processing of iToF camera output light intensity control parameter and processing based on calculated parameter”, it is possible to change distance calculation accuracy of an object in a long-distance region of the iToF point cloud map generated by the iToF point cloud map generation unit 126, by changing intensity of light output from the iToF camera 120 in accordance with a traveling speed of the robot 10.

That is, the iToF point cloud map generation unit 126 can generate an iToF point cloud map in which a highly accurate point cloud is set up to a farther region when the robot 10 is traveling at a high speed, and generate an iToF point cloud map in which a highly accurate point cloud is set for an object in a close region when the robot 10 is traveling at a low speed.

Note that, until now, the first to fourth embodiments have been described, that is, as follows:
(First embodiment) Calculation processing of iToF point cloud cut region control parameter and processing based on calculated parameter
(Second embodiment) Calculation processing of iToF camera output light frequency control parameter and processing based on calculated parameter
(Third embodiment) Calculation processing of iTOF camera exposure time control parameter and processing based on calculated parameter
(Fourth embodiment) Calculation processing of iToF camera output light intensity control parameter and processing based on calculated parameter

These four embodiments have been described. Each of these embodiments can be executed individually, but any plurality of embodiments may be combined and executed.

### 4. (Fifth Embodiment) Embodiment in Which Processing of Each of First to Fourth Embodiments Described Above is Sequentially Executed

Next, as (Fifth embodiment), an embodiment in which processing of each of the first to fourth embodiments described above is sequentially executed will be described.

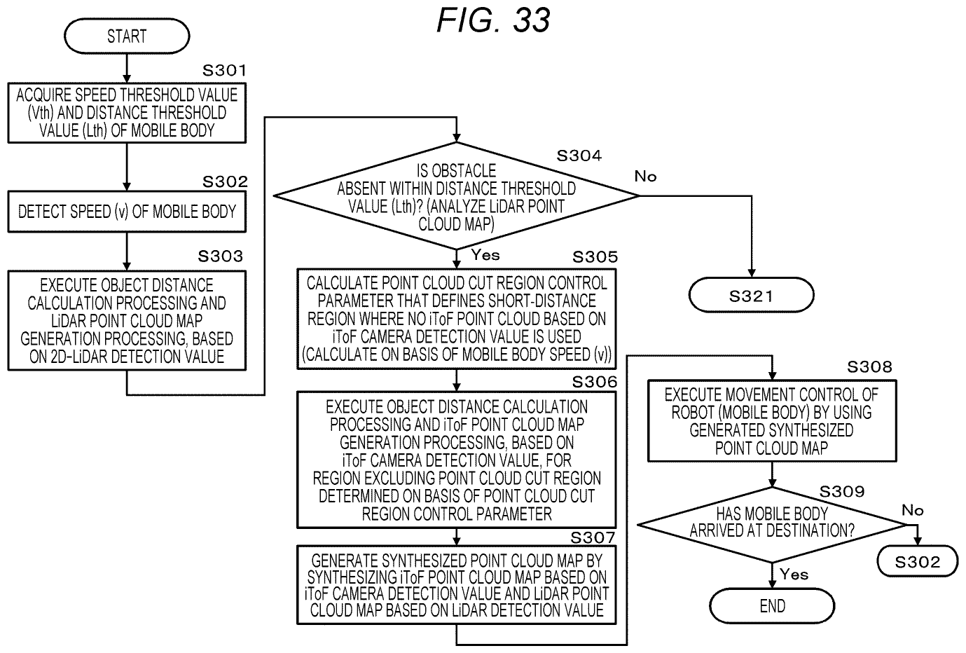

Flowcharts illustrated in FIGS. 33 to 36 are flowcharts for explaining processing of (Fifth embodiment) executed by the information processing device 100 of the present disclosure, that is, the processing of sequentially executing the processing of each of the first to fourth embodiments described above.

Hereinafter, processing of each step of the flow illustrated in FIGS. 33 to 36 will be sequentially described.

### (Step S301)

First, in step S301, the information processing device 100 of the present disclosure acquires a speed threshold value (Vth) and a distance threshold value (Lth) of a mobile body, that is, the robot 10.

This processing is executed by the control unit 132 of the information processing device 100 illustrated in FIG. 11.

The speed threshold value (Vth) and the distance threshold value (Lth) are threshold values to be used to determine a processing mode, are determined in advance according to a specification of the iToF camera 120 to be used, and are stored in a storage unit of the information processing device 100.

Note that these threshold values may be determined by the control unit 132 each time. For example, test imaging is performed by the iToF camera 120, and definition or the like of reception light with respect to output light is analyzed and determined. There is a possibility that the definition of reception light with respect to output light changes according to brightness of the surroundings and a weather condition, and a configuration may be adopted in which threshold determination processing is performed in consideration of these.

### (Step S302)

Next, in step S302, the information processing device 100 detects a speed (v) of the robot (mobile body) 10.

The speed detection processing on the robot (mobile body) 10 is executed by the speed sensor 101 of the information processing device 100 illustrated in FIG. 11, and the detected speed (v) is input to the control unit 132 and the point cloud map synthesizing unit 131.

### (Step S303)

Next, in step S303, the information processing device 100 executes object distance calculation processing and LiDAR point cloud map generation processing based on a 2D-LiDAR detection value.

This processing is processing executed in the 2D-LiDAR 103 and the LiDAR point cloud map generation unit 105 of the information processing device 100 illustrated in FIG. 11.

The LiDAR point cloud map generation unit 105 generates a LiDAR point cloud map based on a detection value of the 2D-LiDAR 103. Note that, as described above with reference to FIG. 13, the LiDAR point cloud map based on the detection value of the 2D-LiDAR 103 and generated by the LiDAR point cloud map generation unit 105 is a point cloud map including point cloud data indicating an object intersecting a two-dimensional plane at a certain height (y=ya) of each object.

### (Step S304)

Next, in step S304, the information processing device 100 determines whether no obstacle has been detected within the distance threshold value (Lth) acquired from the storage unit in step S301.

In this processing, the determination is made by the control unit 132 referring to the LiDAR point cloud map generated by the LiDAR point cloud map generation unit 105.

When it is determined that no obstacle has been detected within the distance threshold value (Lth), the process proceeds to step S305.

Whereas, when it is determined that an obstacle has been detected within the distance threshold value (Lth), the process proceeds to step S321.

### (Step S305)

When it is determined in step S304 that no obstacle has been detected within the distance threshold value (Lth), the process proceeds to step S305.

In this case, in step S305, the information processing device 100 calculates a point cloud cut region control parameter that defines a short-distance region where no iTOF point cloud generated on the basis of a detection value of the iToF camera 120 is used. The calculation is performed on the basis of the mobile body speed (v).

This processing is executed by the control unit 132 of the information processing device 100 illustrated in FIG. 11.

The processing of step S305 is processing corresponding to the processing of steps S103 and S104 of the flowchart illustrated in FIG. 18, which is a flowchart corresponding to the first embodiment described above. That is, the point cloud cut region control parameter is calculated on the basis of a function corresponding to the graph illustrated in FIG. 19 described above.

For example, as described above with reference to FIG. 19, a point cloud cut region control parameter (Dmin) is calculated by the following Formula (Formula 1).

Dmin=a×v+b (Formula 1)
Where,
Dmin: a point cloud cut region control parameter, which is a maximum distance (m) of the point cloud cut region from the robot 10,
v: a speed (m/s) of the robot,
a: a correction coefficient (sensitivity corresponding to a speed), and
b: an offset (a point cloud cut region specified value at a minimum speed value (v=0)).

For example, when it is determined that the speed (v) of the robot 10 is equal to or higher than the speed threshold value (Vth), a point cloud cut region control parameter for enlarging the short-distance region where no three-dimensional point cloud based on the iToF camera detection value is used is calculated.

Whereas, when it is determined that the speed (v) of the robot 10 is not equal to or higher than the speed threshold value (Vth), a point cloud cut region control parameter for reducing the short-distance region where no three-dimensional point cloud based on the iToF camera detection value is used is calculated.

### (Step S306)

Next, in step S306, the information processing device 100 executes object distance calculation processing and generation processing for the iToF point cloud map, based on an iToF camera detection value, for a region excluding the point cloud cut region determined on the basis of the point cloud cut region control parameter.

This processing is processing executed by the iToF point cloud map generation unit 126 of the information processing device 100 illustrated in FIG. 11.

The iToF point cloud map generation unit 126 is input with the point cloud cut region control parameter from the control unit 132, determines the point cloud cut region where no three-dimensional point cloud based on the iToF camera detection value is generated in accordance with the input point cloud cut region control parameter, and generates the iToF point cloud map in which a point cloud is set only in a region excluding the determined point cloud cut region.

### (Step S307)

Next, in step S307, the information processing device 100 generates a synthesized point cloud map.

That is, a synthesized point cloud map is generated by synthesizing the iToF point cloud map generated on the basis of the iToF camera detection value in step S306 and the LiDAR point cloud map generated on the basis of the LiDAR detection value in step S303.

This processing is processing executed by the point cloud map synthesizing unit 131 of the information processing device 100 illustrated in FIG. 11.

A specific example of the synthesized point cloud map generated by the point cloud map synthesizing unit 131 is as described above with reference to FIG. 23.

As illustrated in FIG. 23, the synthesized point cloud map generated by the point cloud map synthesizing unit 131 has a configuration in which the following individual point cloud regions are set from a side closer to the robot 10.
(a) LiDAR point cloud region 191
(b) iTOF point cloud & LiDAR point cloud region 192
(c) LiDAR point cloud region 193

In each of these regions, “(a) LiDAR point cloud region 191” and “(c) LiDAR point cloud region 193” have no iTOF point cloud, and include only a LiDAR point cloud (point cloud on a two-dimensional plane).

“(b) iToF point cloud & LiDAR point cloud region 192” is a region where, in addition to the LiDAR point cloud (point cloud on a two-dimensional plane), an iTOF point cloud (three-dimensional point cloud) generated on the basis of a detection value of the iToF camera is also set.

The robot 10 can acquire an object position and distance information with higher accuracy from “(b) iToF point cloud & LiDAR point cloud region 192”.

Note that “(b) iTOF point cloud & LiDAR point cloud region 192” is a highly important region to be used to determine the traveling route of the robot 10.

### (Step S308)

After generation of the synthesized point cloud map in step S307 by synthesizing the point cloud (three-dimensional point cloud) based on the iToF camera detection value and the point cloud (two-dimensional point cloud) based on the LiDAR detection value, for example, after generation of the synthesized point cloud map as illustrated in FIG. 23, next, the information processing device executes the processing of step S308.

That is, in step S308, movement control of the robot 10 is executed using the synthesized point cloud map generated in step S307.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

Note that the point cloud data to be used for the traveling route determination processing performed by the robot control unit 201 is mainly “(b) iTOF point cloud & LiDAR point cloud region 192” in the synthesized point cloud map illustrated in FIG. 23.

As described above, in “(b) iTOF point cloud & LiDAR point cloud region 192”, in addition to the LiDAR point cloud (point cloud on a two-dimensional plane), the iToF point cloud (three-dimensional point cloud) generated on the basis of the detection value of the iToF camera is also set, and it is possible to analyze the object position and the distance information with higher accuracy, and to set a safe and reliable traveling route.

### (Step S309)

Finally, in step S309, the information processing device 100 determines whether or not the robot 10 has arrived at a destination, and completes the map generation processing and the traveling processing in a case where the robot has arrived at the destination.

In a case where the robot has not arrived at the destination, the process returns to step S302, and the processing of step S302 and subsequent steps is repeated.

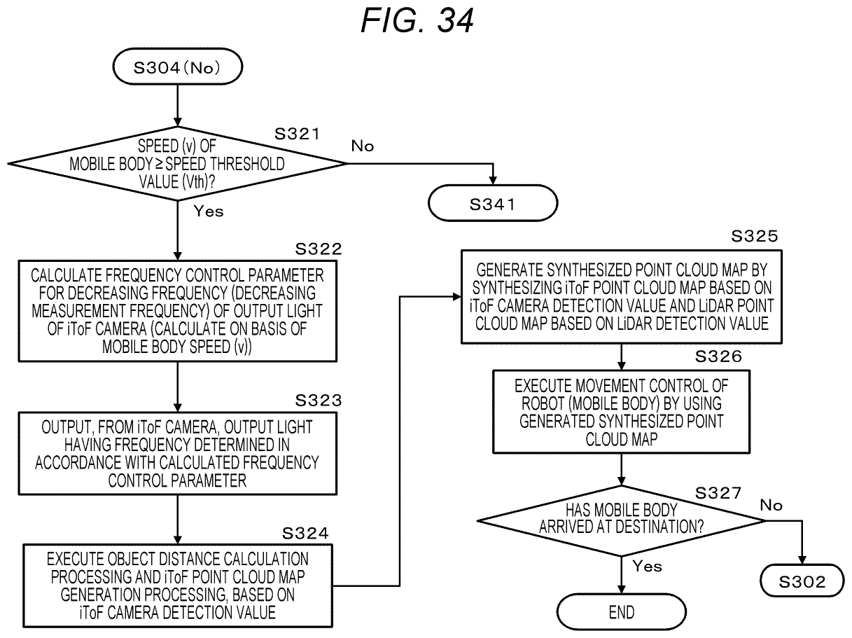

Next, description will be made on processing in step S321 and subsequent steps in a case where determination of No is made in the determination step of step S304, that is, when it is determined that an obstacle has been detected within the distance threshold value (Lth), with reference to a flow illustrated in FIG. 34 and subsequent figures.

### (Step S321)

When it is determined in step S304 that an obstacle has been detected within the distance threshold value (Lth), the information processing device 100 compares, in step S321, the speed (v) of the robot 10 detected in the previous step S302 with the predefined speed threshold value (Vth), and determines whether or not the speed (v) of the robot 10 is equal to or higher than the speed threshold value (Vth). That is, it is determined whether the following (Determination Formula a) is satisfied.

v≥Vth (Determination Formula a)

This processing is executed by the control unit 132 of the information processing device 100 illustrated in FIG. 11.

When it is determined that (Determination Formula a) described above is satisfied and the speed (v) of the robot 10 is equal to or higher than the speed threshold value (Vth), the process proceeds to step S322.

Whereas, when it is determined that (Determination Formula a) described above is not satisfied and the speed (v) of the robot 10 is not equal to or higher than the speed threshold value (Vth), the process proceeds to step S341.

### (Sup S322)

When it is determined in step S321 that (Determination Formula a) described above is satisfied and the speed (v) of the robot 10 is equal to or higher than the speed threshold value (Vth), the process proceeds to step S322.

In this case, in step S322, the information processing device 100 calculates a frequency control parameter for decreasing the frequency of output light of the iToF camera 120. That is, a frequency control parameter for decreasing the frequency of light output from the light transmission unit 122 of the iToF camera 120 is calculated.

This processing is also executed by the control unit 132 of the information processing device 100 illustrated in FIG. 11.

The processing of step S322 is processing corresponding to the processing of step S203 of the flowchart illustrated in FIG. 27 which is a flowchart corresponding to the second embodiment described above. That is, a frequency control parameter is calculated on the basis of a function corresponding to the graph illustrated in FIG. 28 described above. Specifically, a frequency control parameter (fmod) is calculated according to the following Formula (Formula 3).

fmod=(½)c×(1/Dmax) (Formula 3)
Where,
fmod: a frequency control parameter, which is a frequency (Hz) of light output from the iToF camera 120,
c: a speed of light (c=3×10⁸ (m/s)),
Dmax: a target maximum measurement distance,
Dmax=p×v+q,
v: a speed of the robot (m/s),
p: a correction coefficient (sensitivity corresponding to a speed), and
q: an offset (a target maximum measurement distance at a minimum speed value (v=0)).

The processing in step S322 is processing when it is determined that the speed (v) of the robot 10 is equal to or higher than the speed threshold value (Vth), and is to calculate the frequency control parameter for decreasing the frequency of output light of the iTOF camera 120 to be lower than the reference frequency (X (Hz)) in accordance with the formula (Formula 3) described above.

### (Step S323)

Next, in step S323, the information processing device 100 outputs, from the iToF camera 120, output light having a frequency determined on the basis of the frequency control parameter calculated in step S322.

This processing is executed in the output light generation unit 121 and the light transmission unit 122 of the iToF camera 120.

### (Step S324)

Next, in step S324, the information processing device 100 executes object distance calculation processing and generation processing for the iToF point cloud map, based on an iToF camera detection value.

This processing is processing executed by the iToF point cloud map generation unit 126 of the information processing device 100 illustrated in FIG. 11.

The iToF point cloud map generation unit 126 is input with a reception signal of the light reception unit 124 of the iToF camera 120 via the signal processing unit (low-pass filter) 125, and executes the object distance calculation processing and the three-dimensional point cloud generation processing on the basis of the input value, to generate the iToF point cloud map.

### (Step S325)

Next, in step S325, the information processing device 100 generates a synthesized point cloud map.

That is, a synthesized point cloud map is generated by synthesizing the iToF point cloud map generated on the basis of the iToF camera detection value in step S324 and the LiDAR point cloud map generated on the basis of the LiDAR detection value in step S303.

This processing is processing executed by the point cloud map synthesizing unit 131 of the information processing device 100 illustrated in FIG. 11.

A specific example of the synthesized point cloud map generated by the point cloud map synthesizing unit 131 is as described above with reference to FIG. 23.

As illustrated in FIG. 23, the synthesized point cloud map generated by the point cloud map synthesizing unit 131 has a configuration in which the following individual point cloud regions are set from a side closer to the robot 10.
(a) LiDAR point cloud region 191
(b) iToF point cloud & LiDAR point cloud region 192
(c) LiDAR point cloud region 193

The robot 10 can acquire an object position and distance information with higher accuracy from “(b) iTOF point cloud & LiDAR point cloud region 192”.

Note that “(b) iTOF point cloud & LiDAR point cloud region 192” is a highly important region to be used to determine the traveling route of the robot 10.

### (Step S326)

After generation of the synthesized point cloud map in step S325 by synthesizing the point cloud (three-dimensional point cloud) based on the iToF camera detection value and the point cloud (two-dimensional point cloud) based on the LiDAR detection value, for example, after generation of the synthesized point cloud map as illustrated in FIG. 23, next, the information processing device executes the processing of step S326.

That is, in step S326, movement control of the robot 10 is executed using the synthesized point cloud map generated in step S325.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

Note that the point cloud data to be used for the traveling route determination processing performed by the robot control unit 201 is mainly “(b) iToF point cloud & LiDAR point cloud region 192” in the synthesized point cloud map illustrated in FIG. 23.

As described above, in “(b) iTOF point cloud & LiDAR point cloud region 192”, in addition to the LiDAR point cloud (point cloud on a two-dimensional plane), the iTOF point cloud (three-dimensional point cloud) generated on the basis of the detection value of the iToF camera is also set, and it is possible to analyze the object position and the distance information with higher accuracy, and to set a safe and reliable traveling route.

### (Step S327)

Next, in step S327, the information processing device 100 determines whether or not the robot 10 has arrived at a destination, and completes the map generation processing and the traveling processing in a case where the robot has arrived at the destination.

In a case where the robot has not arrived at the destination, the process returns to step S302, and the processing of step S302 and subsequent steps is repeated.

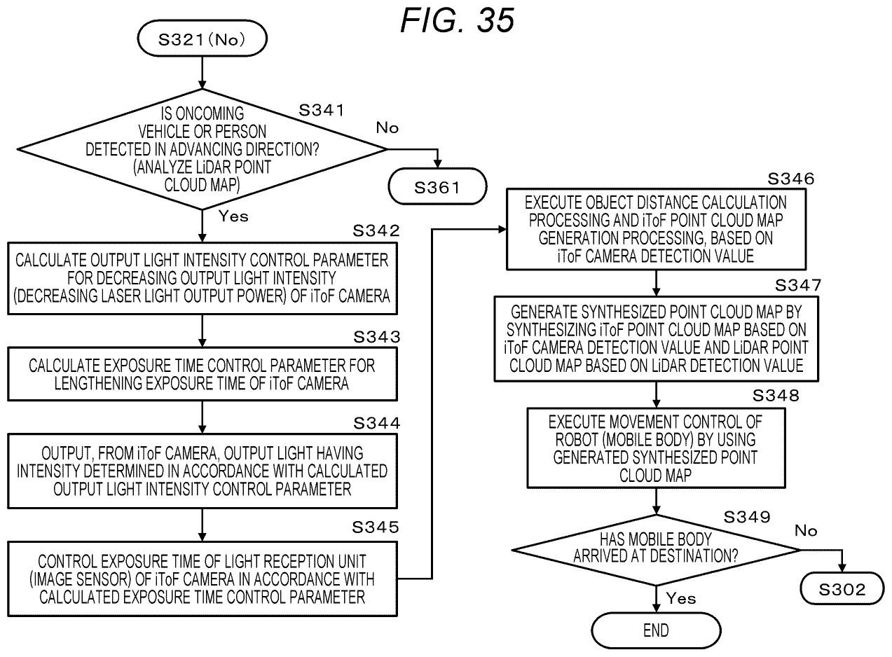

Next, description will be made on processing in step S341 and subsequent steps in a case where determination of No is made in the determination step of step S321, that is, when it is determined that the speed (v) of the robot 10 as the mobile body is not equal to or higher than the speed threshold value (Vth), with reference to the flow illustrated in FIG. 35 and subsequent figures.

### (Step S341)

When it is determined in step S321 that the speed (v) of the robot 10 is not equal to or higher than the speed threshold value (Vth), the information processing device 100 determines in step S341 whether or not a person or an oncoming vehicle has been detected in an advancing direction of the robot 10.

This processing is, for example, processing executed by the control unit 132 of the information processing device 100 illustrated in FIG. 11.

The control unit 132 performs object shape analysis on objects detected on the basis of the LiDAR point cloud map, for example, and determines whether or not these objects are a person or an oncoming vehicle. Alternatively, an image captured by an RGB camera (not illustrated in FIG. 11) may be input to perform object identification processing.

When it is determined that a person or an oncoming vehicle has been detected in the advancing direction of the robot 10, the process proceeds to step S342.

Whereas, when it is determined that no person or oncoming vehicle has been detected in the advancing direction of the robot 10, the process proceeds to step S361.

### (Step S342)

When it is determined in the determination processing of step S341 that a person or an oncoming vehicle has been detected in the advancing direction of the robot 10, the information processing device 100 calculates an intensity control parameter for decreasing the intensity of output light of the iToF camera 120 in step S342. That is, an intensity control parameter for decreasing the intensity of light output from the light transmission unit 122 of the iToF camera 120 is calculated.

This processing is executed by the control unit 132 of the information processing device 100 illustrated in FIG. 11.

The processing of step S342 is processing corresponding to the processing of step S244 of the flowchart illustrated in FIG. 31 which is a flowchart corresponding to the fourth embodiment described above. That is, an output light intensity control parameter is calculated on the basis of a function corresponding to the graph illustrated in FIG. 32 described above. Specifically, an output light intensity control parameter (Po) is calculated according to the following formula (Formula 7).

Po=m×v+n (Formula 7)
Where,
Po: an intensity control parameter, which is light output intensity (watt) of light output from the iToF camera 120,
m: a correction coefficient (sensitivity corresponding to a speed), and
n: an offset (light output intensity (watt) at a minimum speed value (v=0)).

The processing in step S342 is processing when it is determined that a person or an oncoming vehicle has been detected in the advancing direction of the robot 10, and is to calculate the output light intensity control parameter for decreasing the intensity of output light of the iToF camera 120, for example, to be lower than the reference strong output light intensity (X (Watt)) in accordance with the formula (Formula 7) described above.

Decreasing the intensity of output light of the iToF camera 120 in this manner is processing for preventing a person or an oncoming vehicle in the advancing direction of the robot 10 from being disturbed.

### (Step S343)

Next, in step S343, the information processing device 100 calculates an exposure control parameter for lengthening an exposure time of the iToF camera 120.

The processing of step S343 is processing corresponding to the processing of step S223 of the flowchart illustrated in FIG. 29 which is a flowchart corresponding to the third embodiment described above. That is, the exposure time control parameter is calculated on the basis of a function corresponding to the graph illustrated in FIG. 30 described above. Specifically, an exposure time control parameter (tᵢₙₜ) is calculated according to the following Formula (Formula 5) .

tᵢₙₜ=s×v+t_{offset} (Formula 5)
Where,
tᵢₙₜ: an exposure time control parameter, which is an exposure time (μsec) of the light reception unit 124 of the iTOF camera 120,
s: a correction coefficient (sensitivity corresponding to a speed),
v: a speed (m/s) of the robot, and
t_{offset}: an offset (an exposure time (μsec) at a minimum speed value (v=0)).

The processing in step S343 is processing when it is determined that a person or an oncoming vehicle has been detected in the advancing direction of the robot 10 and the output light intensity control of decreasing the intensity of output light of the iToF camera 120 is executed in step S342, and processing of lengthening the exposure time is performed to compensate for the decrease in sensitivity of reception light of the iToF camera with the decrease in the intensity of output light.

### (Step S344)

Next, in step S344, the information processing device 100 outputs, from the iToF camera 120, output light having intensity determined on the basis of the intensity control parameter calculated in step S342.

This processing is executed in the output light generation unit 121 and the light transmission unit 122 of the iToF camera 120.

### (Step S345)

Next, in step S345, the information processing device 100 sets an exposure time determined on the basis of the exposure time control parameter calculated in step S343, as the exposure time of the light reception unit 124 of the iToF camera 120.

This processing is executed by the exposure time control unit 123 and the light reception unit 124 of the iTOF camera 120.

### (Step S346)

Next, in step S346, the information processing device 100 executes object distance calculation processing and generation processing for the iToF point cloud map, based on an iToF camera detection value.

This processing is processing executed by the iToF point cloud map generation unit 126 of the information processing device 100 illustrated in FIG. 11.

The iToF point cloud map generation unit 126 is input with a reception signal of the light reception unit 124 of the iToF camera 120 via the signal processing unit (low-pass filter) 125, and executes the object distance calculation processing and the three-dimensional point cloud generation processing on the basis of the input value, to generate the iToF point cloud map.

### (Step S347)

Next, in step S347, the information processing device 100 generates a synthesized point cloud map.

That is, a synthesized point cloud map is generated by synthesizing the iToF point cloud map generated on the basis of the iToF camera detection value in step S346 and the LiDAR point cloud map generated on the basis of the LiDAR detection value in step S303.

This processing is processing executed by the point cloud map synthesizing unit 131 of the information processing device 100 illustrated in FIG. 11.

A specific example of the synthesized point cloud map generated by the point cloud map synthesizing unit 131 is as described above with reference to FIG. 23.

As illustrated in FIG. 23, the synthesized point cloud map generated by the point cloud map synthesizing unit 131 has a configuration in which the following individual point cloud regions are set from a side closer to the robot 10.
(a) LiDAR point cloud region 191
(b) iToF point cloud & LiDAR point cloud region 192
(c) LiDAR point cloud region 193

The robot 10 can acquire an object position and distance information with higher accuracy from “(b) iToF point cloud & LiDAR point cloud region 192”.

Note that “(b) iToF point cloud & LiDAR point cloud region 192” is a highly important region to be used to determine the traveling route of the robot 10.

### (Step S348)

After generation of the synthesized point cloud map in step S347 by synthesizing the point cloud (three-dimensional point cloud) based on the iToF camera detection value and the point cloud (two-dimensional point cloud) based on the LiDAR detection value, for example, after generation of the synthesized point cloud map as illustrated in FIG. 23, next, the information processing device executes the processing of step S348.

That is, in step S348, movement control of the robot 10 is executed using the synthesized point cloud map generated in step S347.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

Note that the point cloud data to be used for the traveling route determination processing performed by the robot control unit 201 is mainly “(b) iTOF point cloud & LiDAR point cloud region 192” in the synthesized point cloud map illustrated in FIG. 23.

As described above, in “(b) iTOF point cloud & LiDAR point cloud region 192”, in addition to the LiDAR point cloud (point cloud on a two-dimensional plane), the iToF point cloud (three-dimensional point cloud) generated on the basis of the detection value of the iToF camera is also set, and it is possible to analyze the object position and the distance information with higher accuracy, and to set a safe and reliable traveling route.

### (Step S349)

Next, in step S349, the information processing device 100 determines whether or not the robot 10 has arrived at a destination, and completes the map generation processing and the traveling processing in a case where the robot has arrived at the destination.

In a case where the robot has not arrived at the destination, the process returns to step S302, and the processing of step S302 and subsequent steps is repeated.

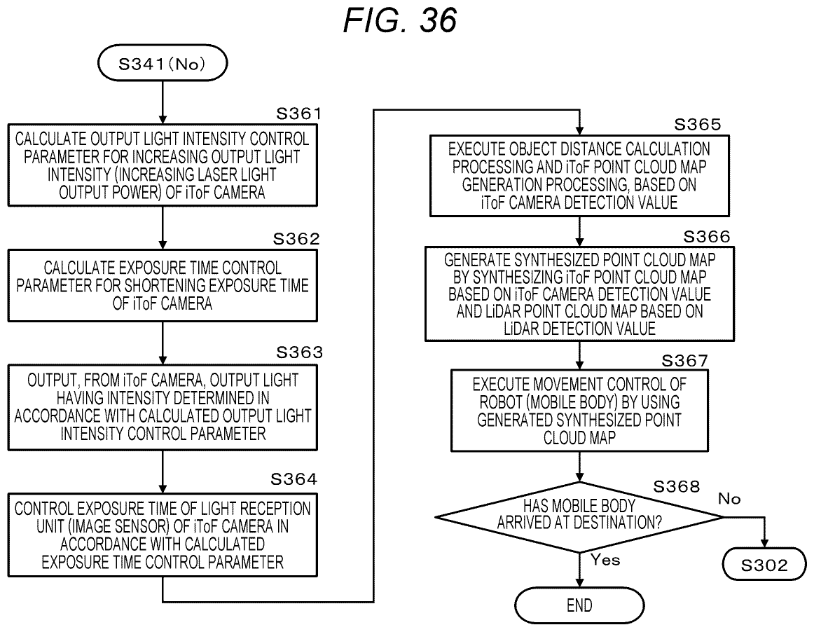

Next, with reference to the flow illustrated in FIG. 36, description will be made on processing in step S361 and subsequent steps in a case where determination of No is made in the determination step of step S341, that is, in a case where no person or oncoming vehicle has been detected in the advancing direction of the robot 10 as the mobile body.

### (Step S361)

In a case where determination of No is made in the determination step of step S341, that is, in a case where no person or oncoming vehicle has been detected in the advancing direction of the robot 10 as the mobile body, the information processing device 100 executes the processing of step S361 and subsequent steps.

In this case, in step S361, the information processing device 100 calculates an intensity control parameter for increasing the intensity of output light of the iToF camera 120. That is, an intensity control parameter for increasing the intensity of light output from the light transmission unit 122 of the iToF camera 120 is calculated.

This processing is executed by the control unit 132 of the information processing device 100 illustrated in FIG. 11.

The processing of step S361 is processing corresponding to the processing of step S243 of the flowchart illustrated in FIG. 31 which is a flowchart corresponding to the fourth embodiment described above. That is, an output light intensity control parameter is calculated on the basis of a function corresponding to the graph illustrated in FIG. 32 described above.

Specifically, an output light intensity control parameter (Po) is calculated according to the following formula (Formula 7).

Po=m×v+n (formula 7)
Where,
Po: an intensity control parameter, which is light output intensity (watt) of light output from the iToF camera 120,
m: a correction coefficient (sensitivity corresponding to a speed), and
n: an offset (light output intensity (watt) at a minimum speed value (v=0)).

The processing in step S361 is processing when it is determined that no person or oncoming vehicle has been detected in the advancing direction of the robot 10, and is to calculate the output light intensity control parameter for increasing the intensity of output light of the iToF camera 120, for example, to be higher than the reference strong output light intensity (X (Watt)) in accordance with the formula (Formula 7) described above.

This is because, there is no person or oncoming vehicle in the advancing direction of the robot 10, and no person or oncoming vehicle is to be disturbed even if the intensity of output light of the iToF camera 120 is increased in this manner. In this case, the processing is for enabling calculation of a distance of a farther object with high accuracy.

### (Step S362)

Next, in step S362, the information processing device 100 calculates an exposure control parameter for shortening an exposure time of the iToF camera 120.

The processing of step S362 is processing corresponding to the processing of step S224 of the flowchart illustrated in FIG. 29 which is a flowchart corresponding to the third embodiment described above. That is, the exposure time control parameter is calculated on the basis of a function corresponding to the graph illustrated in FIG. 30 described above. Specifically, an exposure time control parameter (tᵢₙₜ) is calculated according to the following Formula (Formula 5).

tᵢₙₜ=s×v+t_{offset} (Formula 5)
Where,
tᵢₙₜ: an exposure time control parameter, which is an exposure time (μsec) of the light reception unit 124 of the iToF camera 120,
s: a correction coefficient (sensitivity corresponding to a speed),
v: a speed (m/s) of the robot, and
t_{offset}: an offset (an exposure time (μsec) at a minimum speed value (v=0)).

The processing in step S362 is processing in a case where the output light intensity control of increasing the intensity of output light of the iToF camera 120 is executed in step S361 under the determination that no person or oncoming vehicle is detected in the advancing direction of the robot 10, and is processing to shorten the exposure time in order to prevent excessive increase in intensity of reception light of the iToF camera with the increase in intensity of output light.

### (Step S363)

Next, in step S363, the information processing device 100 outputs, from the iToF camera 120, output light having intensity determined on the basis of the intensity control parameter calculated in step S361.

This processing is executed in the output light generation unit 121 and the light transmission unit 122 of the iToF camera 120.

### (Step S364)

Next, in step S364, the information processing device 100 sets an exposure time determined on the basis of the exposure time control parameter calculated in step S362, as the exposure time of the light reception unit 124 of the iToF camera 120.

This processing is executed by the exposure time control unit 123 and the light reception unit 124 of the iTOF camera 120.

### (Step S365)

Next, in step S365, the information processing device 100 executes object distance calculation processing and generation processing for the iToF point cloud map, based on an iToF camera detection value.

This processing is processing executed by the iToF point cloud map generation unit 126 of the information processing device 100 illustrated in FIG. 11.

The iTOF point cloud map generation unit 126 is input with a reception signal of the light reception unit 124 of the iToF camera 120 via the signal processing unit (low-pass filter) 125, and executes the object distance calculation processing and the three-dimensional point cloud generation processing on the basis of the input value, to generate the iToF point cloud map.

### (Step S366)

Next, in step S366, the information processing device 100 generates a synthesized point cloud map.

That is, a synthesized point cloud map is generated by synthesizing the iToF point cloud map generated on the basis of the iToF camera detection value in step S365 and the LiDAR point cloud map generated on the basis of the LiDAR detection value in step S303.

This processing is processing executed by the point cloud map synthesizing unit 131 of the information processing device 100 illustrated in FIG. 11.

A specific example of the synthesized point cloud map generated by the point cloud map synthesizing unit 131 is as described above with reference to FIG. 23.

As illustrated in FIG. 23, the synthesized point cloud map generated by the point cloud map synthesizing unit 131 has a configuration in which the following individual point cloud regions are set from a side closer to the robot 10.
(a) LiDAR point cloud region 191
(b) iToF point cloud & LiDAR point cloud region 192
(c) LiDAR point cloud region 193

The robot 10 can acquire an object position and distance information with higher accuracy from “(b) iToF point cloud & LiDAR point cloud region 192”.

Note that “(b) iTOF point cloud & LiDAR point cloud region 192” is a highly important region to be used to determine the traveling route of the robot 10.

(step S367)

After generation of the synthesized point cloud map in step S366 by synthesizing the point cloud (three-dimensional point cloud) based on the iToF camera detection value and the point cloud (two-dimensional point cloud) based on the LiDAR detection value, for example, after generation of the synthesized point cloud map as illustrated in FIG. 23, next, the information processing device executes the processing of step S367.

That is, in step S367, movement control of the robot 10 is executed using the synthesized point cloud map generated in step S366.

This processing is processing executed by the robot control unit 201 illustrated in FIG. 11.

The robot control unit 201 refers to the synthesized point cloud map obtained by synthesizing the point cloud (three-dimensional point cloud) based on the iToF camera detection value and the point cloud (two-dimensional point cloud) based on the LiDAR detection value, for example, refers to the synthesized point cloud map as illustrated in FIG. 23, and performs travel control for traveling with setting of a safe traveling route that does not cause collision or contact with an object (obstacle).

Note that the point cloud data to be used for the traveling route determination processing performed by the robot control unit 201 is mainly “(b) iTOF point cloud & LiDAR point cloud region 192” in the synthesized point cloud map illustrated in FIG. 23.

As described above, in “(b) iTOF point cloud & LiDAR point cloud region 192”, in addition to the LiDAR point cloud (point cloud on a two-dimensional plane), the iToF point cloud (three-dimensional point cloud) generated on the basis of the detection value of the iToF camera is also set, and it is possible to analyze the object position and the distance information with higher accuracy, and to set a safe and reliable traveling route.

### (Step S368)

Next, in step S368, the information processing device 100 determines whether or not the robot 10 has arrived at a destination, and completes the map generation processing and the traveling processing in a case where the robot has arrived at the destination.

In a case where the robot has not arrived at the destination, the process returns to step S302, and the processing of step S302 and subsequent steps is repeated.

As described above, the processing of the fifth embodiment described with reference to the flowcharts illustrated in FIGS. 33 to 36 is performed according to the first to fourth embodiments described above, that is, as follows:
(First embodiment) Calculation processing of iToF point cloud cut region control parameter and processing based on calculated parameter
(Second embodiment) Calculation processing of iToF camera output light frequency control parameter and processing based on calculated parameter
(Third embodiment) Calculation processing of iToF camera exposure time control parameter and processing based on calculated parameter
(Fourth embodiment) Calculation processing of iToF camera output light intensity control parameter and processing based on calculated parameter

The processing of the fifth embodiment is a sequence for executing processing in which these first to fourth embodiments are combined.

This processing makes it possible to perform optimal iToF camera control and point cloud map generation processing according to a speed of the robot, the presence or absence of a person or an oncoming vehicle within a predetermined distance in a robot advancing direction, and it is possible to perform optimal object distance calculation processing according to a situation.

### 5. Hardware Configuration Example of Information Processing Device

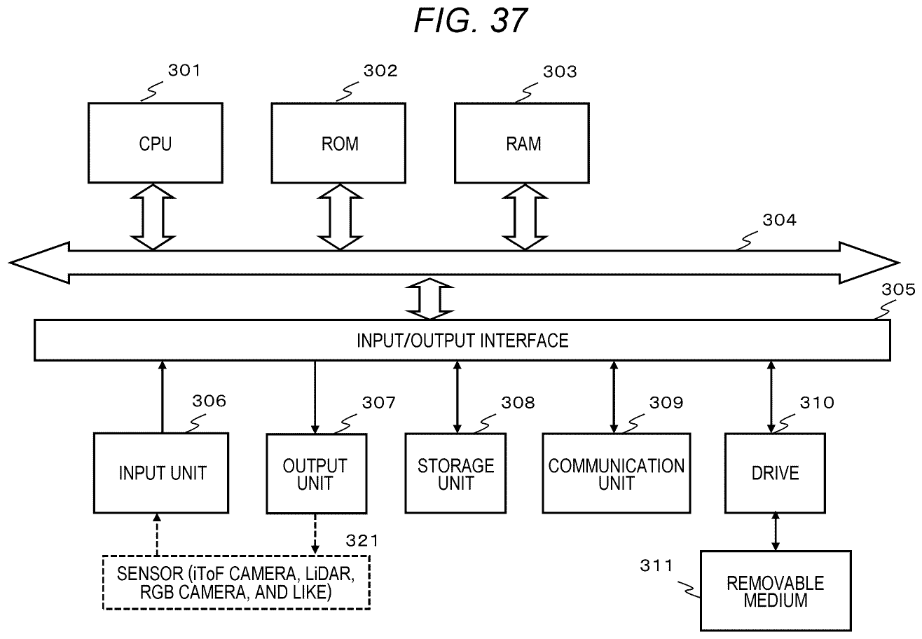

Next, a hardware configuration example of the information processing device 100 according to the present disclosure will be described with reference to FIG. 37.

The hardware configuration illustrated in FIG. 37 is an example of a hardware configuration applicable as the information processing device 100 of the present disclosure.

Each configuration of the hardware illustrated in FIG. 37 will be described.

A central processing unit (CPU) 301 functions as a data processing unit such as a control unit that executes various types of processing in accordance with a program stored in a read only memory (ROM) 302 or a storage unit 308. For example, the CPU 301 executes the processing according to the sequence described in the above-described embodiments. A random access memory (RAM) 303 stores programs, data, or the like to be performed by the CPU 301. The CPU 301, the ROM 302, and the RAM 303 are connected to one another by a bus 304.

The CPU 301 is connected to an input/output interface 305 via the bus 304, and the input/output interface 305 is connected to, for example, an input unit 306 including various switches, a touch panel, a microphone, and the like, and an output unit 307 including a display, a speaker, and the like.

Furthermore, various sensors 321 such as an iToF camera, a LiDAR, and an RGB camera are connected to the input unit 306 and the output unit 307, and light output processing via the output unit 307, input processing of a detection value of the sensor 321 via the input unit 306, and the like are performed.

The storage unit 308 connected to the input/output interface 305 includes, for example, a hard disk, or the like and stores programs executed by the CPU 301 and various types of data. A communication unit 309 functions as a transmitter and receiver for data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

### 6. Summary of Configuration of Present Disclosure

The embodiments of the present disclosure have been described above in detail with reference to specific embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.

(1) An information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit, in which
the control unit
performs control to change at least one of a frequency or intensity of output light of the sensor, an exposure time of input light of the sensor, or a point cloud cut region in a point cloud map generated by the point cloud map generation unit, in accordance with a speed of the mobile body.

(2) The information processing device according to (1), in which
the control unit
executes control to enlarge a point cloud cut region in a point cloud map generated by the point cloud map generation unit, in a case where a speed of the mobile body is equal to or higher than a prescribed threshold value.

(3) The information processing device according to (1) or (2), in which
the control unit
executes control to reduce or fix a point cloud cut region in a point cloud map generated by the point cloud map generation unit, in a case where a speed of the mobile body is lower than a prescribed threshold value.

(4) The information processing device according to any one of (1) to (3), in which
the point cloud cut region
is a region set as a short-distance region close to the mobile body, and is a region where a traveling route based on an object analysis result has been determined.

(5) The information processing device according to any one of (1) to (4), in which
the sensor is an indirect time of flight (iToF) camera, and
the control unit
executes control to decrease a frequency of output light of the iToF camera, in a case where a speed of the mobile body is equal to or higher than a prescribed threshold value.

(6) The information processing device according to any one of (1) to (5), in which
the sensor is an iToF camera, and
the control unit
executes control to increase or control to fix a frequency of output light of the iToF camera, in a case where a speed of the mobile body is lower than a prescribed threshold value.

(7) The information processing device according to any one of (1) to (6), in which
the sensor is an iToF camera, and
the control unit
executes control to increase intensity of output light of the iToF camera, in a case where a speed of the mobile body is equal to or higher than a prescribed threshold value.

(8) The information processing device according to any one of (1) to (7), in which
the sensor is an iToF camera, and
the control unit
executes control to decrease or control to fix intensity of output light of the iToF camera, in a case where a speed of the mobile body is lower than a prescribed threshold value.

(9) The information processing device according to any one of (1) to (8), in which
the sensor is an iToF camera, and
the control unit
executes control to lengthen an exposure time of input light of the iToF camera, in a case where a speed of the mobile body is equal to or higher than a prescribed threshold value.

(10) The information processing device according to any one of (1) to (9), in which
the sensor is an iToF camera, and
the control unit
executes control to shorten or control to fix an exposure time of input light of the iToF camera, in a case where a speed of the mobile body is lower than a prescribed threshold value.

(11) The information processing device according to any one of (1) to (10), in which
the sensor includes: an indirect time of flight (iToF) camera; and
a light detection and ranging (LiDAR), and
the point cloud map generation unit includes:
an iToF point cloud map generation unit configured to be input with a detection value of the iToF camera to generate an iTOF point cloud map indicating an object position;
a LiDAR point cloud map generation unit configured to be input with a detection value of the LiDAR to generate a LiDAR point cloud map indicating an object position; and
a point cloud map synthesizing unit configured to generate a synthesized point cloud map by synthesizing the iToF point cloud map and the LiDAR point cloud map.

(12) The information processing device according to (11), in which
the LiDAR is a two-dimensional (2D)-LiDAR configured to execute object detection on a two-dimensional plane,
the LiDAR point cloud map generation unit generates a LiDAR point cloud map indicating an object position on the two-dimensional plane, and
the point cloud map synthesizing unit
generates a synthesized point cloud map by synthesizing an iToF point cloud map indicating an object position in a three-dimensional space and a LiDAR point cloud map indicating an object position on a two-dimensional plane.

(13) The information processing device according to (11) or (12), in which
the control unit
sets a point cloud cut region only for an iToF point cloud map generated by the iToF point cloud map generation unit, and
the point cloud map synthesizing unit
generates a synthesized point cloud map by synthesizing an iToF point cloud map having a point cloud cut region and a LiDAR point cloud map not including a point cloud cut region.

(14) The information processing device according to any one of (1) to (13), in which
the control unit
performs control to increase intensity of output light of the sensor
in a case where no person or oncoming vehicle is detected within a prescribed threshold distance from the mobile body, and
performs control to decrease intensity of output light of the sensor
in a case where a person or an oncoming vehicle is detected within a prescribed threshold distance from the mobile body.

(15) The information processing device according to (14), in which
the control unit
additionally executes control to shorten an exposure time of input light of the sensor
in a case where the control unit executes control to increase intensity of output light of the sensor.

(16) The information processing device according to (14) or (15), in which
the control unit
additionally executes control to lengthen an exposure time of input light of the sensor
in a case where the control unit executes control to decrease intensity of output light of the sensor.

(17) An information processing method executed in an information processing device,
the information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit,
the information processing method including:
by the control unit,
performing control to change at least one of a frequency or intensity of output light of the sensor, an exposure time of input light of the sensor, or a point cloud cut region in a point cloud map generated by the point cloud map generation unit, in accordance with a speed of the mobile body.

(18) A program for causing an information processing device to execute information processing,
the information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit,
the program causing the control unit to execute
control to change at least one of a frequency or intensity of output light of the sensor, an exposure time of input light of the sensor, or a point cloud cut region in a point cloud map generated by the point cloud map generation unit, in accordance with a speed of the mobile body.

Note that a series of processing herein described can be executed by hardware, software, or a combined configuration of the both. In a case where processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed into a computer from a recording medium, the program can be received via a network such as a local area network (LAN) or the Internet, and installed into a recording medium such as an internal hard disk or the like.

Furthermore, the various types of processing herein described may be performed not only in time series as described, but also in parallel or individually in accordance with the processing capability of the device that performs the processing or as necessary. Furthermore, a system in the present specification is a logical assembly of a plurality of devices, and is not limited to a system in which devices of the respective configurations are in the same housing.

### Industrial Applicability

As described above, according to a configuration of an embodiment of the present disclosure, a configuration is achieved in which the light output sensor and a point cloud map generated on the basis of sensor detection information are controlled according to a speed of a mobile body, to enable optimal object detection according to the speed of the mobile body.

Specifically, for example, there are provided: a sensor that is attached to the mobile body, outputs light with a predetermined frequency from the light transmission unit, and is input with reflected light from the object via the light reception unit; the point cloud map generation unit that is input with a sensor detection value to generate a point cloud map indicating an object position; and a control unit that controls at least one of the sensor or the point cloud map generation unit. The control unit performs control to change at least one of a frequency or intensity of output light of the sensor, an exposure time of input light of the sensor, or a point cloud cut region in a point cloud map, in accordance with a speed of the mobile body.

With this configuration, a configuration is achieved in which the light output sensor and a point cloud map generated on the basis of sensor detection information are controlled according to a speed of the mobile body, to enable optimal object detection according to the speed of the mobile body.

### REFERENCE SIGNS LIST

10 Robot (mobile body)
20 Camera
21 RGB camera
22 iToF camera
30 LiDAR
100 Information processing device
101 Speed sensor
102 Signal processing unit (low-pass filter)
103 2D-LiDAR
104 Signal processing unit (low-pass filter)
105 LiDAR point cloud map generation unit
120 iTOF camera
121 Output light generation unit
122 Light transmission unit
123 Exposure time control unit
124 Light reception unit (image sensor)
125 Signal processing unit (low-pass filter)
126 iTOF map generation unit
131 Point cloud map synthesizing unit
132 Control unit
141 Object (obstacle) analysis target region
142 Object (obstacle) analysis non-target region
151 Two-dimensional plane
171,174 Point cloud cut region
172 Point cloud cut reference distance
173,175 iToF point cloud generation region
177 iToF point cloud region
178 LiDAR point cloud region
181 LiDAR point cloud region
182 iTOF point cloud & LiDAR point cloud region
183 LiDAR point cloud region
191 LiDAR point cloud region
192 iTOF point cloud & LIDAR point cloud region
193 LiDAR point cloud region
301 CPU
302 ROM
303 RAM
304 Bus
305 Input/output interface
306 Input unit
307 Output unit
308 Storage unit
309 Communication unit
310 Drive
311 Removable medium
321 Sensor

1. An information processing device comprising:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit, wherein
the control unit
performs control to change at least one of a frequency or intensity of output light of the sensor, an exposure time of input light of the sensor, or a point cloud cut region in a point cloud map generated by the point cloud map generation unit, in accordance with a speed of the mobile body.

2. The information processing device according to claim 1, wherein
the control unit
executes control to enlarge a point cloud cut region in a point cloud map generated by the point cloud map generation unit, in a case where a speed of the mobile body is equal to or higher than a prescribed threshold value.

3. The information processing device according to claim 1, wherein
the control unit
executes control to reduce or fix a point cloud cut region in a point cloud map generated by the point cloud map generation unit, in a case where a speed of the mobile body is lower than a prescribed threshold value.

4. The information processing device according to claim 1, wherein
the point cloud cut region
is a region set as a short-distance region close to the mobile body, and is a region where a traveling route based on an object analysis result has been determined.

5. The information processing device according to claim 1, wherein
the sensor is an indirect time of flight (iToF) camera, and
the control unit
executes control to decrease a frequency of output light of the iToF camera, in a case where a speed of the mobile body is equal to or higher than a prescribed threshold value.

6. The information processing device according to claim 1, wherein
the sensor is an iToF camera, and
the control unit
executes control to increase or control to fix a frequency of output light of the iToF camera, in a case where a speed of the mobile body is lower than a prescribed threshold value.

7. The information processing device according to claim 1, wherein
the sensor is an iToF camera, and
the control unit
executes control to increase intensity of output light of the iToF camera, in a case where a speed of the mobile body is equal to or higher than a prescribed threshold value.

8. The information processing device according to claim 1, wherein
the sensor is an iToF camera, and
the control unit
executes control to decrease or control to fix intensity of output light of the iToF camera, in a case where a speed of the mobile body is lower than a prescribed threshold value.

9. The information processing device according to claim 1, wherein
the sensor is an iToF camera, and
the control unit
executes control to lengthen an exposure time of input light of the iToF camera, in a case where a speed of the mobile body is equal to or higher than a prescribed threshold value.

10. The information processing device according to claim 1, wherein
the sensor is an iToF camera, and
the control unit
executes control to shorten or control to fix an exposure time of input light of the iToF camera, in a case where a speed of the mobile body is lower than a prescribed threshold value.

11. The information processing device according to claim 1, wherein
the sensor includes:
an indirect time of flight (iToF) camera; and
a light detection and ranging (LiDAR), and
the point cloud map generation unit includes:
an iToF point cloud map generation unit configured to be input with a detection value of the iToF camera to generate an iTOF point cloud map indicating an object position;
a LiDAR point cloud map generation unit configured to be input with a detection value of the LiDAR to generate a LiDAR point cloud map indicating an object position; and
a point cloud map synthesizing unit configured to generate a synthesized point cloud map by synthesizing the iToF point cloud map and the LiDAR point cloud map.

12. The information processing device according to claim 11, wherein
the LiDAR is a two-dimensional (2D)-LiDAR configured to execute object detection on a two-dimensional plane,
the LiDAR point cloud map generation unit generates a LiDAR point cloud map indicating an object position on the two-dimensional plane, and
the point cloud map synthesizing unit
generates a synthesized point cloud map by synthesizing an iToF point cloud map indicating an object position in a three-dimensional space and a LiDAR point cloud map indicating an object position on a two-dimensional plane.

13. The information processing device according to claim 11, wherein
the control unit
sets a point cloud cut region only for an iToF point cloud map generated by the iToF point cloud map generation unit, and
the point cloud map synthesizing unit
generates a synthesized point cloud map by synthesizing an iToF point cloud map having a point cloud cut region and a LiDAR point cloud map not including a point cloud cut region.

14. The information processing device according to claim 1, wherein
the control unit
performs control to increase intensity of output light of the sensor
in a case where no person or oncoming vehicle is detected within a prescribed threshold distance from the mobile body, and
performs control to decrease intensity of output light of the sensor
in a case where a person or an oncoming vehicle is detected within a prescribed threshold distance from the mobile body.

15. The information processing device according to claim 14, wherein
the control unit
additionally executes control to shorten an exposure time of input light of the sensor
in a case where the control unit executes control to increase intensity of output light of the sensor.

16. The information processing device according to claim 14, wherein
the control unit
additionally executes control to lengthen an exposure time of input light of the sensor
in a case where the control unit executes control to decrease intensity of output light of the sensor.

17. An information processing method executed in an information processing device,
the information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit,
the information processing method comprising:
by the control unit,
performing control to change at least one of a frequency or intensity of output light of the sensor, an exposure time of input light of the sensor, or a point cloud cut region in a point cloud map generated by the point cloud map generation unit, in accordance with a speed of the mobile body.

18. A program for causing an information processing device to execute information processing,
the information processing device including:
a sensor attached to a mobile body, the sensor being configured to output light with a predetermined frequency from a light transmission unit and to be input with reflected light from an object via a light reception unit;
a point cloud map generation unit configured to be input with a detection value of the sensor, to generate a point cloud map indicating an object position; and
a control unit configured to execute control on at least one of the sensor or the point cloud map generation unit,
the program causing the control unit to execute
control to change at least one of a frequency or intensity of output light of the sensor, an exposure time of input light of the sensor, or a point cloud cut region in a point cloud map generated by the point cloud map generation unit, in accordance with a speed of the mobile body.
